(19) United States
(12) Patent Application Publication
(10) Pub. No.: US 2025/0243109 A1
(43) Pub. Date: Jul. 31, 2025

(54) COATED ARTICLES WITH A PLANARIZATION LAYER AND A SURFACE-MODIFYING LAYER AND METHODS OF MAKING THE SAME

(71) Applicants: CORNING INCORPORATED, CORNING, NY (US); CORNING PRECISION MATERIALS Co., LTD., ASAN-SI (KR)

(72) Inventors: George Karl Kaufman, Painted Post, NY (US); Robert George Manley, Ocala, FL (US); Jeonghong Oh, Chungcheongnam-do (KR); Jung-keun Oh, Seoul (KR); Sung-kun Yoon, Gyeonggi-do (KR)

(21) Appl. No.: 19/039,471

(22) Filed: Jan. 28, 2025

Related U.S. Application Data
(60) Provisional application No. 63/626,817, filed on Jan. 30, 2024.

(51) Int. Cl. C03C 17/245

(52) U.S. Cl. CPC C03C 17/245; C03C 2217/213; C03C 2218/155

(57) ABSTRACT

Coated articles are described herein that include a planarization layer exhibiting one or more of a surface roughness Ra of less than or equal to 1.6 nm, a spatial height variation of less than or equal to 0.24 μm², or both. The planarization layer is disposed over a first major surface of a substrate having a glass-based material or a ceramic-based material. A surface-modifying layer is disposed on an outer surface of the planarization layer. Methods of forming the coated article are also described herein.

### CLAIM OF PRIORITY

This application claims the benefit of priority under 35 U.S.C. § 119 of U.S. Provisional Application Ser. No. 63/626,817, filed on Jan. 30, 2024, the content of which is relied upon and incorporated herein by reference in its entirety.

### FIELD

The present disclosure relates generally to coated articles with a planarization layer a surface-modifying layer and methods of making the same and, more particularly, to coated articles comprising the surface-modifying layer disposed on the planarization layer and methods of making coated articles including impinging a surface with an ion beam.

### BACKGROUND

Glass, glass-ceramic, and ceramic materials are commonly used in various consumer electronic products including display devices, for example, liquid crystal displays (LCDs), electrophoretic displays (EPD), organic light-emitting diode displays (OLEDs), plasma display panels (PDPs), or the like. For example, chemically strengthened glass is favored for many touch-screen products, including cell phones, music players, e-book readers, notepads, tablets, laptop computers, automatic teller machines, and other similar devices. Many of these glass, glass-ceramic, and ceramic materials are also employed in displays and display devices of consumer electronic products that do not have touch-screen capability but are prone to direct human contact, including desktop computers, laptop computers, elevator screens, equipment displays, and others. Glass, glass-ceramic, and ceramic materials are often treated to provide aesthetic and functional characteristics based on the end-use application of the material. For example, anti-reflective, anti-glare, and anti-fingerprint treatments are common treatments used on materials used in touch-screen products.

The durability of some types of treatments, such as an anti-fingerprint coating, can be limited, especially when used in combination with other treatments, for example an anti-reflective coating. Material choices for anti-fingerprint treatments and/or an easy-to-clean (ETC) treatments typically rely on the ability of the treatment materials on the surface to repel material, for example, such as water, dust, and environmental debris including sebum, oils, and proteins. Anti-fingerprint and/or ETC treatments experience wear over time, such as from repeated touching, swiping, cleaning, etc. during use that can affect the ability of the surface of the anti-fingerprint and/or ETC treatment to maintain the ability to repel material.

It is known to use fluorinated silanes, for example fluoroethersilanes, which can bind to the surface as a monolayer or multilayer, to form coatings with a thickness from 2 nm to 5 nm. Once this nanoscale coating is abraded away, the surface no longer exhibits repellant properties. Consequently, there is a need for a way to improve the abrasion resistance of coatings that can be used with glass, glass-ceramic, and/or ceramic articles. This need and other needs are addressed by the present disclosure.

### SUMMARY

There are set forth herein coated articles, planarization layers, and methods of making the same. The planarization layer can provide a decreased surface roughness Ra relative to what would be obtained in an article (e.g., coated article) without the planarization layer, which enables the coated article of the present disclosure including the planarization layer to have increased abrasion resistance of the surface-modifying layer. For example, a steel-wool abraded water contact angle (after 3,000 cycles in a Steel Wool Abrasion Test) of the surface-modifying layer can be 90° or more or 95° or more (e.g., greater than or equal to 90° or greater than or equal to 95°).

The planarization layer can comprise an inner sublayer and an outer sublayer, where a microstructure of the inner sublayer is different than a corresponding microstructure of the outer sublayer (e.g., a grain size, roughness, or other characteristic of the outer sublayer can be smaller than a corresponding characteristic of the inner sublayer), where the inner sublayer and the outer sublayer can comprise the same material (e.g., silica). A surface roughness Ra of the outer surface of the planarization layer can be from greater than or equal to 0.5 nm to less than or equal to 1.6 nm (e.g., from greater than or equal to 0.8 nm to less than or equal to 1.5 nm or from greater than or equal to 1.0 nm to less than or equal to 1.4 nm).

Without wishing to be bound by theory, it is believed that higher spatial frequencies of a surface (e.g., gradients of the surface as measured by surface height variation) impact the abrasion resistance of a surface-modifying layer disposed thereon. For example, it is believed that decreasing the amplitude of these higher spatial frequencies can enable increased abrasion resistance. Overall surface roughness values such as surface roughness Ra may not fully capture the role of the decreased amplitude at higher spatial frequencies in the planarization layer. In contrast, aspects of the surface height variation and ratios thereof as well as domain sizes and/or domain heights discussed herein may more directly describe these aspects of the planarization layer. A surface height variation of the outer surface of the planarization layer can be from greater than or equal to 0.18 μm² to less than or equal to 0.24 μm² (e.g., from greater than or equal to 0.20 μm² to less than or equal to 0.23 μm²). A ratio of a mean peak height divided by the surface height variation of the planarization layer can be from greater than or equal to 0.8 nm/μm² to less than or equal to 2.0 nm/μm² (e.g., from greater than or equal to 1.0 nm/μm² to less than or equal to 1.5 nm/μm²).

Methods of making the coated article (e.g., planarization layer) comprises impinging an initial layer with an ion beam to form an inner sublayer and disposing an outer sublayer thereon. The inner sublayer and the outer sublayer can comprise silica. The ion beam can be generated by a Kaufman-type ion beam source, an end-Hall ion beam source, or a linear ion beam source. The ion beam treatment can remove less than or equal to 60 nm (e.g., from greater than or equal to 10 nm to less than or equal to 60 nm) from the initial layer. In aspects, a Kaufman-type ion beam source can be operated with a current of less than or equal to 0.8 Amps (e.g., from greater than or equal to 0.5 Amps to less than or equal to 0.8 Amps), with oxygen ions, and/or impinge the initial layer for less than or equal to 20 minutes (e.g., from about 10 minutes to about 15 minutes). In aspects, a linear ion beam source can be operated at a voltage of 2000 Volts or more (e.g., from greater than or equal to 2000 V to less than or equal to 2500 V), a distance between the linear ion beam source and the initial surface of the initial layer less than 50 mm (e.g., from greater than or equal to 30 mm to less than or equal to 40 mm), and/or impinge the initial layer for less than or equal to 5 minutes (e.g., from greater than or equal to 20 seconds to less than or equal to 1 minute).

The surface-modifying coating can reduce a visibility and/or color shift associated with disposing a fingerprint thereon. Providing a high water contact angle (e.g., greater than or equal to 100°) can enhance the removal of aqueous material (e.g., water droplets, sweat droplets) from the anti-fingerprint coating. Consequently, the anti-fingerprint coating can be hydrophobic and oleophilic. The coated article in accordance with the aspects of the disclosure can exhibit good abrasion resistance (e.g., an abraded water contact angle greater than or equal to 90° after 2,000 cycles, 3,000 cycles, and/or 3,500 cycles in a Steel Wool Abrasion Test, a cheesecloth-abraded water contact angle greater than or equal to 90° after 200,000 cycles in a Cheesecloth Abrasion Test), for example, maintaining a hydrophobic character. The planarization layer can exhibit good adhesion to the surface-modifying layer disposed thereon, for example, by providing a lower roughness surface for the surface-modifying layer.

The substrate can comprise a glass-based and/or ceramic-based material, which can provide good dimensional stability, good impact resistance, and/or good puncture resistance. The glass-based and/or ceramic-based substrate can comprise one or more compressive stress regions, which can further provide increased impact resistance and/or increased puncture resistance.

Some example aspects of the disclosure are described below with the understanding that any of the features of the various aspects may be used alone or in combination with one another.

Aspect 1. A coated article comprising:
a substrate comprising a first major surface, the substrate comprising glass-based material or a ceramic-based material;
a planarization layer disposed over the first major surface, an outer surface of the planarization layer exhibits:
   a surface roughness Ra of less than or equal to 1.6 nm; and
   a spatial height variation of less than or equal to 0.24 μm²;
a surface-modifying layer disposed on the outer surface of the planarization layer.

Aspect 2. The coated article of aspect 1, wherein the outer surface of the planarization layer further exhibits a ratio of a maximum height to the spatial height variation of less than or equal to 2.0 nm/μm².

Aspect 3. The coated article of aspect 2, wherein the ratio of the maximum height to the spatial height variation is from greater than or equal to 1.0 nm/μm² to less than or equal to 1.50 nm/μm².

Aspect 4. The coated article of any one of aspects 1-3, wherein the surface roughness Ra is from greater than or equal to 0.8 nm to less than or equal to 1.5 nm.

Aspect 5. The coated article of aspect 4, wherein the surface roughness Ra is from greater than or equal to 1.0 nm to less than or equal to 1.4 nm.

Aspect 6. The coated article of any one of aspects 1-5, wherein the spatial height variation is from greater than or equal to 0.20 μm² to less than or equal to 0.23 μm².

Aspect 7. The coated article of any one of aspects 1-6, wherein the outer surface exhibits:
a mean height of domains above an average location is from greater than or equal to 1 nm to less than or equal to 8 nm; and
an areal density of the domains is from greater than or equal to 10 per μm² to less than or equal to 70 per μm².

Aspect 8. The coated article of any one of aspects 1-7, wherein an exterior surface of the surface-modifying layer exhibits a water contact angle of from greater than or equal to 950 to less than or equal to 120°.

Aspect 9. The coated article of aspect 8, wherein the water contact angle is from greater than or equal to 1050 to less than or equal to 118°.

Aspect 10. The coated article of any one of aspects 8-9, wherein the surface-modifying layer exhibits an abraded water contact angle of greater than or equal to 900 after being abraded for 3,000 cycles in a Steel Wool Abrasion test.

Aspect 11. The coated article of aspect 10, wherein the abraded water contact angle is greater than or equal to 95°.

Aspect 12. The coated article of any one of aspects 8-11, wherein the surface-modifying layer exhibits a cheesecloth-abraded water contact angle of greater than or equal to 800 after being subjected to 200,000 cycles of in a Cheesecloth Abrasion Test.

Aspect 13. The coated article of aspect 12, wherein the cheesecloth-abraded water contact angle is greater than or equal to 90°.

Aspect 14. The coated article of any one of aspects 8-13, wherein the surface-modifying layer exhibits a rubber-abraded water contact angle of greater than or equal to 800 after being subjected to 3,000 cycles of in a Rubber Abrasion Test.

Aspect 15. The coated article of aspect 14, wherein the rubber-abraded water contact angle is greater than or equal to 90°.

Aspect 16. The coated article of any one of aspects 8-15, wherein the surface-modifying layer exhibits a coefficient of friction of the exterior surface of less than or equal to 0.25.

Aspect 17. The coated article of any one of aspects 8-16, wherein the exterior surface exhibits an oleic acid contact angle of less than or equal to 30°.

Aspect 18. The coated article of any one of aspects 8-16, wherein the exterior surface exhibits an oleic acid contact angle of greater than or equal to 40°.

Aspect 19. The coated article of any one of aspects 1-18, wherein the surface-modifying layer is an easy-to-clean coating.

Aspect 20. The coated article of any one of aspects 1-19, wherein the surface-modifying layer comprises a perfluoropolyether.

Aspect 21. The coated article of any one of aspects 1-19, wherein the surface-modifying layer is fluorine-free.

Aspect 22. The coated article of any one of aspects 1-21, wherein the planarization layer comprises an inner sublayer and an outer sublayer disposed on the inner sublayer, the outer sublayer comprising the outer surface, a thickness of the outer sublayer is from about 10 nm to about 100 nm, and a microstructure of the inner sublayer is different than a corresponding microstructure of the outer sublayer.

Aspect 23. The coated article of any one of aspects 1-22, wherein the planarization layer comprises silica.

Aspect 24. The coated article of any one of aspects 1-23, wherein the coated article further comprises at least one of:
an anti-reflective coating positioned between the surface-modifying layer and the substrate;
a gradient coating positioned between the surface-modifying layer and the substrate; or both.

Aspect 25. The coated article of any one of aspects 1-23, further comprising an optical stack positioned between the surface-modifying layer and the substrate, wherein the optical stack comprises an anti-reflective coating, a band-pass filter coating, an edge neutral mirror, a beam splitter coating, a multi-layer high-reflectance coating, or an edge filter coating.

Aspect 26. The coated article of aspect 25, wherein the optical stack has a stack thickness from about 10 nanometers to about 10 micrometers.

Aspect 27. The coated article of aspect 26, wherein the stack thickness of the optical stack is from about 50 nanometers to about 5 micrometers.

Aspect 28. The coated article of any one of aspects 26-27, wherein the stack thickness of the optical stack is from about 50 nanometers to about 500 nanometers.

Aspect 29. The coated article of any one of aspects 25-28, wherein the optical stack comprises a scratch resistant layer, and the scratch resistant layer has a scratch-resistant thickness from 0.05 micrometers to 3 micrometers.

Aspect 30. The coated article of any one of aspects 25-29, wherein the coated article including the optical stack and the fingerprint-hiding coating exhibits a hardness of 8 GigaPascals or greater measured by a Berkovich Indenter Hardness test.

Aspect 31. The coated article of any one of aspects 25-30, wherein the optical stack comprises one or more of a silicon-containing oxide, a silicon-containing nitride, a silicon-containing oxynitride, and Nb₂O₅.

Aspect 32. The coated article of any one of aspects 25-31, wherein the optical stack comprises two or more layers with different refractive indices including at least a first low refractive index (RI) layer and a second high refractive index (RI) layer, wherein the absolute value of a difference between the first low RI layer and the second high RI layer is 0.2 or more, and further wherein the optical stack comprises one or more of a silicon-containing oxide, a silicon-containing nitride, a silicon-containing oxynitride, and Nb₂O₅.

Aspect 33. The coated article of any one of aspects 1-23, wherein the substrate is a textured substrate.

Aspect 34. The coated article of aspect 33, wherein the coated article further comprises an anti-reflective coating or a gradient coating positioned between the fingerprint-hiding coating and the textured substrate.

Aspect 35. The coated article of aspect 34, wherein a thickness of the anti-reflective coating is from about 200 nanometers to about 3 micrometers.

Aspect 36. A consumer electronic device comprising:
a housing comprising a front surface, a back surface, and a side surface;
electrical components at least partially within the housing, the electrical components comprise a controller, a memory, and a display, the display at or facing the front surface of the housing; and
a cover substrate disposed over the display,
wherein at least one of the housing or the cover substrate comprises the coated article of any one of aspects 1-35.

Aspect 37. A method of forming a coated article comprising:
impinging an initial surface of an initial layer disposed over a substrate with an ion beam to form an inner surface of an inner layer corresponding to the initial layer; and
disposing a silica-containing material on the inner layer to form a planarization layer, the planarization comprising the inner layer and an outer layer corresponding to the silica-containing material and having an outer surface.

Aspect 38. The method of aspect 37, wherein the impinging occurs for from about 20 seconds to about 60 minutes while the substrate is maintained at a temperature from about 20° C. to about 40° C.

Aspect 39. The method of any one of aspects 37-38, wherein the ion beam comprises oxygen ions.

Aspect 40. The method of any one of aspects 37-39, wherein the ion beam is formed by a Kaufman-type ion beam source, an end-Hall ion beam source, or a linear ion beam source.

Aspect 41. The method of any one of aspects 37-40, wherein the ion beam is formed by a Kaufman-type ion beam source and the impinging occurs for a first period of time from greater than 10 minutes to about 60 minutes.

Aspect 42. The method of aspect 41, wherein the first period of time is from about 15 minutes to about 45 minutes.

Aspect 43. The method of any one of aspects 41-42, wherein the impinging removes from about 20 nanometers to about 60 nanometers from the initial layer.

Aspect 44. The method of any one of aspects 37-40, wherein the ion beam is formed by a linear ion beam source and the impinging occurs for a first period of time from about 20 seconds to about 20 minutes.

Aspect 45. The method of aspect 45, wherein the first period of time is from about 1 minute to about 5 minutes.

Aspect 46. The method of any one of aspects 44-45, wherein a distance between the inner surface and the linear ion beam source is from about 10 mm to about 50 mm.

Aspect 47. The method of aspect 46, wherein the distance is from about 15 mm to about 30 mm.

Aspect 48. The method of any one of aspects 44-47, wherein the linear ion beam source is operated with a voltage of greater than or equal to 2000 V.

Aspect 49. The method of any one of aspects 37-48, wherein a surface roughness Ra of the inner surface is from about 1.0 nm to about 1.9 nm.

Aspect 50. The method of aspect 49, wherein the surface roughness Ra of the inner surface is from about 1.3 nm to about 1.8 nm.

Aspect 51. The method of any one of aspects 37-50, wherein the silica-containing material is silica.

Aspect 52. The method of any one of aspects 37-51, wherein the inner layer comprises the same material as the outer layer with a microstructure of the inner layer being different from a corresponding microstructure of the outer layer.

Aspect 53. The method of any one of aspects 37-52, wherein a deposition rate of the silica-containing material is less than about 1.0 Å/s.

Aspect 54. The method of aspect 53, wherein the disposing the silica-containing material comprises e-beam evaporation.

Aspect 55. The method of any one of aspects 37-54, wherein a thickness of the outer layer is greater than or equal to 10 nanometers.

Aspect 56. The method of aspect 55, wherein the thickness of the outer layer is from greater than or equal to 15 nanometers to less than or equal to 30 nanometers.

Aspect 57. The method of any one of aspects 37-56, wherein the outer surface exhibits a surface roughness Ra of less than or equal to 1.6 nm.

Aspect 58. The method of aspect 57, wherein the surface roughness Ra is from greater than or equal to 0.8 nm to less than or equal to 1.5 nm.

Aspect 59. The method of any one of aspects 57-58, wherein the surface roughness Ra is from greater than or equal to 1.0 nm to less than or equal to 1.4 nm.

Aspect 60. The method of any one of aspects 37-59, wherein the outer surface exhibits a spatial height variation of less than or equal to 0.24 μm².

Aspect 61. The method of aspect 60, wherein the spatial height variation is from greater than or equal to 0.20 μm² to less than or equal to 0.23 μm².

Aspect 62. The method of any one of aspects 60-61, wherein the outer surface further exhibits a ratio of a maximum height to the spatial height variation of less than or equal to 2.0 nm/μm².

Aspect 63. The method of aspect 62, wherein the ratio of the maximum height to the spatial height variation is from greater than or equal to 1.0 nm/μm² to less than or equal to 1.50 nm/μm².

Aspect 64. The method of any one of aspects 37-63, wherein the outer surface exhibits:
a mean height of domains above an average location is from greater than or equal to 1 nm to less than or equal to 8 nm; and
an areal density of the domains is from greater than or equal to 10 per μm² to less than or equal to 70 per μm².

Aspect 65. The method of any one of aspects 37-64, further comprising disposing a surface-modifying layer on the outer surface, the surface modifying layer comprising an exterior surface.

Aspect 66. The method of aspect 65, wherein the exterior surface of the surface-modifying layer exhibits a water contact angle of from about 950 to about 120°.

Aspect 67. The method of aspect 66, wherein the water contact angle is from about 105° to about 118°.

Aspect 68. The method of any one of aspects 65-67, wherein the surface-modifying layer exhibits an abraded water contact angle of greater than or equal to 90° after being abraded for 3,000 cycles in a Steel Wool Abrasion test.

Aspect 69. The method of aspect 68, wherein the abraded water contact angle is greater than or equal to 95°.

Aspect 70. The method of any one of aspects 65-69, wherein the surface-modifying layer exhibits a cheesecloth-abraded water contact angle of greater than or equal to 800 after being subjected to 200,000 cycles of in a Cheesecloth Abrasion Test.

Aspect 71. The method of aspect 70, wherein the cheesecloth-abraded water contact angle is greater than or equal to 90°.

Aspect 72. The method of any one of aspects 65-71, wherein the surface-modifying layer exhibits a rubber-abraded water contact angle of greater than or equal to 800 after being subjected to 3,000 cycles of in a Rubber Abrasion Test.

Aspect 73. The method of aspect 72, wherein the rubber-abraded water contact angle is greater than or equal to 90°.

Aspect 74. The method of any one of aspects 65-73, wherein the surface-modifying layer exhibits a coefficient of friction of the exterior surface of less than or equal to 0.25.

Aspect 75. The method of any one of aspects 65-74, wherein the exterior surface exhibits an oleic acid contact angle of less than or equal to 30°.

Aspect 76. The method of any one of aspects 65-74, wherein the exterior surface exhibits an oleic acid contact angle of greater than or equal to 40°.

Aspect 77. The method of any one of aspects 65-76, wherein the surface-modifying layer is an easy-to-clean coating.

Aspect 78. The method of any one of aspects 65-77, wherein the surface-modifying layer comprises a perfluoropolyether.

Aspect 79. The method of any one of aspects 65-77, wherein the surface-modifying layer is fluorine-free.

Aspect 80. The method of any one of aspects 37-79, further comprising, before the impinging, disposing the initial layer over the substrate.

Aspect 81. The method of aspect 80, wherein the disposing the initial layer comprises reactive sputtering.

Aspect 82. The method of any one of aspects 37-81, wherein the coated article further comprises at least one of:
an anti-reflective coating positioned between the surface-modifying layer and the substrate;
a gradient coating positioned between the surface-modifying layer and the substrate; or both.

Aspect 83. The method of any one of aspects 37-81, further comprising an optical stack positioned between the surface-modifying layer and the substrate, wherein the optical stack comprises an anti-reflective coating, a band-pass filter coating, an edge neutral mirror, a beam splitter coating, a multi-layer high-reflectance coating, or an edge filter coating.

Aspect 84. The method of aspect 83, wherein the optical stack has a stack thickness from greater than or equal to 10 nanometers to less than or equal to 10 micrometers.

Aspect 85. The method of aspect 84, wherein the stack thickness of the optical stack is from greater than or equal to 50 nanometers to less than or equal to 5 micrometers.

Aspect 86. The method of any one of aspects 83-85, wherein the stack thickness of the optical stack is from greater than or equal to 50 nanometers to less than or equal to 500 nanometers.

Aspect 87. The method of any one of aspects 83-86, wherein the optical stack comprises a scratch resistant layer, and the scratch resistant layer has a scratch-resistant thickness from greater than or equal to 0.05 micrometers to less than or equal to 3 micrometers.

Aspect 88. The method of any one of aspects 83-87, wherein the coated article including the optical stack and the fingerprint-hiding coating exhibits a hardness of 8 GigaPascals or greater measured by a Berkovich Indenter Hardness test.

Aspect 89. The method of any one of aspects 83-88, wherein the optical stack comprises one or more of a silicon-containing oxide, a silicon-containing nitride, a silicon-containing oxynitride, and Nb₂O₅.

Aspect 90. The method of any one of aspects 83-89, wherein the optical stack comprises two or more layers with different refractive indices including at least a first low refractive index (RI) layer and a second high refractive index (RI) layer, wherein the absolute value of a difference between the first low RI layer and the second high RI layer is 0.2 or more, and further wherein the optical stack comprises one or more of a silicon-containing oxide, a silicon-containing nitride, a silicon-containing oxynitride, and Nb₂O₅.

Aspect 91. The method of any one of aspects 37-81, wherein the substrate is a textured substrate.

Aspect 92. The method of aspect 91, wherein the coated article further comprises an anti-reflective coating or a gradient coating positioned between the fingerprint-hiding coating and the textured substrate.

Aspect 93. The method of aspect 92, wherein a thickness of the anti-reflective coating is from greater than or equal to 200 nanometers to less than or equal to 3 micrometers.

Aspect 94. A coated article comprising:
a substrate comprising a first major surface, the substrate comprising glass-based material or a ceramic-based material;
a planarization layer disposed over the first major surface and comprising an outer surface; and
a surface-modifying layer disposed on the outer surface of the planarization layer,
wherein the planarization layer comprises an inner sublayer and an outer sublayer disposed on the inner sublayer, the outer sublayer comprising the outer surface, a thickness of the outer sublayer is from greater than or equal to 10 nm to less than or equal to 100 nm, and a microstructure of the inner sublayer is different than a corresponding microstructure of the outer sublayer.

Aspect 95. The coated article of aspect 94, wherein the outer surface exhibits a surface roughness Ra of less than or equal to 1.6 nm.

Aspect 96. The coated article of aspect 95, wherein the surface roughness Ra is from greater than or equal to 0.8 nm to less than or equal to 1.5 nm.

Aspect 97. The coated article of any one of aspects 95-96, wherein the surface roughness Ra is from greater than or equal to 1.0 nm to less than or equal to 1.4 nm.

Aspect 98. The coated article of any one of aspects 91-94, wherein the outer surface exhibits a spatial height variation of less than or equal to 0.24 μm².

Aspect 99. The coated article of aspect 95, wherein the spatial height variation is from greater than or equal to 0.20 μm² to less than or equal to 0.23 μm².

Aspect 100. The coated article of any one of aspects 91-96, wherein the outer surface of the planarization layer further exhibits a ratio of a maximum height to the spatial height variation of less than or equal to 2.0 nm/μm².

Aspect 101. The coated article of aspect 97, wherein the ratio of the maximum height to the spatial height variation is from greater than or equal to 1.0 nm/μm² to less than or equal to 1.50 nm/μm².

Aspect 102. The coated article of any one of aspects 94-101, wherein the outer surface exhibits:
a mean height of domains above an average location is from greater than or equal to 1 nm to less than or equal to 8 nm; and
an areal density of the domains is from greater than or equal to 10 per μm² to less than or equal to 70 per μm².

Aspect 103. The coated article of any one of aspects 94-102, wherein the outer sublayer of the planarization layer comprises silica.

Aspect 104. The coated article of any one of aspects 94-103, wherein the inner sublayer of the planarization layer comprises the same material as the outer layer of the planarization layer.

Aspect 105. The coated article of any one of aspects 94-104, wherein an exterior surface of the surface-modifying layer exhibits a water contact angle of from greater than or equal to 950 to less than or equal to 120°.

Aspect 106. The coated article of aspect 105, wherein the water contact angle is from greater than or equal to 1050 to less than or equal to 118°.

Aspect 107. The coated article of any one of aspects 105-106, wherein the surface-modifying layer exhibits an abraded water contact angle of greater than or equal to 90° after being abraded for 3,000 cycles in a Steel Wool Abrasion test.

Aspect 108. The coated article of aspect 107, wherein the abraded water contact angle is greater than or equal to 95°.

Aspect 109. The coated article of any one of aspects 94-108, wherein the surface-modifying layer exhibits a cheesecloth-abraded water contact angle of greater than or equal to 80° after being subjected to 200,000 cycles of in a Cheesecloth Abrasion Test.

Aspect 110. The coated article of aspect 109, wherein the cheesecloth-abraded water contact angle is greater than or equal to 90°.

Aspect 111. The coated article of any one of aspects 94-110, wherein the surface-modifying layer exhibits a rubber-abraded water contact angle of greater than or equal to 800 after being subjected to 3,000 cycles of in a Rubber Abrasion Test.

Aspect 112. The coated article of aspect 111, wherein the rubber-abraded water contact angle is greater than or equal to 90°.

Aspect 113. The coated article of any one of aspects 94-112, wherein the surface-modifying layer exhibits a coefficient of friction of the exterior surface of less than or equal to 0.25.

Aspect 114. The coated article of any one of aspects 94-113, wherein the exterior surface exhibits an oleic acid contact angle of less than or equal to 30°.

Aspect 115. The coated article of any one of aspects 94-113, wherein the exterior surface exhibits an oleic acid contact angle of greater than or equal to 40°.

Aspect 116. The coated article of any one of aspects 94-115, wherein the surface-modifying layer is an easy-to-clean coating.

Aspect 117. The coated article of any one of aspects 94-116, wherein the surface-modifying layer comprises a perfluoropolyether.

Aspect 118. The coated article of any one of aspects 94-116, wherein the surface-modifying layer is fluorine-free.

Aspect 119. The coated article of any one of aspects 94-118, wherein the coated article further comprises at least one of:
an anti-reflective coating positioned between the surface-modifying layer and the substrate;
a gradient coating positioned between the surface-modifying layer and the substrate; or both.

Aspect 120. The coated article of any one of aspects 94-118, further comprising an optical stack positioned between the surface-modifying layer and the substrate, wherein the optical stack comprises an anti-reflective coating, a band-pass filter coating, an edge neutral mirror, a beam splitter coating, a multi-layer high-reflectance coating, or an edge filter coating.

Aspect 121. The coated article of aspect 120, wherein the optical stack has a stack thickness from greater than or equal to 10 nanometers to less than or equal to 10 micrometers.

Aspect 122. The coated article of aspect 121, wherein the stack thickness of the optical stack is from greater than or equal to 50 nanometers to less than or equal to 5 micrometers.

Aspect 123. The coated article of any one of aspects 120-122, wherein the stack thickness of the optical stack is from greater than or equal to 50 nanometers to less than or equal to 500 nanometers.

Aspect 124. The coated article of any one of aspects 119-123, wherein the optical stack comprises a scratch resistant layer, and the scratch resistant layer has a scratch-resistant thickness from greater than or equal to 0.05 micrometers to less than or equal to 3 micrometers.

Aspect 125. The coated article of any one of aspects 119-124, wherein the coated article including the optical stack and the fingerprint-hiding coating exhibits a hardness of 8 GigaPascals or greater measured by a Berkovich Indenter Hardness test.

Aspect 126. The coated article of any one of aspects 119-125, wherein the optical stack comprises one or more of a silicon-containing oxide, a silicon-containing nitride, a silicon-containing oxynitride, and Nb₂O₅.

Aspect 127. The coated article of any one of aspects 119-126, wherein the optical stack comprises two or more layers with different refractive indices including at least a first low refractive index (RI) layer and a second high refractive index (RI) layer, wherein the absolute value of a difference between the first low RI layer and the second high RI layer is 0.2 or more, and further wherein the optical stack comprises one or more of a silicon-containing oxide, a silicon-containing nitride, a silicon-containing oxynitride, and Nb₂O₅.

Aspect 128. The coated article of any one of aspects 94-118, wherein the substrate is a textured substrate.

Aspect 129. The coated article of aspect 128, wherein the coated article further comprises an anti-reflective coating or a gradient coating positioned between the fingerprint-hiding coating and the textured substrate.

Aspect 130. The coated article of aspect 129, wherein a thickness of the anti-reflective coating is from greater than or equal to 200 nanometers to less than or equal to 3 micrometers.

Aspect 131. A consumer electronic device comprising:
a housing comprising a front surface, a back surface, and a side surface;
electrical components at least partially within the housing, the electrical components comprise a controller, a memory, and a display, the display at or facing the front surface of the housing; and
a cover substrate disposed over the display,
wherein at least one of the housing or the cover substrate comprises the coated article of any one of aspects 94-130.

### BRIEF DESCRIPTION OF THE DRAWINGS

The above and other features and advantages of aspects of the present disclosure are better understood when the following detailed description is read with reference to the accompanying drawings, in which:

FIGS. 1 and 2A-2C are schematic views of exemplary coated articles according to aspects;

FIG. 3 is a schematic plan view of an example consumer electronic device according to aspects;

FIG. 4 is a schematic perspective view of the example consumer electronic device of FIG. 3;

FIG. 5 schematically illustrates an inner layer and an outer layer of the planarization layer in accordance with aspects of the present disclosure;

FIG. 6 is a flow chart illustrating example methods of making coated articles in accordance with aspects of the disclosure;

FIG. 7 schematically illustrates a step in methods of making a coated article comprising disposing a silica-containing material over a substrate;

FIG. 8 schematically illustrates a step in methods of making a coated article comprising impinging on ion beam on an initial layer to form an inner sublayer;

FIG. 8 schematically illustrates a step(s) in methods of making a coated article comprising evaporating a functionalized POSS and impinging an ion beam on a first major surface of a substrate to form an inner surface of the inner sublayer;

FIG. 9 schematically illustrates a step in methods of making a coated article comprising disposing an outer layer of a silica-containing material on the inner sublayer;

FIG. 10 schematically illustrates a step in methods of making a coated article comprising disposing a solution over a first major surface of a substrate;

FIG. 11 schematically illustrates a step in methods of making a coated article comprising disposing a surface-modifying layer on a planarization surface;

FIG. 12 schematically illustrates a step in methods of making a coated article comprising heating the solution on the first major surface;

FIG. 13 schematically illustrates contour corresponding to water contact angles of a surface-modifying layer as a function of an average domain height (in nm) on the vertical axis (i.e., y-axis) and an area density of domains (per μm²) on the horizontal axis (i.e., x-axis) for the outer surface of the planarization layer;

FIG. 14 schematically illustrates surface roughness Ra (in nm) on the vertical axis (i.e., y-axis) as a function of current (in amps) for a Kaufman-type ion beam source on the horizontal axis (i.e., x-axis);

FIG. 15 schematically illustrates a depth of material (in nm) removed from the initial layer on the vertical axis (i.e., y-axis) as a function of function of current (in amps) for a Kaufman-type ion beam source on the horizontal axis (i.e., x-axis);

FIG. 16 schematically illustrates surface roughness Ra (in nm) on the vertical axis (i.e., y-axis) as a function of ion material on the horizontal axis (i.e., x-axis);

FIG. 17 schematically illustrates a depth of material (in nm) removed from the initial layer on the vertical axis (i.e., y-axis) as a function of function of ion material on the horizontal axis (i.e., x-axis);

FIG. 18 schematically illustrates surface roughness Ra (in nm) on the vertical axis (i.e., y-axis) as a function of time (in min) that the ion beam impinges the initial surface on the horizontal axis (i.e., x-axis);

FIG. 19 schematically illustrates a depth of material (in nm) removed from the initial layer on the vertical axis (i.e., y-axis) as a function of time (in min) that the ion beam impinges the initial surface on the horizontal axis (i.e., x-axis);

FIG. 20 schematically illustrates a relationship between a change in surface roughness Ra (%) on the vertical axis (i.e., y-axis) as a result of deposition rate (in Å/s) and deposited thickness (in nm) as the outer layer of the planarization layer on the horizontal axis (i.e. x-axis);

FIG. 21 schematically illustrates a relationship between a steel-wool abraded water contact angle (°) of the surface-modifying layer on the vertical axis (i.e., y-axis) as a function of a surface roughness Ra (in nm) of the outer surface of the planarization layer on the horizontal axis (i.e., x-axis);

FIG. 22 schematically illustrates a relationship between a steel-wool abraded water contact angle (°) of the surface-modifying layer on the vertical axis (i.e., y-axis) as a function of surface height variation (in μm²) of an outer surface of the planarization layer on the horizontal axis (i.e., x-axis);

FIG. 23 schematically illustrates a relationship between a steel-wool abraded water contact angle (°) of the surface-modifying layer on the vertical axis (i.e., y-axis) as a function of a ratio of a peak height to a surface height variation (in nm/μm²) of an outer surface of the planarization layer on the horizontal axis (i.e., x-axis);

FIGS. 24A-24F illustrate contours corresponding to a steel-wool abraded water contact angle (°) of the surface modifying layer for combinations of various processing conditions using a Kaufman-type ion beam source (as discussed below);

FIG. 25 schematically illustrates surface roughness Ra (in nm) on the vertical axis (i.e., y-axis) as a function of a voltage (in volts) of a linear ion beam source (i.e., x-axis);

FIG. 26 schematically illustrates a water contact angle (°) of a surface-modifying layer on the vertical axis (i.e., y-axis) as a function of a voltage (in volts) of a linear ion beam source (i.e., x-axis) used in forming the planarization layer;

FIG. 27 schematically illustrates surface roughness Ra (in nm) on the vertical axis (i.e., y-axis) as a function of ion material on the horizontal axis (i.e., x-axis);

FIG. 28 schematically illustrates a water contact angle (°) of a surface-modifying layer on the vertical axis (i.e., y-axis) as a function of function of ion material on the horizontal axis (i.e., x-axis);

FIG. 29 schematically illustrates surface roughness Ra (in nm) on the vertical axis (i.e., y-axis) as a function of a distance between the linear ion beam source and the initial layer (in mm) on the horizontal axis (i.e., x-axis);

FIG. 30 schematically illustrates a water contact angle (°) of a surface-modifying layer on the vertical axis (i.e., y-axis) as a function of a distance between the linear ion beam source and the initial layer (in mm) on the horizontal axis (i.e., x-axis);

FIGS. 31A-31C illustrate a steel-wool abraded water contact angle (°) of the surface modifying layer on the vertical axis (i.e., y-axis) as a function of various processing conditions using a linear ion beam source (as discussed below);

FIGS. 31D-31F illustrate a change in surface roughness Ra (in nm) of the planarization layer on the vertical axis (i.e., y-axis) as a function of various processing conditions using a linear ion beam source (as discussed below);

FIG. 32 schematically illustrates a relationship between a steel-wool abraded water contact angle (°) of the surface-modifying layer on the vertical axis (i.e., y-axis) as a function of a surface roughness Ra (in nm) of the outer surface of the planarization layer on the horizontal axis (i.e., x-axis);

FIG. 33 schematically illustrates a relationship between a steel-wool abraded water contact angle (°) of the surface-modifying layer on the vertical axis (i.e., y-axis) as a function of surface height variation (in μm²) of an outer surface of the planarization layer on the horizontal axis (i.e., x-axis); and

FIG. 34 schematically illustrates a relationship between a steel-wool abraded water contact angle (°) of the surface-modifying layer on the vertical axis (i.e., y-axis) as a function of a ratio of a peak height to a surface height variation (in nm/μm²) of an outer surface of the planarization layer on the horizontal axis (i.e., x-axis).

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

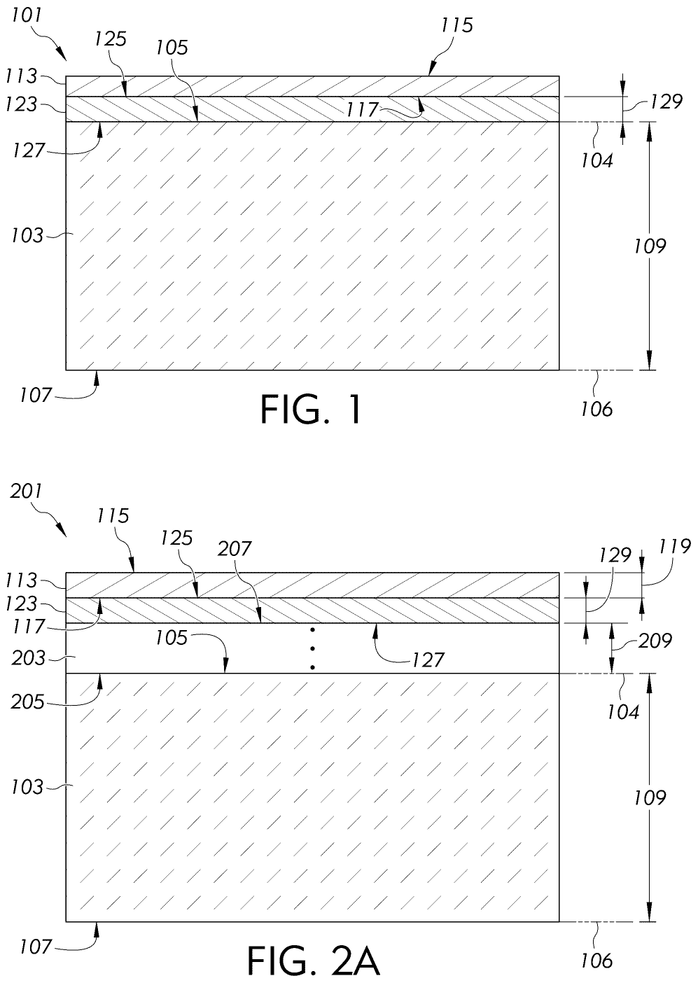

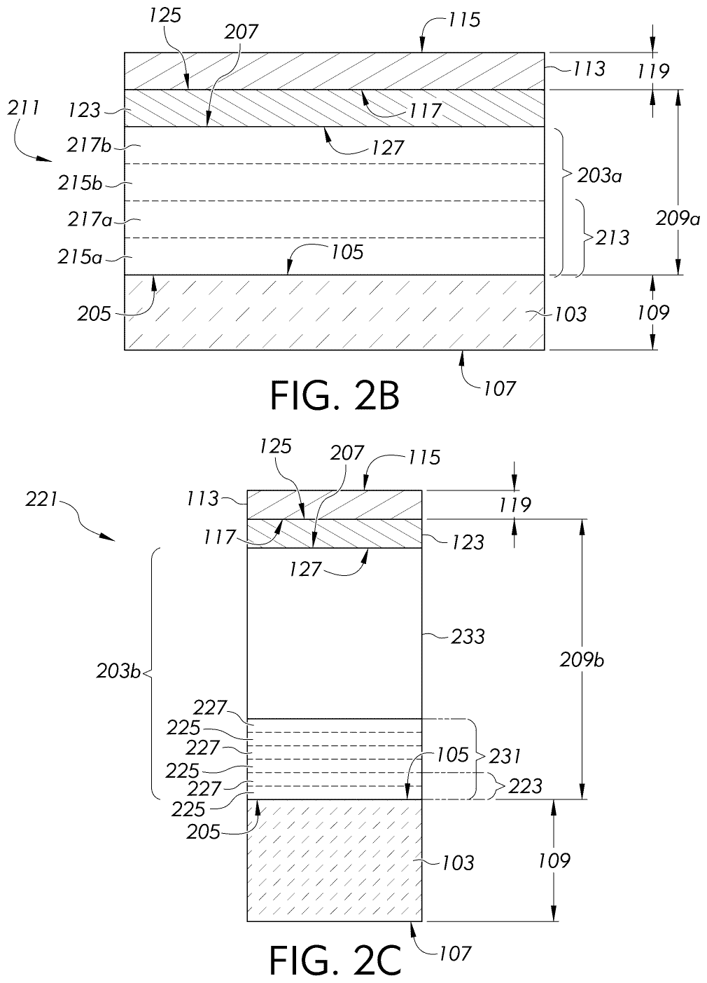

FIGS. 1 and 2A-2C illustrate views of a coated article 101, 201, 211, or 221 comprising a planarization layer 123 disposed over a substrate 103 in accordance with aspects of the disclosure. In aspects, as shown, the coated article 101, 201, 211, or 221 further comprises a surface-modifying layer 113 disposed on the planarization layer 123 with the planarization layer 123 positioned between surface-modifying layer 113 and the substrate 103. In aspects, as shown in FIGS. 2A-2C, the coated article 201, 211, and/or 221 can comprise an optical stack 203, 203a, and/or 203b, an optical film 231, and/or a scratch-resistant layer 233 that can impart increased hardness, an anti-glare property, an anti-reflection property, or combinations thereof to the coated article. Unless otherwise noted, a discussion of features of aspects of one planarization layer or coated article can apply equally to corresponding features of any aspects of the disclosure. For example, identical part numbers throughout the disclosure can indicate that, in some aspects, the identified features are identical to one another and that the discussion of the identified feature of one aspect, unless otherwise noted, can apply equally to the identified feature of any of the other aspects of the disclosure.

As shown in FIGS. 1 and 2A-2C, the substrate 103 comprises a first major surface 105 and a second major surface 107 opposite the first major surface 105. As shown, the first major surface 105 can extend along a first plane 104, and/or the second major surface 107 can extend along a second plane 106. In aspects, as shown, the second plane 106 can be parallel to the first plane 104. As used herein, a substrate thickness 109 is defined between the first major surface 105 and the second major surface 107 as a distance between the first plane 104 and the second plane 106. In aspects, the substrate thickness 109 can be greater than or equal to 10 micrometers (μm), greater than or equal to 25 μm, greater than or equal to 40 μm, greater than or equal to 60 μm, greater than or equal to 70 μm, greater than or equal to 80 μm, greater than or equal to 90 μm, greater than or equal to 100 μm, greater than or equal to 125 μm, greater than or equal to 150 μm, greater than or equal to 200 μm, greater than or equal to 300 μm, less than or equal to 3 millimeters (mm), less than or equal to 2 mm, less than or equal to 1 mm, less than or equal to 800 μm, less than or equal to 500 μm, less than or equal to 300 μm, less than or equal to 200 μm, less than or equal to 180 μm, or less than or equal to 160 μm. In aspects, the substrate thickness 109 can range from greater than or equal to 10 μm to less than or equal to 3 mm, from greater than or equal to 25 μm to less than or equal to 2 mm, from greater than or equal to 40 μm to less than or equal to 2 mm, from greater than or equal to 60 μm to less than or equal to 2 mm, from greater than or equal to 70 μm to less than or equal to 2 mm, from greater than or equal to 70 μm to less than or equal to 1 mm, from greater than or equal to 70 μm to less than or equal to 800 μm, from greater than or equal to 80 μm to less than or equal to 500 μm, from greater than or equal to 90 μm to less than or equal to 500 μm, from greater than or equal to 100 μm to less than or equal to 200 μm, from greater than or equal to 125 μm to less than or equal to 200 μm, from greater than or equal to 150 μm to less than or equal to 200 μm, from greater than or equal to 150 μm to less than or equal to 160 μm, or any range or subrange therebetween. Alternatively, the substrate thickness 109 can be from greater than or equal to 1 millimeter (mm) to less than or equal to 5 mm, from greater than or equal to 1 mm to less than or equal to 3 mm, or any range or subrange therebetween.

The substrate 103 can comprise a glass-based material and/or a ceramic-based material, for example, having a pencil hardness of greater than or equal to 8H (e.g., greater than or equal to 9H). As used herein, pencil hardness is measured using ASTM D 3363-20 with standard lead graded pencils. Providing a glass-based substrate and/or a ceramic-based substrate can enhance puncture resistance and/or impact resistance. As used herein, “glass-based” includes both glasses and glass-ceramics, wherein glass-ceramics have one or more crystalline phases and an amorphous, residual glass phase. A glass-based material may comprise an amorphous material (e.g., glass) and optionally one or more crystalline materials (e.g., ceramic). Exemplary glass-based materials may be an alkali-free glass and/or comprise a low content of alkali metals (e.g., R₂O of less than or equal to 10 mol %, wherein R₂O comprises Li₂O Na₂O, and K₂O). As used herein, “ceramic-based” includes both ceramics and glass-ceramics, wherein glass-ceramics have one or more crystalline phases and an amorphous, residual glass phase. In aspects, ceramic-based materials can comprise one or more oxides, nitrides, oxynitrides, carbides, borides, and/or silicides. Throughout the disclosure, the Young's modulus of the glass-based materials and ceramic-based materials are measured using the resonant ultrasonic spectroscopy technique set forth in ASTM E2001-13, titled “Standard Guide for Resonant Ultrasound Spectroscopy for Defect Detection in Both Metallic and Non-metallic Parts.” In aspects, the substrate 103 can comprise an elastic modulus ranging from about 10 GPa to about 100 GPa, from about 40 GPa to about 100 GPa, from about 60 GPa to about 100 GPa, from about 60 GPa to about 80 GPa, from about 80 GPa to about 100 GPa, or any range or subrange therebetween.

In aspects, the substrate 103 can be optically transparent. As used herein, “optically transparent” or “optically clear” means an average transmittance of greater than or equal to 70% in the wavelength range of 400 nm to 750 nm through a 1.0 mm thick piece of a material. In aspects, an “optically transparent material” or an “optically clear material” may have an average transmittance of greater than or equal to 75%, greater than or equal to 80%, greater than or equal to 85%, or greater than or equal to 90%, greater than or equal to 91%, greater than or equal to 92%, greater than or equal to 93%, greater than or equal to 94%, or greater than or equal to 96% in the wavelength range of 400 nm to 750 nm through a 1.0 mm thick piece of the material. The average transmittance in the wavelength range of 400 nm to 700 nm is calculated by measuring the transmittance of whole number wavelengths from about 400 nm to about 700 nm and averaging the measurements.

In aspects, the coated article 101, 201, 211, or 221 comprising a glass-based substrate and/or a ceramic-based substrate can comprise one or more compressive stress regions. In aspects, a compressive stress region may be created by chemically strengthening. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate 103 can enable good impact resistance, good puncture resistance, and/or enable small bend radii, for example, with the compressive stress from the chemical strengthening counteracting bend-induced tensile stress on the outermost surface of the substrate. A compressive stress region may extend into a portion of the first portion and/or the second portion for a depth called the depth of compression (DOC). As used herein, depth of compression means the depth at which the stress in the chemically strengthened substrates and/or portions described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate and/or portion is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 400 μm, SCALP is used to measure the depth of compression and central tension (CT). Where the stress in the substrate and/or portion is generated by exchanging both potassium and sodium ions into the substrate and/or portion, and the article being measured is thicker than about 400 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate and/or portion (e.g., sodium, potassium). Throughout the disclosure, DOL is measured in accordance with ASTM C-1422. Without wishing to be bound by theory, a DOL is usually greater than or equal to the corresponding DOC. Through the disclosure, when the maximum central tension cannot be measured directly by SCALP (as when the article being measured is thinner than about 400 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the substrate 103 may comprise a first compressive stress region at the first major surface 105 that can extend to a first depth of compression from the first major surface 105. In aspects, the substrate 103 may comprise a second compressive stress region at the second major surface 107 that can extend to a second depth of compression from the second major surface 107. In aspects, the first depth of compression and/or the second depth of compression as a percentage of the substrate thickness 109 can be greater than or equal to 5%, greater than or equal to 10%, greater than or equal to 12%, greater than or equal to 15%, greater than or equal to 17%, less than or equal to 30%, less than or equal to 25%, less than or equal to 22%, less than or equal to 20%, less than or equal to 17%, or less than or equal to 15%. In aspects, the first depth of compression and/or the second depth of compression as a percentage of the substrate thickness 109 can range from greater than or equal to 5% to less than or equal to 30%, from greater than or equal to 10% to less than or equal to 25%, from greater than or equal to 10% to less than or equal to 22%, from greater than or equal to 12% to less than or equal to 20%, from greater than or equal to 12% to less than or equal to 17%, from greater than or equal to 15% to less than or equal to 17%, or any range or subrange therebetween. In aspects, the first depth of compression and/or the second depth of compression can be greater than or equal to 1 μm, about greater than or equal to 10 μm, greater than or equal to 15 μm, greater than or equal to 20 μm, greater than or equal to 25 μm, greater than or equal to 30 μm, less than or equal to 200 μm, less than or equal to 150 μm, less than or equal to 100 μm, less than or equal to 60 μm, less than or equal to 45 μm, less than or equal to 30 μm, or less than or equal to 20 μm. In aspects, the first depth of compression and/or the second depth of compression can range from greater than or equal to 1 μm to less than or equal to 200 μm, from greater than or equal to 1 μm to less than or equal to 150 μm, from greater than or equal to 10 μm to less than or equal to 100 μm, from greater than or equal to 15 μm to less than or equal to 600 μm, from greater than or equal to 20 μm to less than or equal to 45 μm, from greater than or equal to 20 μm to less than or equal to 30 μm, or any range or subrange therebetween. By providing a first portion comprising a first glass-based and/or ceramic-based portion comprising a first depth of compression and/or a second depth of compression from greater than or equal to 1% to less than or equal to 30% of the first thickness, good impact and/or puncture resistance can be enabled.

In aspects, the first compressive stress region can comprise a maximum first compressive stress, and/or the second compressive stress region can comprise a maximum second compressive stress. In further aspects, the maximum first compressive stress and/or the maximum second compressive stress can be greater than or equal to 100 MegaPascals (MPa), greater than or equal to 300 MPa, greater than or equal to 400 MPa, greater than or equal to 500 MPa, greater than or equal to 600 MPa, greater than or equal to 700 MPa, less than or equal to 1,500 MPa, less than or equal to 1,200 MPa, less than or equal to 1,000 MPa, or less than or equal to 800 MPa. In further aspects, the maximum first compressive stress and/or the maximum second compressive stress can range from greater than or equal to 100 MPa to less than or equal to 1,500 MPa, from greater than or equal to 100 MPa to less than or equal to 1,200 MPa, from greater than or equal to 300 MPa to less than or equal to 1,200 MPa, from greater than or equal to 300 MPa to less than or equal to 1,000 MPa, from greater than or equal to 400 MPa to less than or equal to 1,000 MPa, from greater than or equal to 500 MPa to less than or equal to 1,000 MPa, from greater than or equal to 600 MPa to less than or equal to 900 MPa, from greater than or equal to 700 MPa to less than or equal to 800 MPa, or any range or subrange therebetween. By providing a maximum first compressive stress and/or a maximum second compressive stress from greater than or equal to 100 MPa to less than or equal to 1,500 MPa, good impact and/or puncture resistance can be enabled.

In aspects, the substrate 103 may comprise a tensile stress region. The tensile stress region can be positioned between the first compressive stress region and the second compressive stress region. In aspects, the tensile stress region can comprise a maximum tensile stress. In further aspects, the maximum first stress can be greater than or equal to 10 MPa, greater than or equal to 20 MPa, greater than or equal to 30 MPa, less than or equal to 100 MPa, less than or equal to 80 MPa, or less than or equal to 60 MPa. In further aspects, the maximum tensile stress can range from greater than or equal to 10 MPa to less than or equal to 100 MPa, from greater than or equal to 10 MPa to less than or equal to 80 MPa, from greater than or equal to 20 MPa to less than or equal to 80 MPa, from greater than or equal to 30 MPa to less than or equal to 60 MPa, or any range or subrange therebetween. Providing a maximum tensile stress from greater than or equal to 10 MPa to less than or equal to 100 MPa can enable good impact and/or puncture resistance.

As used herein, if a first layer and/or component is described as “disposed over” a second layer and/or component, other layers may or may not be present between the first layer and/or component and the second layer and/or component. Furthermore, as used herein, “disposed over” does not refer to a relative position with reference to gravity. For example, a first layer and/or component can be considered “disposed over” a second layer and/or component, for example, when the first layer and/or component is positioned underneath, above, or to one side of a second layer and/or component. As used herein, a first layer and/or component described as “bonded to” a second layer and/or component means that the layers and/or components are bonded to each other, either by direct contact and/or bonding between the two layers and/or components or via an adhesive layer. As used herein, a first layer and/or component described as “contacting” or “in contact with” a second layer and/or components refers to direct contact and includes the situations where the layers and/or components are bonded to each other. As used herein, a first layer and/or component described as “disposed on” a second layer and/or component means that the layers do not have any other layers therebetween other than an optional layer of a coupling agent or are bonded together. Consequently, a first layer disposed over a second layer may further be disposed on, in contact with, and/or bonded to the second layer.

In aspects, as shown in FIGS. 2A-2C, the coated article 201, 211, or 221 can comprise an optical stack 203 comprising a third major surface 205 disposed on the first major surface 105 of the substrate 103. As shown, the optical stack 203 can comprise a fourth major surface 207 opposite the third major surface 205 with a stack thickness 209 defined therebetween. In aspects, the stack thickness 209 can be greater than or equal to 10 nanometers (nm), greater than or equal to 50 nm, greater than or equal to 100 nm, greater than or equal to 300 nm, greater than or equal to 500 nm, greater than or equal to 700 nm, greater than or equal to 1 μm, less than or equal to 10 μm, less than or equal to 5 μm, less than or equal to 2 μm, or less than or equal to 1 μm. In aspects, the stack thickness 209 can range from greater than or equal to 10 nm to less than or equal to 10 μm, from greater than or equal to 50 nm to less than or equal to 5 μm, from greater than or equal to 100 nm to less than or equal to 2 μm, from greater than or equal to 300 nm to less than or equal to 1 μm, from greater than or equal to 500 nm to less than or equal to 1 μm, or any range or subrange therebetween. In exemplary aspects, the stack thickness 209 can range from greater than or equal to 10 nm to less than or equal to 10 μm, from greater than or equal to 50 nm to less than or equal to 5 μm, or from greater than or equal to 50 nm to less than or equal to 500 nm.

In further aspects, the optical stack 203 can comprise an anti-reflective (AR) coating, a band-pass filter coating, an edge neutral mirror, a beam splitter coating, a multi-layer high-reflectance coating, and/or an edge filter coating. For example, the anti-reflective coating of the optical stack 203 can be positioned between the surface-modifying layer 113 and the substrate 103, and/or the anti-reflective coating of the optical stack 203 can be positioned between the planarization layer 123 and the substrate 103. In even further aspects, the optical stack 203 (e.g., anti-reflective coating) can comprise two or more layers with differing refractive index values, for example, with a first low refractive index (RI) from about 1.3 to about 1.6 and a second high refractive index (RI) from about 1.6 to about 3.0. In still further aspects, the two or more layers of the optical stack 203 can form an alternative set of layers, for example, 2 sets or more, 3 sets or more, 5 sets or more, or 10 sets or more, for example, from 2 to 15 periods, from 2 to 10 periods, from 2 to 12 periods, from 3 to 8 periods, from 3 to 6 periods, or any range or subrange therebetween.

In aspects, as shown in FIG. 2B, the coated article 211 comprises optical stack 203a comprising a plurality of a silicon-containing oxide, a silicon-containing nitride, a silicon-containing oxynitride, and/or Nb₂O₅ layers. For example, the optical stack 203a can be an anti-reflective coating. As shown, the optical stack 203a can comprise one or more periods 213 comprising two or more layers with different refractive indices, for example, a first low RI layer 215a and a second high RI layer 217a. For example, the optical stack 203a shown in FIG. 2B has 2 periods 213 comprising first low RI layers 215a and 215b (L) and a second high RI layers 217a and 217b (H) that alternate in the following sequence of layers: L/H/L/H, although H/L/H/L could be provided in other aspects. An absolute value of a difference between the first low RI layer 215a and a second high RI layer 217a can be greater than or equal to 0.01, greater than or equal to 0.05, greater than or equal to 0.1, or greater than or equal to 0.2 or more. Exemplary materials for the first low RI layer 215a include SiO₂, Al₂O₃, GeO₂, AlOₓN_{y} (e.g., Al_{1-x-y}OₓN_{y}), SiOₓN_{y} (e.g., Si_{1-x-y}N_{y}), SiᵤAlᵥOₓN_{y}, MgO, and MgAl₂O₄. Exemplary materials for the second high RI layer 217a include SiᵤAlᵥOₓN_{y}, AlN, oxygen-doped SiNₓ (e.g., Si₁₋ₓNₓ), Si₃N₄, AlOₓN_{y} (e.g., Al_{1-x-y}OₓN_{y}), SiOₓN_{y} (e.g., Si_{1-x-y}OₓN_{y}), Ta₂O₅, Nb₂O₅, HfO₂, TiO₂, ZrO₂, Y₂O₃, ZrO₂, Al₂O₃, and diamond-like carbon. The oxygen content of the materials for the high RI layer(s) 130B may be minimized, especially in SiNₓ (e.g., Si₁₋ₓNₓ) or AlN, (e.g., Al₁₋ₓNₓ) materials. The foregoing materials may be hydrogenated up to about 30% by weight. As used herein, it is to be understood that the subscripts (e.g., “u,” “v”, “x,” “y,” and “z”) range from greater than 0 to 1, where the subscripts sum to 1 to represent an “atomic fraction formula.” See, for example: (i) Charles Kittel, Introduction to Solid State Physics, seventh edition, John Wiley & Sons, Inc., NY, 1996, pp. 611-627; (ii) Smart and Moore, Solid State Chemistry, An introduction, Chapman & Hall University and Professional Division, London, 1992, pp. 136-151; and (iii) James F. Shackelford, Introduction to Materials Science for Engineers, Sixth Edition, Pearson Prentice Hall, New Jersey, 2005, pp. 404-418. The balance of the material (i.e., 1 minus the sum of the subscripts) is the first atom (e.g., SiNₓ with x=0.57 actually corresponds to Si_{0.43}N_{0.57}, which is the same as Si₃N₄). Also, the sum of all subscripts is greater than 0.

In aspects, the optical stack 203a can include the antireflective structure, antireflective coating, or outer optical film described in U.S. Pat. No. 10,948,629, issued Mar. 16, 2021, U.S. Published Application No. 2022/0011468, and/or WIPO Publication WO 2022/125846, which are incorporated by reference in their entirety. Although not shown, the optical stack 203a can comprise a capping layer, for example, a low refractive index material, which can be the same material as the first low RI layer 215a. In further aspects, the capping layer can comprise a silicon-containing oxide (e.g., silicon dioxide), a silicon-containing nitride (e.g., an oxide-doped silicon nitride, silicon nitride, etc.), and a silicon-containing oxynitride (e.g., silicon oxynitride). An exemplary aspect of the capping layer is silicon dioxide (SiO₂). Alternatively, the planarization layer 123 can function fulfil the functions associated with a so-called capping layer, and/or a capping layer (distinct from the planarization layer 123) may not be present the coated article. In aspects, as shown, the layer of the optical stack 203 closest to the substrate 103 can be a low index layer (i.e., first low RI layer 215a) and the layer closest to the planarization layer 123 can be a low index layer (e.g., capping layer 219). An exemplary combination of materials for the optical stack is SiO₂ for the first low RI layer, silicon nitride (e.g., Si₃N₄, SiNₓ) or silicon oxynitride (SiOₓN_{y}) for the second high RI layer, and silicon dioxide (SiO₂) for the capping layer.

In aspects, the coated article 211 can comprise a stack thickness 209a corresponding to a physical thickness of the optical stack 203a in a range from greater than or equal to 50 nm to less than 500 nm, from greater than or equal to 75 nm to less than or equal to 490 nm, from greater than or equal to 100 nm to less than or equal to 480 nm, from greater than or equal to 125 nm to less than or equal to 475 nm, from greater than or equal to 150 nm to less than or equal to 450 nm, from greater than or equal to 175 nm to less than or equal to 425 nm, from greater than or equal to 200 nm to less than or equal to 400 nm, from greater than or equal to 225 nm to less than or equal to 375 nm, from greater than or equal to 250 nm to less than or equal to 350 nm, from greater than or equal to 250 nm to less than or equal to 340 nm, or any range or subrange therebetween. As used herein, the term “optical thickness” is determined by (n*d), where “n” refers to the RI of the sub-layer and “d” refers to the physical thickness of the layer. In aspects, at least one layer in the optical stack 203a can have an optical thickness from greater than or equal to 2 nm to less than or equal to 200 nm, from greater than or equal to 10 nm to less than or equal to 100 nm, from greater than or equal to 15 nm to less than or equal to 90 nm, from greater than or equal to 50 nm to less than or equal to 80 nm, or any range or subrange therebetween. In further aspects, the first low RI layers 215a and 215b in periods 213 in the optical stack 203 can be within or more of the ranges mentioned in the previous sentence. In aspects, a combined physical thickness of the second high RI layers 217a and 217b can be greater than or equal to 90 nm, greater than or equal to 100 nm, greater than or equal to 120 nm, greater than or equal to 130 nm, greater than or equal to 150 nm, or less than 500 nm. For example, the combined physical thickness of the second high RI layers 217a and 217b can range from greater than or equal to 90 nm to less than 500 nm, from greater than or equal to 100 nm to less than or equal to 300 nm, from greater than or equal to 120 nm to less than or equal to 200 nm, or any range or subrange therebetween. In aspects, the combined physical thickness of the second high RI layers 217a and 217b as a percentage of the physical thickness of the stack thickness 209a can be greater than or equal to 30%, greater than or equal to 35%, greater than or equal to 40%, or greater than or equal to 45%, for example, ranging from greater than or equal to 35% to less than or equal to 75%, from greater than or equal to 40% to less than or equal to 65%, from greater than or equal to 45% to less than or equal to 55%, or any range or subrange therebetween.

In aspects, the optical stack 203a of the coated article 211 can comprise a residual stress of less than about +50 MPa (tensile) to about −1000 MPa (compression). In some aspects, the anti-reflective coating can be characterized by a residual stress from about −50 MPa to about −1000 MPa (compression) or from about −75 MPa to about −800 MPa (compression). Unless otherwise noted, residual stress in the anti-reflective coating is obtained by measuring the curvature of the substrate 103 before and after deposition of the anti-reflective coating, and then calculating residual film stress according to the Stoney equation according to principles known and understood by those with ordinary skill in the field of the disclosure.

In aspects, the optical stack 203a and/or the coated article 211 may exhibit a visible photopic average reflectance of less than or equal to 1%, less than or equal to 0.9%, less than or equal to 0.8%, less than or equal to 0.7%, less than or equal to 0.6%, less than or equal to 0.5%, less than or equal to 0.4%, less than or equal to 0.3%, or less than or equal to 0.2%, over the optical wavelength regime. These photopic average reflectance values may be exhibited at incident illumination angles in the range from about 0° to about 20°, from about 0° to about 40°, or from about 0° to about 60°. As used herein, “photopic average reflectance” mimics the response of the human eye by weighting the reflectance versus wavelength spectrum according to the human eye's sensitivity. Photopic average reflectance may also be referred to as the luminance, or tristimulus Y value of reflected light, according to known conventions, for example CIE color space conventions. The photopic average reflectance <Rₚ> is defined as the integral of the spectral reflectance, R(λ), multiplied by the illuminant spectrum, I(λ), and the CIE's color matching function, y̅(λ), related to the eye's spectral response:

<Rₚ>=∫_{380 nm}^{720 nm}R(λ)×I(λ)×y̅(λ)dλ.

Further, the article exhibits a CIE a* value, in reflectance, from about −10 to +2 and a CIE b* value, in reflectance, from −10 to +2, the CIE a* and CIE b* values each measured on the optical film structure at a normal incident illumination angle. In aspects, the optical stack 203a and/or the coated article 211 can exhibit a photopic average light transmission of greater than or equal to 90%, greater than or equal to 92%, greater than or equal to 94%, greater than or equal to 96%, or greater than or equal to 98%, over the optical wavelength regime. In some embodiments, the optical stack 203a and/or the coated article 211 exhibits an average light transmission of greater than or equal to 87%, greater than or equal to 88%, greater than or equal to 89%, greater than or equal to 90%, greater than or equal to 91%, greater than or equal to 92%, greater than or equal to 93%, greater than or equal to 94%, or greater than or equal to 95%, over the optical wavelength regime in the infrared spectrum from 800 nm to 1000 nm, from 900 nm to 1000 nm, or from 930 nm to 950 nm. In aspects, the optical stack 203a and/or the coated article 211 can exhibit a hardness of 8 GPa or greater measured at an indentation depth of about 100 nm or a maximum hardness of 9 GPa or greater measured over an indentation depth range from greater than or equal to 100 nm to less than or equal to 500 nm, the hardness and the maximum hardness measured by a Berkovich Indenter Hardness Test (as defined below).

In aspects, as shown in FIG. 2B, the coated article 211 comprises optical stack 203a comprising an optical film 231, and a scratch-resistant layer 233. In aspects, the optical stack 203b can include the scratch resistant coating, anti-reflective coating, and/or optical film structure described in U.S. Pat. No. 9,328,016, issued May 3, 2016, U.S. Pat. No. 9,684,097, issued Jun. 20, 2017, U.S. Pat. No. 9,703,011, issued Jul. 11, 2017, U.S. Pat. No. 9,079,802, issued Jul. 14, 2015, U.S. Pat. No. 9,726,786, issued Aug. 8, 2017, U.S. Pat. No. 10,416,352, issued Sep. 17, 2019, which are incorporated by reference in their entirety. For example, the optical stack 203b can be an anti-reflective coating and/or a scratch-resistant coating.

In further aspects, as shown in FIG. 2C, the optical film 130 of the optical stack 203b can comprise one or more periods 223 comprising two or more layers with different refractive indices, for example, a first low RI layer 225 and a second high RI layer 227. For example, the optical stack 203b shown in FIG. 2C has 3 periods 223 forming the optical film 231 with alternating first low RI layers 225 and second high RI layers 227. In even further aspects, the optical film 231 can comprise any number of periods, for example, within one or more of the ranges discussed above for the optical stack 203a. An absolute value of a difference between the first low RI layers 225 and the second high RI layers 227 can be greater than or equal to 0.01, greater than or equal to 0.05, greater than or equal to 0.1, or greater than or equal to 0.2. In further aspects, the first low RI layers 225 can comprise any of the materials discussed above for the first low RI layer 215a, for example, silicon dioxide (SiO₂). In further aspects, the second high RI layers 227 can comprise any of the materials discussed above for the second high RI layer 217a, for example, SiOₓN_{y}. In further aspects, a layer of the first low RI sub-layers 225 and/or the second high RI sub-layers 227 can comprise an optical thickness (n*d) in the range from greater than or equal to 2 nm to less than or equal to 200 nm, from greater than or equal to 10 nm to less than or equal to 100 nm, from greater than or equal to 15 nm to less than or equal to 100 nm, or any range or subrange therebetween. In even further aspects, all of the layers in the optical film 130 or all of the second high RI layers in the optical film 130 can have an optical thickness within one or more of the ranges mentioned in the previous sentence. In further aspects, a layer of the first low RI sub-layers 225 and/or the second high RI sub-layers 227 can comprise a physical thickness from greater than or equal to 10 nm to less than or equal to 800 nm, from greater than or equal to 10 nm to less than or equal to 500 nm, from greater than or equal to 10 nm to less than or equal to 300 nm, from greater than or equal to 10 nm to less than or equal to 200 nm, from greater than or equal to 20 nm to less than or equal to 100 nm, or any range or subrange therebetween. In further aspects, the optical stack 203 and/or any one or of the layers or sections therein (e.g., optical film 231, a scratch-resistant layer 233) may exhibit an extinction coefficient (at a wavelength of about 400 nm) of less than or equal to 10⁻⁴.

In further aspects, as shown in FIG. 2C, the scratch-resistant layer 233 can include an inorganic carbide, nitride, oxide, diamond-like material, or combination of these. Examples of suitable materials for the scratch-resistant layer 233 include metal oxides, metal nitrides, metal oxynitride, metal carbides, metal oxycarbides, and/or combinations thereof combination thereof. Exemplary metals include B, Al, Si, Ti, V, Cr, Y, Zr, Nb, Mo, Sn, Hf, Ta and W. Specific examples of materials that may be utilized in the scratch-resistant layer 233 may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y}, or combinations thereof. In even further aspects, the scratch-resistant layer 233 can comprise the same material as the second high RI layers 227, for example, SiOₓN_{y}. In even further aspects, a physical thickness of the scratch-resistant layer and/or optical stack can be from greater than or equal to 0.05 μm to less than or equal to 3 μm, from greater than or equal to 0.1 μm to less than or equal to 3 μm, from greater than or equal to 0.2 μm to less than or equal to 3 μm, from greater than or equal to 0.3 μm to less than or equal to 2.2 μm, from greater than or equal to 0.5 μm to less than or equal to 2.1 μm, from greater than or equal to 1 μm to less than or equal to 2.1 μm, from greater than or equal to 1.8 μm to less than or equal to 2.1 μm, or any range or subrange therebetween. In exemplary aspects, a physical thickness of the scratch-resistant layer can be from greater than or equal to 0.05 μm to less than or equal to 3 μm, from greater than or equal to 0.3 μm to less than or equal to 2.2 μm, or from greater than or equal to 1 μm to less than or equal to 2.1 μm. The scratch-resistant layer 233 and/or the optical stack 203b may exhibit a hardness of greater than or equal to 8 GPa, greater than or equal to 10 GPa, greater than or equal to 13 GPa, or greater than or equal to 17 GPa, as measured by the Berkovich Indenter Hardness Test (as described below).

Although not shown, it is to be understood that the scratch-resistant layer can be sandwiched by portions of the optical film. For example, 3 or more periods can be positioned between the scratch-resistant layer and the substrate while 2 or more periods can be positioned between the scratch-resistant layer and the surface-modifying layer and/or between the scratch-resistant layer and the planarization layer.

In further aspects, although not shown, the optical stack can comprise capping layer disposed over (e.g., disposed on) the scratch-resistant layer. In even further aspects, the capping layer can include a low refractive index material, such as SiO₂, Al₂O₃, GeO₂, SiO₂, AlOₓN_{y}, SiOₓN_{y}, SiᵤAlᵥOₓN_{y}, MgO, MgF₂, BaF₂, CaF₂, DyF₃, YbF₃, YF₃, or CeF₃. In further aspects, the capping layer can comprise the same material as the first high RI layers 225, for example, SiO₂. In further aspects, a thickness of the capping layer can be from greater than or equal to 10 nm to less than or equal to 120 nm, from greater than or equal to 20 nm to less than or equal to 115 nm, from greater than or equal to 50 nm to less than or equal to 110 nm, from greater than or equal to 80 nm to less than or equal to 110 nm, from greater than or equal to 90 nm to less than or equal to 105 nm, or any range or subrange therebetween. The capping layer may exhibit an intrinsic hardness in the range from greater than or equal to 7 GPa to less than or equal to 10 GPa, as measured by the Berkovich Indenter Hardness Test (as measured on the surface of a layer of the same material of the capping layer, formed in the same manner, but having a thickness of about 1 micrometer or greater). Alternatively, the planarization layer can function as a capping layer without the coated article comprising a separate capping layer.

In further aspects, a stack thickness 209b corresponding to a physical thickness of the optical stack 203b can range from greater than or equal to 0.5 μm to less than or equal to 3 μm, from greater than or equal to 1 μm to less than or equal to 3 μm, from greater than or equal to 1.2 μm to less than or equal to 3 μm, from greater than or equal to 1.5 μm to less than or equal to 3 μm, from greater than or equal to 2 μm to less than or equal to 2.6 μm, or any range or subrange therebetween. In further aspects, the optical stack 203b can exhibit an average light reflectance of less than or equal to 0.5%, less than or equal to 0.25%, less than or equal to 0.1%, or even greater than or equal to 0.05% over the optical wavelength regime. In further aspects, the optical stack 203b can exhibit an average transmittance or average reflectance having an average oscillation amplitude of about 5 percentage points or less over the optical wavelength regime. In further aspects, the optical stack 203b may exhibit an average light transmission of greater than or equal to 80%, greater than or equal to 82%, greater than or equal to 85%, greater than or equal to 90%, greater than or equal to 90.5%, greater than or equal to 91%, greater than or equal to 91.5%, greater than or equal to 92%, greater than or equal to 92.5%, greater than or equal to 93%, greater than or equal to 93.5%, greater than or equal to 94%, greater than or equal to 94.5%, or greater than or equal to 95%.

The optical stack 203, 203a, or 203b may be formed using various deposition methods, for example, vacuum deposition techniques, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (e.g., reactive or nonreactive sputtering or laser ablation), thermal or e-beam evaporation and/or atomic layer deposition. Liquid-based methods may also be used, for example, printing, spraying, or slot coating. Where vacuum deposition is utilized, inline processes may be used to form the optical stack 203, 203a, or 203b in one deposition run. In aspects, the vacuum deposition can be made by a linear PECVD source. In aspects, the optical stack 203, 203a, or 203b can be prepared using a sputtering process (e.g., a reactive sputtering process), chemical vapor deposition (CVD) process, plasma-enhanced chemical vapor deposition process, or some combination of these processes. In aspects, the optical stack 203a or 203b comprising low RI layer(s) 215a, 215b, or 225 and high RI layer(s) 217a, 217b, or 227 can be prepared according to a reactive sputtering process. According to some embodiments, optical stack 203a or 203b (including low RI layer 215a, 215b, or 225 and/or high RI layer 217a, 217b, or 227) can be fabricated using a metal-mode, reactive sputtering in a rotary drum coater. The reactive sputtering process conditions were defined through careful experimentation to achieve the desired combinations of hardness, refractive index, optical transparency, low color, and controlled film stress.

In further aspects, the optical stack 203 can comprise a gradient coating comprising a refractive index gradient. For example, the gradient coating of the optical stack 203 can be positioned between the surface-modifying layer 113 and the substrate 103, and/or the gradient coating of the optical stack 203 can be positioned between the planarization layer 123 and the substrate 103. In even further aspects, the refractive index gradient can span a range of refractive index values of greater than or equal to 0.2, greater than or equal to 0.3, greater than or equal to 0.4, less than or equal to 1, less than or equal to 0.8, less than or equal to 0.6, or less than or equal to 0.5, for example, from greater than or equal to 0.2 to less than or equal to 1, from greater than or equal to 0.3 to less than or equal to 0.8, from greater than or equal to 0.4 to less than or equal to 0.6, or any range or subrange therebetween. In even further aspects, the gradient coating can comprise a concentration gradient of one or more of oxygen, nitrogen, and/or silicon. It should be understood, however, that other functional coatings may be provided in the optical stack 203 to achieve predetermined optical properties of the coated article 201, 211, or 221.

According to one or more aspects, an anti-reflective coating can be used in combination with an anti-glare (AG) surface. Anti-glare surface treatments can impact the performance of anti-reflective coatings. Thus, selection of the proper anti-glare surface can be important for optimal performance, particularly in difficult use environments, such as vehicle interiors. In such environments, anti-glare surfaces on a cover glass needs to have the minimum sparkle and provide the appropriate anti-glare effect and tactile while meeting a required Contrast Ratio (CR) under sunlight. For example, a sample can be prepared with a chemically-etched Ultra-Low Sparkle (ULS) AG surface on a glass substrate made of Corning® Gorilla® Glass with an anti-reflective coating according to embodiments of this disclosure, and an easy-to-clean (ETC) coating to provide stable color appearance with wide-viewing angles. The ambient contrast performance was evaluated at a system level to gauge the impact of AG/AR coating on sunlight viewability.

In the above-mentioned example, the anti-glare surface was prepared on a Corning® Gorilla® Glass substrate by using a chemical etching method that enables ultra-low sparkle performance suitable for high resolution display up to 300 pixels per inch (PPI). Then, the anti-glare glass optical properties can be analyzed, including with and without contributions from specular reflection (i.e., specular component excluded (SCE) or specular component included (SCI)), transmission haze, gloss, distinctness of image (DOI), and sparkle. Further information regarding these properties and how these measurement are made can be found in (1) C. Li and T. Ishikawa, Effective Surface Treatment on the Cover Glass for Auto-Interior Applications, SID Symposium Digest of Technical Papers Volume 1, Issue 36.4, pp. 467 (2016); (2) J. Gollier, G. A. Piech, S. D. Hart, J. A. West, H. Hovagimian, E. M. Kosik Williams, A. Stillwell and J. Ferwerda, Display Sparkle Measurement and Human Response, SID Symposium Digest of Technical Papers Volume 44, Issue 1 (2013); and (3) J. Ferwerda, A. Stillwell, H. Hovagimian and E. M. Kosik Williams, Perception of sparkle in anti-glare display screen, Journal of the SID, Vol 22, Issue 2 (2014), the contents of which are incorporated herein by reference.

The balance of the five metrics of SCE/SCI (see previous paragraph), transmission haze, gloss, distinctness of image (DOI), and sparkle is important for maximizing the benefits of an anti-glare for display readability, tactility on the glass surface, and the aesthetic appearance of high-performance touch displays in applications such as vehicle interiors. Sparkle is a micro-scattering interaction of the anti-glare surface with LCD pixels to create bright spots degrading image quality, especially at high resolution. The sparkle effect can be characterized using the method of the Pixel Power Deviation with reference (PPDr) to examine the sparkle effect on different resolution displays. For example, ultra-low sparkle anti-glare glass with less than 1% PPDr will have invisible sparkle effect on a display of less than 300 pixels-per-inch (PPI). However, up to 4% PPDr may be acceptable depending on the contents of display, based on the preference of the end-user. In vehicular or automotive interior settings, about 120 PPI to about 300 PPI is acceptable, and displays over 300 PPI have diminishing value.

In aspects, the substrate 103 and/or an anti-glare surface of the optical stack 203, 203a, and/or 203b can comprise a textured surface, for example, having particulates, a mechanically roughened surface, and/or a chemically roughened surface. In further aspects, the anti-glare and/or textured surface can be formed by treating the corresponding surface with an anti-glare treatment. Exemplary aspects of anti-glare treatments include chemical or physical surface treatment to form irregularities and/or etching the surface (e.g., with hydrofluoric acid) to create an etched region exhibiting anti-glare properties. In aspects, the optical stack 203, 203a, and/or 203b (e.g., including the anti-glare coating and/or anti-reflection coating) can be disposed on the first major surface 105 of the substrate when the first major surface 105 is textured (e.g., when the substrate is a textured substrate).

Throughout the disclosure, hardness of the optical stack is measured using the “Berkovich Indenter Hardness Test.” As used herein, the “Berkovich Indenter Hardness Test” measures the hardness of a material by indenting the surface (e.g., fourth major surface 207) with a diamond Berkovich indenter to form an indent to an indentation depth in the range from greater than or equal to 50 nm to less than or equal to 1000 nm (or the entire thickness of the optical stack 203, 203a, or 203b, whichever is less) and measuring the hardness from this indentation at various points along the entire indentation depth range, along a specified segment of this indentation depth (e.g., in the depth range from greater than or equal to 100 nm to less than or equal to 500 nm), or at a particular indentation depth (e.g., at a depth of 100 nm, at a depth of 500 nm, etc.) generally using the methods set forth in Oliver, W. C. and Pharr, G. M., “An improved technique for determining hardness and elastic modulus using load and displacement sensing indentation experiments”, J. Mater. Res., Vol. 7, No. 6, 1992, 1564-1583; and Oliver, W. C. and Pharr, G. M., “Measurement of Hardness and Elastic Modulus by Instrument Indentation: Advances in Understanding and Refinements to Methodology”, J. Mater. Res., Vol. 19, No. 1, 2004, 3-20. Further, when hardness is measured over an indentation depth range (e.g., in the depth range from greater than or equal to 100 nm to less than or equal to 500 nm), the results can be reported as a maximum hardness within the specified range, wherein the maximum is selected from the measurements taken at each depth within that range. As used herein, “hardness” and “maximum hardness” both refer to as-measured hardness values, not averages of hardness values. Similarly, when hardness is measured at an indentation depth, the value of the hardness obtained from the Berkovich Indenter Hardness Test is given for that particular indentation depth.

The optical stack 203, 203a or 203b, if present, can comprise a hardness of greater than about 8 GPa, by the Berkovich Indenter Hardness Test at an indentation depth of about 100 nm. The optical stack 203 may exhibit a hardness of greater than or equal to 8 GPa, greater than or equal to 9 GPa, greater than or equal to 10 GPa, greater than or equal to 11 GPa, greater than or equal to 12 GPa, greater than or equal to 13 GPa, greater than or equal to 14 GPa, or greater than or equal to 15 GPa by the Berkovich Indenter Hardness Test at an indentation depth of about 100 nm. For example, the optical stack 203 or 203a, including the planarization layer 123 and/or surface-modifying layer 113, as described herein, may exhibit a hardness of greater than or equal to 8 GPa, greater than or equal to 10 GPa, or greater than or equal to 12 GPa, by the Berkovich Indenter Hardness Test at an indentation depth of about 100 nm. In aspects, the optical stack 203 or 203b can exhibit a hardness ranging from greater than or equal to 8 GPa to less than or equal to 30 GPa, from greater than or equal to 10 GPa to less than or equal to 25 GPa, from greater than or equal to 12 GPa to less than or equal to 20 GPa, from greater than or equal to 16 GPa to less than or equal to 20 GPa, or any range or subrange therebetween. Such measured hardness values may be exhibited by the optical stack 203, 203a, or 203b and/or the coated article 101, 201, 211, or 221 over an indentation depth of greater than or equal to 50 nm or less than or equal to 100 nm or greater (e.g., from greater than or equal to 100 nm to less than or equal to 600 nm, from greater than or equal to 100 nm to less than or equal to 500 nm, from greater than or equal to 100 nm to less than or equal to 400 nm, from greater than or equal to 200 nm to less than or equal to 400 nm, from greater than or equal to 200 nm to less than or equal to 300 nm). Similarly, maximum hardness values of greater than or equal to 8 GPa, greater than or equal to 9 GPa, greater than or equal to 10 GPa, greater than or equal to 11 GPa, greater than or equal to 12 GPa, greater than or equal to 13 GPa, greater than or equal to 14 GPa, or greater than or equal to 15 GPa by the Berkovich Indenter Hardness Test may be exhibited by the optical stack 203 and/or the coated article 101, 201, 211, or 221 over an indentation depth of greater than or equal to 50 nm or less than or equal to 100 nm or greater (e.g., from greater than or equal to 100 nm to less than or equal to 600 nm, from greater than or equal to 100 nm to less than or equal to 500 nm, from greater than or equal to 100 nm to less than or equal to 400 nm, from greater than or equal to 200 nm to less than or equal to 400 nm, from greater than or equal to 200 nm to less than or equal to 300 nm).

As shown in FIGS. 1 and 2A-2C, the coated article 101, 201, 211, or 221 comprises the planarization layer 123 disposed over the first major surface 105 of the substrate 103. As shown, the planarization layer 123 comprises a first surface area 125 and a second surface area 127 opposite the first surface area 125. In aspects, as shown in FIGS. 1 and 2A-2C, the second surface area 127 of the planarization layer 123 can face the first major surface 105 of the substrate 103. In further aspects, as shown in FIG. 1, the second surface area 127 of the planarization layer 123 can contact the first major surface 105 of the substrate 103. Alternatively, as shown in FIGS. 2A-2C, one or more layers, for example, the optical stack 203, 203a, and/or 203b, can be positioned between the second surface area 127 of the planarization layer 123 and the first major surface 105 of the substrate 103. As used herein, the term “planarization layer” is not intended to be limited by a specific surface roughness Ra (or a specific reduction in surface roughness Ra relative to the surface that the planarization layer is disposed on). Instead, the planarization can comprise any of the aspects discussed herein, including the spatial height variation, ratio of maximum height to spatial height variation, domain size, and/or domain density in addition to or instead of surface roughness Ra properties.

As shown in FIGS. 1 and 2A-2C, a planarization thickness 129 is defined as an average distance between the first surface area 125 and the second surface area 127. In aspects, the planarization thickness 129 can be greater than or equal to 50 nm, greater than or equal to 70 nm, greater than or equal to 100 nm, greater than or equal to 150 nm, greater than or equal to 200 nm, less than or equal to 600 nm, less than or equal to 500 nm, less than or equal to 400 nm, less than or equal to 350 nm, or less than or equal to 300 nm. In aspects, the planarization thickness 129 can range from greater than or equal to 50 nm to less than or equal to 600 nm, from greater than or equal to 70 nm to less than or equal to 500 nm, from greater than or equal to 100 nm to less than or equal to 400 nm, from greater than or equal to 150 nm to less than or equal to 300 nm, from greater than or equal to 200 nm to less than or equal to 300 nm, or any range or subrange therebetween. The planarization thickness 129 is determined from a cross-sectional image from electron microscopy (e.g., scanning electron microscopy (SEM) or transmission electron microscope (TEM)).

Throughout the disclosure, an elastic modulus (e.g., Young's modulus) of the optical stack, the planarization layer, and/or the surface-modifying layer is determined using nanoindentation with a Berkovich diamond indenter tip. See: Fischer-Cripps, A. C., “Critical Review of Analysis and Interpretation of Nanoindentation Test Data,” Surface & Coatings Technology, 200, 4153-4165 (2006); and Hay, J., Agee, P, and Herbert, E., “Continuous Stiffness measurement During Instrumented Indentation Testing, Experimental Techniques,” 34 (3) 86-94 (2010). For coatings, instantaneous estimates of the elastic modulus are measured as a function of indentation depth. The elastic modulus is taken as the maximum value of the instantaneous estimate of the elastic modulus for measurements within the 50% of the planarization thickness 129 closest to the exterior surface 115 (i.e., first surface area 125) minus 5 nm of the planarization layer 123 from the exterior surface 115. Without wishing to be bound by theory, if a coating is of sufficient thickness, then it is then possible to isolate the properties of the coating from an adjacent coating based on the resulting response profiles as a function of depth. Extraction of reliable nanoindentation data is based on well-established protocols described in the above-mentioned references. Otherwise, these metrics can be subject to significant errors. In aspects, the planarization layer 123 can exhibit an elastic modulus of greater than or equal to 30 GPa, greater than or equal to 35 GPa, greater than or equal to 40 GPa, greater than or equal to 45 GPa, greater than or equal to 50 GPa, greater than or equal to 55 GPa, less than or equal to 70 GPa, less than or equal to 65 GPa, less than or equal to 60 GPa, less than or equal to 55 GPa, or less than or equal to 50 GPa. In aspects, the planarization layer 123 can exhibit an elastic modulus from greater than or equal to 30 GPa to less than or equal to 70 GPa, from greater than or equal to 35 GPa to less than or equal to 65 GPa, from greater than or equal to 40 GPa to less than or equal to 65 GPa, from greater than or equal to 45 GPa to less than or equal to 55 GPa, or any range or subrange therebetween.

Throughout the disclosure, hardness is measured for planarization layers with a thickness of at least 30 nm as the maximum hardness recorded in a range of from 20 nm the first surface area 125 of the planarization layer 123 to 60% of the planarization thickness 129 (from the first surface area 125 of the planarization layer 123) in a Berkovich Indenter Hardness Test. It has been found that measurements closer to the surface than 20 nm tend to underestimate the hardness while measurements closer than 40% of the planarization thickness to an underlying layer can be significantly influenced by the properties of the underlying layer. For planarization layers with a thickness of less than 30 nm, it is believed that no reliable hardness measurement can be obtained. In aspects, the planarization layer 123 can exhibit a hardness of greater than or equal to 3 GPa, greater than or equal to 3.5 GPa, greater than or equal to 4 GPa, greater than or equal to 5 GPa, greater than or equal to 6 GPa, less than or equal to 8 GPa, less than or equal to 7 GPa, or less than or equal to 6 GPa measured at an indentation depth of about 20 nm by a Berkovich Indenter Hardness Test. In aspects, the planarization layer 123 can exhibit a hardness (e.g., measured at an indentation depth of about 20 nm by a Berkovich Indenter Hardness Test) from greater than or equal to 3 GPa to less than or equal to 8 GPa, from greater than or equal to 3.5 GPa to less than or equal to 7 GPa, from greater than or equal to 4 GPa to less than or equal to 6 GPa, or any range or subrange therebetween. In aspects, the planarization layer 123 can exhibit a maximum hardness of greater than or equal to 3 GPa, greater than or equal to 3.5 GPa, greater than or equal to 4 GPa, greater than or equal to 5 GPa, greater than or equal to 6 GPa, less than or equal to 8 GPa, less than or equal to 7 GPa, or less than or equal to 6 GPa. In aspects, the planarization layer 123 can exhibit a hardness (e.g., measured over an indentation depth range from about 20 nm to about 500 nm or 60% of the planarization thickness, the hardness and the maximum hardness measured by a Berkovich Indenter Hardness Test) from greater than or equal to 3 GPa to less than or equal to 8 GPa, from greater than or equal to 3.5 GPa to less than or equal to 7 GPa, from greater than or equal to 4 GPa to less than or equal to 6 GPa, or any range or subrange therebetween.

Throughout the disclosure, a refractive index of coatings and films is measured by spectroscopic ellipsometry using a Woollam M-2000 and modelled using Wollam CompleteEase software. Unless otherwise specified, refractive index is measured at an optical wavelength of 589 nm. In aspects, a refractive index of the planarization layer 123 can be greater than or equal to 1.440, greater than or equal to 1.445, greater than or equal to 1.450, greater than or equal to 1.455, less than 1.50, less than or equal to 1.48, less than or equal to 1.47, less than or equal to 1.46, greater than or equal to 1.455, or less than or equal to 1.450. In aspects, a refractive index of the planarization layer 123 can range from greater than or equal to 1.440 to less than about 1.50, from greater than or equal to 1.445 to less than or equal to 1.48, from greater than or equal to 1.450 to less than or equal to 1.47, from greater than or equal to 1.455 to less than or equal to 1.46, or any range or subrange therebetween. In aspects, a refractive index of the planarization layer 123 can be less than or equal to 1.47, for example, in a range from greater than or equal to 1.440 to less than or equal to 1.47, from greater than or equal to 1.445 to less than or equal to 1.46, from greater than or equal to 1.445 to less than or equal to 1.455, from greater than or equal to 1.445 to less than or equal to 1.450, or any range or subrange therebetween. In aspects, a refractive index of the substrate 103 can be greater than or less than the refractive index of the planarization layer 123. It is noted that a reactively sputtered silica layer has a refractive index of less than 1.460 or about 1.458.

As used herein, an elemental composition of the planarization layer and/or the surface-modifying layer is determined using X-ray photoelectron spectroscopy (XPS). In aspects, the planarization layer and/or the surface-modifying layer can be fluorine-free. In aspects, the planarization layer 123 can comprise silicon atoms, oxygen atoms, carbon atoms, and hydrogen atoms. In further aspects, oxygen atoms in the planarization layer can be more common than any other atom in the planarization layer detected by XPS. In further aspects, the planarization layer can comprise less than or equal to 5 atom % carbon, less than or equal to 2 atom % carbon, less than or equal to 1 atom % carbon, less than or equal to 0.5 atom % carbon, less than or equal to 0.2 atom % carbon, less than or equal to 0.1 atom % carbon. In further aspects, the planarization layer can comprise less than 30 atom % nitrogen, less than 10 atom % nitrogen, less than or equal to 5 atom % nitrogen, less than or equal to 2 atom % nitrogen, less than or equal to 1 atom % nitrogen, less than or equal to 0.5 atom % nitrogen, less than or equal to 0.1 atom % nitrogen, greater than or equal to 0.5 atom % nitrogen, greater than or equal to 1 atom % nitrogen, greater than or equal to 2 atom % nitrogen, or greater than or equal to 5 atom % nitrogen. In further aspects, the planarization layer can consist essentially of or consist of silicon and oxygen. In further aspects, the planarization layer can comprise a silica-containing material, for example, silica, silica oxynitride, silicon aluminum oxide, and/or silicon aluminum oxynitride. An exemplary aspect for a material of the planarization layer is silica.

As used herein, “surface roughness” means the surface roughness Ra, which is an arithmetical mean of the absolute deviations of a surface profile from an average position in a direction normal to the surface of the test area. Surface roughness Ra is calculated using a surface profile measured for an 2 μm by 2 μm test area using atomic force microscopy (AFM). In aspects, the planarization layer 123 (e.g., outer surface or first surface area 125) can comprise a surface roughness Ra (e.g., as-formed) of less than or equal to 1.6 nm, less than or equal to 1.5 nm, less than or equal to 1.4 nm, less than or equal to 1.3 nm, less than or equal to 1.2 nm, less than or equal to 1.1 nm, less than or equal to 1.0 nm, less than or equal to 0.9 nm, greater than or equal to 0.5 nm, greater than or equal to 0.7 nm, greater than or equal to 0.8 nm, greater than or equal to 0.9, greater than or equal to 1.0 nm, greater than or equal to 1.1, or greater than or equal to 1.2 nm. In aspects, the planarization layer 123 (e.g., outer surface or first surface area 125) can comprise a surface roughness Ra (e.g., as-formed) ranging from greater than or equal to 0.5 nm to less than or equal to 1.6 nm, from greater than or equal to 0.7 nm to less than or equal to 1.6 nm, from greater than or equal to 0.8 nm to less than or equal to 1.5 nm, from greater than or equal to 0.9 nm to less than or equal to 1.5 nm, from greater than or equal to 1.0 to less than or equal to 1.4 nm, from greater than or equal to 1.0 nm to less than or equal to 1.3 nm, from greater than or equal to 1.1 nm to less than or equal to 1.2 nm, or any range or subrange therebetween. Providing a low surface roughness (e.g., less than or equal to 1.6 nm, from greater than or equal to 0.8 nm to less than or equal to 1.5 nm, or from greater than or equal to 1.0 nm to less than or equal to 1.4 nm) can increase an abrasion resistance of a surface-modifying layer disposed thereon.

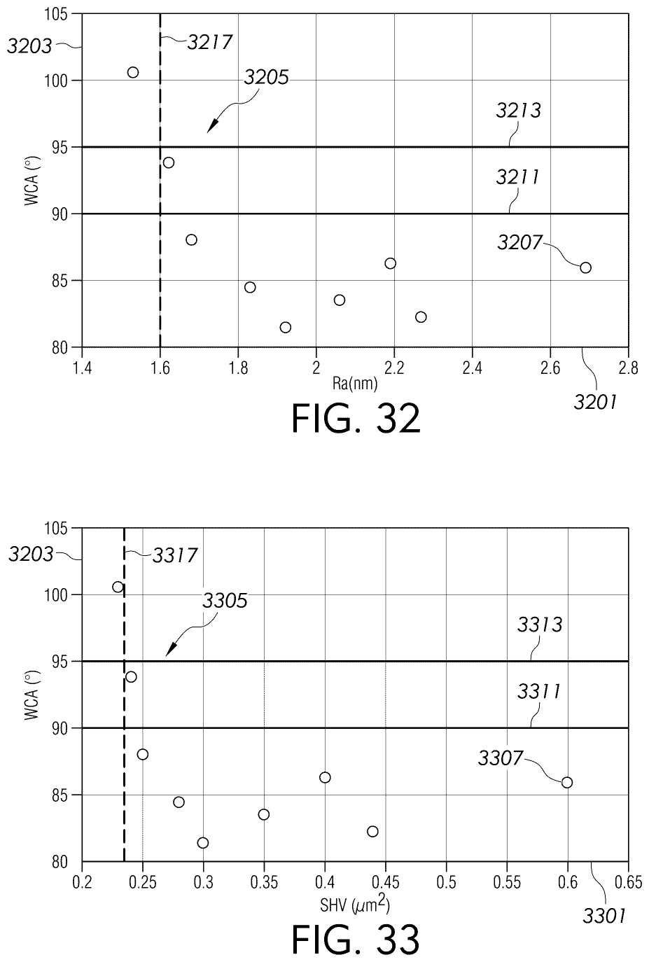

Alternatively or additionally, the first surface area 125 of the planarization layer 123 can provide a lower surface roughness than a surface that the second surface area 127 of the planarization layer 123 is in contact with (e.g., the first major surface 105 of the substrate 103 in FIG. 1, fourth major surface 207 of the optical stack 203 in FIG. 2A, and/or fourth major surface 207 of the optical stack 203a, or 203b in FIGS. 2B-2C). For example, the planarization layer can provide a decreased surface roughness Ra than would be obtained in an article (e.g., coated article) without the planarization layer, which enables the coated article of the present disclosure including the planarization layer to have increased abrasion resistance of the surface-modifying layer. For example, as shown in FIGS. 21 and 32, points 2105 and 3205 in accordance with aspects of the present disclosure are associated with lower surface roughness Ra as indicated by the horizontal axis 2101 or 3201 (i.e., x-axis) relative to a reactively sputtered silica coating corresponding to points 2107 and 3207 for an underlying surface roughness Ra of the untreated initial layer (corresponding to inner layer before being impinged by the ion beam). It is to be understood that the methods of present disclosure can (in aspects) provide an outer surface with a lower surface roughness than an underlying surface based on the reduced surface roughness of the formed planarization layer (points 2105 and 3205) relative to an untreated surface (points 2107 and 3207). In aspects, a ratio of the surface roughness Ra of the first surface area 125 of the planarization layer 123 to a surface roughness Ra of a surface in contact with the second surface area 127 of the planarization layer 123 can be less than or equal to 0.90, less than or equal to 0.85, less than or equal to 0.85, less than or equal to 0.80, less than or equal to 0.75, less than or equal to 0.70, less than or equal to 0.65, less than or equal to 0.60, less than or equal to 0.55, less than or equal to 0.50, greater than or equal to 0.1, greater than or equal to 0.2, greater than or equal to 0.3, greater than or equal to 0.4, greater than or equal to 0.5. In aspects, a ratio of the surface roughness Ra of the first surface area 125 of the planarization layer 123 to a surface roughness Ra of a surface in contact with the second surface area 127 of the planarization layer 123 can be in a range from greater than or equal to 0.1 to less than or equal to 0.90, from greater than or equal to 0.1 to less than or equal to 0.85, from greater than or equal to 0.2 to less than or equal to 0.80, from greater than or equal to 0.2 to less than or equal to 0.75, from greater than or equal to 0.3 to less than or equal to 0.70, from greater than or equal to 0.3 to less than or equal to 0.65, from greater than or equal to 0.4 to less than or equal to 0.60, from greater than or equal to 0.5 to less than or equal to 0.55, or any range or subrange therebetween.

Without wishing to be bound by theory, it is believed that higher spatial frequencies of a surface (e.g., gradients of the surface as measured by surface height variation) impact the abrasion resistance of a surface-modifying layer disposed thereon. For example, it is believed that decreasing the amplitude of these higher spatial frequencies can enable increased abrasion resistance. Overall surface roughness values such as surface roughness Ra may not fully capture the role of the decreased amplitude at higher spatial frequencies in the planarization layer. In contrast, aspects of the surface height variation and ratios thereof as well as domain sizes and/or domain heights discussed herein may more directly describe these aspects of the planarization layer.

As used herein, “spatial height variation” (SHV) corresponds to a density of peaks. SHV is calculated from the surface measurements in the AFM images of 2 μm by 2 μm area also used to calculate surface roughness Ra. The spatial height variation (SHV) is calculated as the integral sum of absolute values of the local gradient measurements calculated at the intersections for 4 adjacent AFM measurements as the average of first finite differences. Unless otherwise indicated, the spatial height variation reported herein is the average of at least six measurements based on different 2 μm by 2 μm areas. In aspects, the spatial height variation of the first surface area 125 of the planarization layer 123 can be less than or equal to 0.24 μm², less than or equal to 0.23 μm², less than or equal to 0.22 μm², less than or equal to 0.21 μm², greater than or equal to 0.18 μm², greater than or equal to 0.20 μm², greater than or equal to 0.21 μm², or greater than or equal to 0.22 μm². In aspects, the spatial height variation of the first surface area 125 of the planarization layer 123 can be in a range from greater than or equal to 0.18 μm² to less than or equal to 0.24 μm², from greater than or equal to 0.20 μm² to less than or equal to 0.23 μm², from greater than or equal to 0.21 μm² to less than or equal to 0.22 μm², or any range or subrange therebetween.

As used herein, peaks are identified using the Otsu thresholding algorithm that separates “peaks” from “valleys” in the AFM images of 2 μm by 2 μm area. A peak height is extracted from the data for each contiguous region of “peaks” as the maximum height in that region. The mean peak height is calculated from the peak heights for each of the distinct contiguous region of “peaks.” In aspects, a mean peak height (for the first surface area 125 of the planarization layer 123) can be less than or equal to 8 nm, less than or equal to 7 nm, less than or equal to 6 nm, less than or equal to 5 nm, less than or equal to 4 nm, less than or equal to 3 nm, less than or equal to 2 nm, greater than or equal to 1 nm, greater than or equal to 2 nm, greater than or equal to 3 nm, greater than or equal to 4 nm, or greater than or equal to 5 nm. In aspects, a mean peak height (for the first surface area 125 of the planarization layer 123) can be in a range from greater than or equal to 1 nm to less than or equal to 8 nm, from greater than or equal to 1 nm to less than or equal to 7 nm, from greater than or equal to 2 nm to less than or equal to 6 nm, from greater than or equal to 2 nm to less than or equal to 5 nm, from greater than or equal to 3 nm to less than or equal to 4 nm, or any range or subrange therebetween.

In aspects, a ratio of the mean peak height divided by the surface height variation (for the first surface area 125 of the planarization layer 123) can be less than or equal to 2.0 nm/μm², less than or equal to 1.8 nm/μm², less than or equal to 1.6 nm/μm², less than or equal to 1.5 nm/μm², less than or equal to 1.4 nm/μm², less than or equal to 1.3 nm/μm², less than or equal to 1.2 nm/μm², less than or equal to 1.1 nm/μm², greater than or equal to 0.8 nm/μm², greater than or equal to 0.9 nm/μm², greater than or equal to 1.0 nm/μm², greater than or equal to 1.1 nm/μm², or greater than or equal to 1.2 nm/μm². In aspects, a ratio of the mean peak height divided by the surface height variation (for the first surface area 125 of the planarization layer 123) can be in a range from greater than or equal to 0.8 nm/μm² to less than or equal to 2.0 nm/μm², from greater than or equal to 0.8 nm/μm² to less than or equal to 1.8 nm/μm², from greater than or equal to 0.9 nm/μm² or to less than or equal to 1.6 nm/μm², from greater than or equal to 0.9 nm/μm² to less than or equal to 1.5 nm/μm², from greater than or equal to 1.0 nm/μm² to less than or equal to 1.5 nm/μm², from greater than or equal to 1.1 nm/μm² to less than or equal to 1.4 nm/μm², from greater than or equal to 1.2 nm/μm² to less than or equal to 1.3 nm/μm², or any range or subrange therebetween.

As used herein, “domains” are calculated using the Otsu thresholding algorithm that separates “peaks” from “valleys” in the AFM images of 2 μm by 2 μm area. A “domain size” is defined as an area of a contiguous region of “peaks.” In aspects, an average “domain size” of “peaks” (for the first surface area 125 of the planarization layer 123) can be less than or equal to 0.10 μm², less than or equal to 0.08 μm², less than or equal to 0.06 μm², less than or equal to 0.05 μm², less than or equal to 0.04 μm², less than or equal to 0.03 μm², less than or equal to 0.02 μm², greater than or equal to 0.01 μm², greater than or equal to 0.02 μm², greater than or equal to 0.03 μm², or greater than or equal to 0.04 μm². In aspects, an average “domain size” of “peaks” (for the first surface area 125 of the planarization layer 123) can be in a range from greater than or equal to 0.01 μm² to less than or equal to 0.10 μm², from greater than or equal to 0.02 μm² to less than or equal to 0.08 μm², from greater than or equal to 0.02 μm² to less than or equal to 0.06 μm², from greater than or equal to 0.03 μm² to less than or equal to 0.05 μm², from greater than or equal to 0.03 μm² to less than or equal to 0.04 μm², or any range or subrange therebetween. A “density of domains” refers to an average number of “domains” of “peaks” per area. In aspects, a mean density of domains (for the first surface area 125 of the planarization layer 123) can be greater than or equal to 10 per μm², greater than or equal to 15 per μm², greater than or equal to 20 per μm², greater than or equal to 25 per μm², greater than or equal to 30 per μm², less than or equal to 70 per μm², less than or equal to 60 per μm², less than or equal to 50 per μm², less than or equal to 40 per μm², or less than or equal to 30 per μm². In aspects, a mean density of domains (for the first surface area 125 of the planarization layer 123) can be in a range from greater than or equal to 10 per μm² to less than or equal to 70 per μm², from greater than or equal to 15 per μm² to less than or equal to 60 per μm², from greater than or equal to 20 per μm² to less than or equal to 50 per μm², from greater than or equal to 25 per μm² to less than or equal to 40 per μm², from greater than or equal to 30 per μm² to less than or equal to 40 per μm², or any range or subrange therebetween.

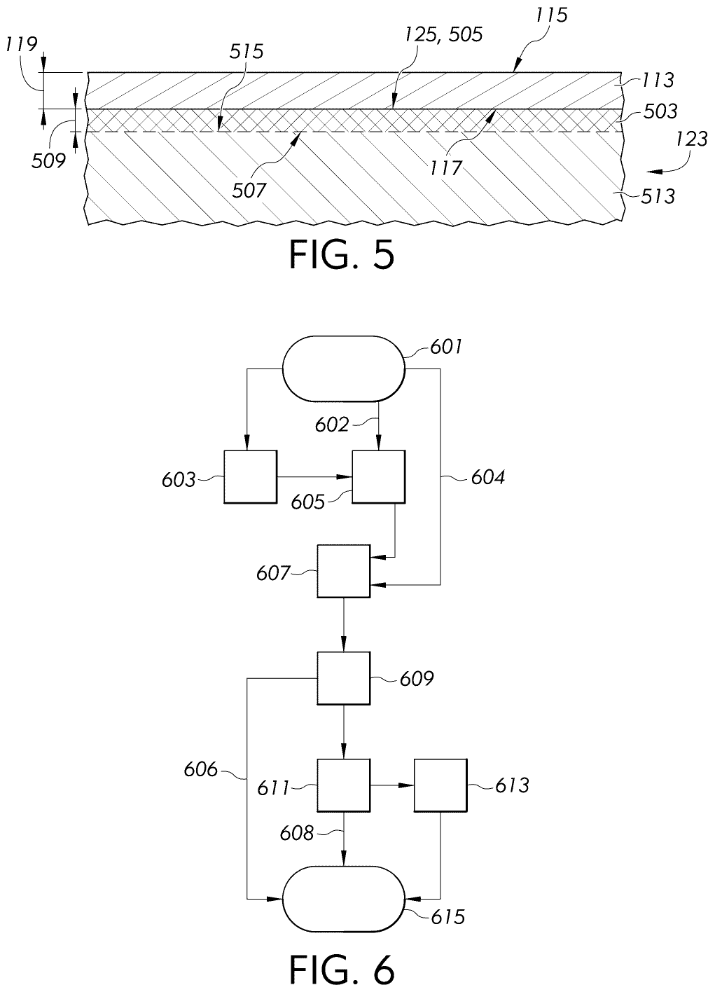

As shown in FIG. 5, the planarization layer 123 can comprise an inner sublayer 513 and an outer sublayer 503 disposed on the inner sublayer 513. The outer sublayer 503 has an outer surface 505 corresponding to the first surface area 125 of the planarization layer 123 that faces and/or contacts the surface-modifying layer 113 (e.g., inner surface 117). The outer sublayer 503 has a first interior surface 507 opposite the outer surface 505. The first interior surface 507 faces and integrally contacts a second interior surface 515 of the inner sublayer 513. An outer thickness 509 of the outer sublayer 503 is defined as an average distance between the outer surface 505 and the first interior surface 507. In aspects, the outer thickness 509 of the outer sublayer 503 can be greater than or equal to 10 nm, greater than or equal to 15 nm, greater than or equal to 20 nm, greater than or equal to 25 nm, less than or equal to 100 nm, less than or equal to 80 nm, less than or equal to 50 nm, less than or equal to 40 nm, less than or equal to 30 nm, or less than or equal to 25 nm. In aspects, the outer thickness 509 of the outer sublayer 503 can be in a range from greater than or equal to 10 nm to less than or equal to 100 nm, from greater than or equal to 10 nm to less than or equal to 80 nm, from greater than or equal to 15 nm to less than or equal to 50 nm, from greater than or equal to 15 nm to less than or equal to 40 nm, from greater than or equal to 15 nm to less than or equal to 30 nm, from greater than or equal to 20 nm to less than or equal to 25 nm, or any range or subrange therebetween. Also, a microstructure of the inner sublayer 513 can be different than a corresponding microstructure of the outer sublayer 503. For example, a grain size, roughness, or other characteristic of the outer sublayer 503 can be smaller than a corresponding characteristic of the inner sublayer 513. In aspects, the inner sublayer 513 and the outer sublayer 503 can comprise the same material (e.g., silica-containing oxide or silica). In aspects, a surface roughness Ra of the second interior surface 515 of the inner sublayer 513 can be less than or equal to 2.0 nm, less than or equal to 1.9 nm, less than or equal to 1.8 nm, less than or equal to 1.7 nm, less than or equal to 1.6 nm, less than or equal to 1.5 nm, greater than or equal to 0.8 nm, greater than or equal to 1.0 nm, greater than or equal to 1.2 nm, greater than or equal to 1.3 nm, greater than or equal to 1.4 nm, or greater than or equal to 1.5 nm. In aspects, a surface roughness Ra of the second interior surface 515 of the inner sublayer 513 can be in a range from greater than or equal to 0.8 nm to less than or equal to 2.0 nm, from greater than or equal to 1.0 nm to less than or equal to 1.9 nm, from greater than or equal to 1.2 nm to less than or equal to 1.8 nm, from greater than or equal to 1.3 nm to less than or equal to 1.8 nm, from greater than or equal to 1.3 nm to less than or equal to 1.7 nm, from greater than or equal to 1.4 nm to less than or equal to 1.6, from greater than or equal to 1.4 nm to less than or equal to 1.5 nm, or any range or subrange therebetween.

Throughout the disclosure, “surface-modifying layer” refers to a layer that is characterized by changing a physical property or other behavior of the coated article. For example, a surface-modifying layer can modify one or more of a water contact angle, an oleic contact angle, a visibility of a fingerprint (e.g., simulated fingerprint), and/or an ability to remove a fingerprint (e.g., by wiping).

In aspects, the surface-modifying layer can be an anti-fingerprint coating. Throughout the disclosure, a surface-modifying layer is an “anti-fingerprint” coating if the coating on a substrate can reduce the visibility of, reduce a color shift of, and/or reduce droplet formation of fingerprint oil disposed thereon relative to the substrate without the coating. As used herein, the visibility of a fingerprint refers to an absolute value of a difference in brightness (e.g., CIELAB L* value) for a portion of the anti-fingerprint coating with the fingerprint oil and another portion of the anti-fingerprint coating without the fingerprint oil. As used herein, the color shift of the substrate refers to a difference in measured color as √((a₁*−a₂*)²+(b₁*−b₂*)²), where a* refers to CIELAB a* values, b* refers to CIELAB b* values, subscript 1 refers to a portion of the anti-fingerprint coating without fingerprint oil, and subscript 2 refers to a portion of the anti-fingerprint coating with fingerprint oil. An anti-fingerprint coating can reduce droplet formation, which can increase a visibility and/or color shift of fingerprint oil, by being oleophilic, as defined below. Additionally, the anti-fingerprint coating can enable the removal of aqueous material (e.g., water droplets, sweat droplets) from the coating, for example, by being hydrophobic, as defined below. In further aspects, the anti-fingerprint coating can exhibit an (e.g., as-formed) water contact angle from greater than or equal to 90° to less than or equal to 120°, an (e.g., as-formed) oleic acid contact angle of greater than or equal to 40°, and a coefficient of friction of less than or equal to 0.25. In further aspects, the easy-to-clean coating can be substantially free and/or free of fluorine. In aspects, a diiodomethane contact angle of an anti-fingerprint coating (e.g., as-formed) can be greater than or equal to 60°, greater than or equal to 62°, greater than or equal to 65°, less than or equal to 80°, less than or equal to 75°, less than or equal to 73°, or less than or equal to 70°. In aspects, a diiodomethane contact angle of an anti-fingerprint coating (e.g., as-formed) can range from greater than or equal to 600 to less than or equal to 80°, from greater than or equal to 620 to less than or equal to 75°, from greater than or equal to 650 to less than or equal to 72°, or any range or subrange therebetween. In aspects, an anti-fingerprint coating can be oleophilic. In aspects, a hexadecane contact angle and/or an oleic acid contact angle of an anti-fingerprint coating (e.g., as-formed) can be less than or equal to 45°, less than or equal to 40°, less than or equal to 30°, less than or equal to 25°, less than or equal to 20°, or the anti-fingerprint coating can wet hexadecane and/or oleic acid. In further aspects, the anti-fingerprint coating (e.g., as formed) wets hexadecane and/or oleic acid. Providing a low diiodomethane contact angle (e.g., less than or equal to 60°) and/or a low hexadecane contact angle (e.g., less than or equal to 30°) can reduce the visibility and/or color shift associated with fingerprints by enabling fingerprint oil to be dispersed across the anti-fingerprint coating rather than beading up into pronounced droplets.

In aspects, the surface-modifying layer can be a fingerprint-hiding coating. Throughout the disclosure, a “fingerprint-hiding coating” can reduce the visibility of and/or reduce a color shift of fingerprint oil disposed thereon relative to a glass-based substrate without the coating. As used herein, the visibility of a fingerprint refers to an absolute value of a difference in brightness (e.g., CIELAB L* value) for a portion of the fingerprint-hiding coating with the fingerprint oil and another portion of the fingerprint-hiding coating without the fingerprint oil. As used herein, the color shift of the glass-based substrate refers to a difference in measured color as √((a₁*−a₂*)²+(b₁*−b₂*)²), where a* refers to CIELAB a* values, b* refers to CIELAB b* values, subscript 1 refers to a portion of the fingerprint-hiding coating without fingerprint oil, and subscript 2 refers to a portion of the fingerprint-hiding coating with fingerprint oil. Specifically, the fingerprint-hiding coating can cause fingerprint oil to spread out over the surface of the fingerprint-hiding coating. Reducing the thickness of fingerprint oil droplets and/or increasing an area of fingerprint-hiding coating covered by the fingerprint oil can decrease a color shift and/or visibility associated with the fingerprint oil. Fingerprint-hiding coatings that can be oleophilic are to be contrasted with other coatings (e.g., anti-fingerprint coatings) that can reduce droplet formation by being oleophobic. Additionally, the fingerprint-hiding coating can enable the removal of aqueous material (e.g., water droplets, sweat droplets) from the coating, for example, by being hydrophobic, as discussed herein. In further aspects, the fingerprint-hiding coating can exhibit an (e.g., as-formed) water contact angle from greater than or equal to 90° to less than or equal to 120°, an (e.g., as-formed) oleic acid contact angle of less than or equal to 40°, and a coefficient of friction of less than or equal to 0.25. In further aspects, the fingerprint-hiding coating can be a fluorine-containing material. Alternatively, in further aspects, the fingerprint-hiding coating can be substantially free and/or free of fluorine. In further aspects, the finger-hiding coating can exhibit a hexadecane contact angle of less than or equal to 20° (or wet hexadecane) and/or a diiodomethane contact angle of greater than or equal to 60°.

In aspects, the surface-modifying layer can be an easy-to-clean coating. Throughout the disclosure, a surface-modifying layer is an “easy-to-clean” coating if the coating on a glass-based substrate can repel material and/or facilitate removal of material disposed thereon relative to the glass-based substrate without the coating. As used herein, an ability to repel material is determined based on a contact angle with higher contact angles associated with greater repulsion. As used herein, an ability to remove material is measured by wiping the material disposed on the surface (e.g., coating or glass-based substrate) with a cheesecloth (see details from the Cheesecloth Abrasion Test with the modification that the material is disposed on the surface before wiping) and the visibility of the material is monitored. A decreased visibility (e.g., fewer wiping cycles to achieve a predetermined reduction is visibility) is associated with a coating facilitating removal of material disposed thereon. In further aspects, the easy-to-clean coating can exhibit an (e.g., as-formed) water contact angle from greater than or equal to 90° to less than or equal to 120°, an (e.g., as-formed) oleic acid contact angle of greater than or equal to 50°, and a coefficient of friction of less than or equal to 0.25. In further aspects, the easy-to-clean coating can be a fluorine-containing material. Alternatively, in further aspects, the easy-to-clean coating can be substantially free and/or free of fluorine. In aspects, a diiodomethane contact angle of an anti-fingerprint coating (e.g., as-formed) can be greater than or equal to 60°, greater than or equal to 62°, greater than or equal to 65°, less than or equal to 80°, less than or equal to 75°, less than or equal to 73°, or less than or equal to 70°. In aspects, a diiodomethane contact angle of an anti-fingerprint coating (e.g., as-formed) can range from greater than or equal to 600 to less than or equal to 80°, from greater than or equal to 620 to less than or equal to 75°, from greater than or equal to 650 to less than or equal to 72°, or any range or subrange therebetween. In aspects, the anti-fingerprint coating can be oleophilic. In aspects, a hexadecane contact angle of the anti-fingerprint coating (e.g., as-formed) can be less than or equal to 45°, less than or equal to 40°, less than or equal to 30°, less than or equal to 25°, less than or equal to 20°, or the anti-fingerprint coating can wet hexadecane. In further aspects, the anti-fingerprint coating (e.g., as formed) wets hexadecane. Providing a low diiodomethane contact angle (e.g., less than or equal to 60°) and/or a low hexadecane contact angle (e.g., less than or equal to 30°) can reduce the visibility and/or color shift associated with fingerprints by enabling fingerprint oil to be dispersed across the surface-modifying layer rather than beading up into pronounced droplets.

In aspects, the surface-modifying layer 113 can be an easy-to-clean coating. In aspects, the surface-modifying layer 113 can be substantially free of and/or free of fluorine. Alternatively, in aspects, the surface-modifying layer 113 can comprise a perfluoropolyether. In aspects, the surface-modifying layer 113 can have an oleic acid contact angle of less than or equal to 30°. Alternatively, the surface-modifying layer 113 can have an oleic acid contact angle of greater than or equal to 40°.

As shown in FIGS. and 2A-2C, the coated article 101, 201, 211, or 221 can comprise the surface-modifying layer 113 disposed over the first major surface 105 of the substrate 103. The surface-modifying layer 113 comprises an inner surface 117 facing the first major surface 105 of the substrate 103. In aspects, as shown in FIGS. 1 (by dashed lines) and FIGS. 2A-2C, the surface-modifying layer 113 can be disposed on the planarization layer 123. In further aspects, as shown, the inner surface 117 of the surface-modifying layer 113 can face, contact, and/or otherwise be bonded to the first surface area 125 of the planarization layer 123. In further aspects, as shown in FIGS. 2A-2C, the planarization layer 123 can be positioned between the surface-modifying layer 113 and the optical stack 203, 203a, or 203b (e.g., an optical film 231, a scratch-resistant layer 233, anti-glare coating, anti-reflection coating). In aspects, as shown in FIGS. 1 and 2A-2C, the surface-modifying layer 113 comprises an exterior surface 115 that forms an exterior surface of the coated article 101, 201, 211, or 221. Consequently, a user would interact with the coated article 101, 201, 211, or 221 by, for example, touching the exterior surface 115 or viewing an image through the exterior surface 115. Alternatively, although not shown, the coated article may not have a surface-modifying layer 113 disposed on the planarization layer 123.

As shown in FIGS. 1 and 2A-2C, a surface-modifying thickness 119 of the surface-modifying layer 113 is defined as an average distance between the inner surface 117 and the exterior surface 115. In aspects, the surface-modifying thickness 119 can be greater than or equal to 1 nm, greater than or equal to 2 nm, greater than or equal to 3 nm, greater than or equal to 5 nm, greater than or equal to 10 nm, greater than or equal to 20 nm, greater than or equal to 50 nm, less than or equal to 500 nm, less than or equal to 200 nm, less than or equal to 100 nm, less than or equal to 75 nm, less than or equal to 50 nm, less than or equal to 25 nm, less than or equal to 15 nm, less than or equal to 10 nm, less than or equal to 8 nm, less than or equal to 7 nm, less than or equal to 6 nm, less than or equal to 5 nm, or less than or equal to 4 nm. In aspects, the surface-modifying thickness 119 can be in a range from greater than or equal to 1 nm to less than or equal to 500 nm, from greater than or equal to 1 nm to less than or equal to 200 nm, from greater than or equal to 1 nm to less than or equal to 100 nm, from greater than or equal to 1 nm to less than or equal to 75 nm, from greater than or equal to 1 nm to less than or equal to 50 nm, from greater than or equal to 1 nm to less than or equal to 25 nm, from greater than or equal to 1 nm to less than or equal to 15 nm, from greater than or equal to 2 nm to less than or equal to 10 nm, from greater than or equal to 2 nm to less than or equal to 8 nm, from greater than or equal to 2 nm to less than or equal to 5 nm, from greater than or equal to 3 nm to less than or equal to 5 nm, or any range or subrange therebetween. The surface-modifying thickness 119 is determined from a cross-sectional image taken using a scanning electron microscope (SEM).

In aspects, the surface-modifying layer 113, the planarization layer 123, and/or the coated article 101, 201, 211, or 221 can comprise an average transmittance (as described above) of greater than or equal to 80%, greater than or equal to 85%, greater than or equal to 88%, greater than or equal to 89%, greater than or equal to 90%, greater than or equal to 91%, greater than or equal to 92%, or greater than or equal to 93%. In aspects, the average transmittance of the surface-modifying layer 113, the planarization layer 123, and/or the coated article 101, 201, 211, or 221 can range from greater than or equal to 80% to less than or equal to 100%, from greater than or equal to 85% to less than or equal to 99%, from greater than or equal to 88% to less than or equal to 97%, from greater than or equal to 89% to less than or equal to 97%, from greater than or equal to 90% to less than or equal to 96%, from greater than or equal to 91% to less than or equal to 95%, from greater than or equal to 92% to less than or equal to 94%, or any range or subrange therebetween. In aspects, the transmittance of the surface-modifying layer 113, the planarization layer 123, and/or the coated article 101, 201, 211, or 221 at 550 nm can be within one or more of the ranges mentioned above in this paragraph for the average transmittance.

As used herein, haze refers to transmission haze that is measured through the surface-modifying layer 113, the planarization layer 123, and/or through the coated article 101, 201, 211, or 221 (through the exterior surface 115) in accordance with ASTM D1003-21 at 0° relative to a direction normal to the exterior surface 115. Haze is measured using a HAZE-GARD PLUS available from BYK Gardner with an aperture over the source port. The aperture has a diameter of 8 mm. A CIE C illuminant is used as the light source for illuminating the surface-modifying layer 113, the planarization layer 123, and/or through the coated article 101, 201, 211, or 221. In aspects, the surface-modifying layer 113, the planarization layer 123, and/or through the coated article 101, 201, 211, or 221 comprises a haze of less than or equal to 5%, less than or equal to 2%, less than or equal to 1.5%, less than or equal to 1%, less than or equal to 0.5%, or less than or equal to 0.1%, for example from greater than or equal to 0.01% to less than or equal to 5%, from greater than or equal to 0.01% to less than or equal to 2%, from greater than or equal to 0.05% to less than or equal to 1.5%, from greater than or equal to 0.05% to less than or equal to 1%, from greater than or equal to 0.1% to less than or equal to 0.5%, or any range or subrange therebetween.

Throughout the disclosure, a coefficient of friction refers to a dynamic coefficient of friction measured in accordance with ASTM D1894-14. Unless otherwise indicated, “coefficient of friction” refers to the “dynamic coefficient of friction.” In aspects, the exterior surface 115 of the surface-modifying layer 113 can comprise a dynamic coefficient of friction of less than or equal to 0.25, less than or equal to 0.22, less than or equal to 0.20, less than or equal to 0.18, or less than or equal to 0.15. In aspects, the exterior surface 115 of the surface-modifying layer 113 can comprise a dynamic coefficient of friction in a range from greater than or equal to 0.05 to less than or equal to 0.25, from greater than or equal to 0.10 to less than or equal to 0.22, from greater than or equal to 0.12 to less than or equal to 0.20, from greater than or equal to 0.15 to less than or equal to 0.18, or any range or subrange therebetween.

Throughout the disclosure, contact angles are determined for a drop of a corresponding liquid disposed on the exterior surface (not treated with plasma nor corona) using a 30 gauge needle with the contact angle measured using a goniometer in accordance with ASTM D5946. If a contact angle cannot be reliably determined due to a high degree of droplet spread corresponding to a contact angle of less than or equal to 15°, then the coating is said to “wet” the droplet material. As used herein, water contact angles are measured using a drop of deionized water. As used herein, a coating is “hydrophobic” if it has a water contact angle of greater than or equal to 100°. As used herein, a coating is “superhydrophobic” if it has a water contact angle of less than or equal to 130°. As used herein, an “as-formed” coating refers to a coating that has not been subjected to an abrasive (e.g., see Steel Wool Abrasion Test and Cheesecloth Abrasion Test below). As used herein, a coating is “oleophilic” if it has a hexadecane contact angle of less than 60°.

In aspects, the surface-modifying layer 113 (e.g., as-formed) is hydrophobic but not superhydrophobic. In aspects, the water contact angle of the surface-modifying layer 113 (e.g., as-formed) can be greater than or equal to 90°, greater than or equal to 95°, greater than or equal to 100°, greater than or equal to 103°, greater than or equal to 105°, greater than or equal to 108°, greater than or equal to 110°, greater than or equal to 113°, greater than or equal to 115°, less than or equal to 120°, less than or equal to 118°, less than or equal to 115°, less than or equal to 113°, or less than or equal to 110°. In aspects, the water contact angle of the surface-modifying layer 113 (e.g., as-formed) can range from greater than or equal to 900 to less than or equal to 120°, from greater than or equal to 950 to less than or equal to 120°, from greater than or equal to 1000 to less than or equal to 118°, from greater than or equal to 1030 to less than or equal to 118°, from greater than or equal to 1050 to less than or equal to 118°, from greater than or equal to 1080 to less than or equal to 115°, from greater than or equal to 1100 to less than or equal to 113°, or any range or subrange therebetween. Providing a high water contact angle (e.g., greater than or equal to 950 or greater than or equal to 100°) can enhance the removal of aqueous material (e.g., water droplets, sweat droplets) from the surface-modifying layer.

Throughout the disclosure, the “Steel Wool Abrasion Test” is used to determine the durability of a coating. For the Steel Wool Abrasion Test, steel wool (Bonstar #0000) was cut into strips (25 mm×12 mm) and placed on a sheet of aluminum foil to bake in an oven for 2 hours at 100° C. A steel wool strip was fitted to an attachment (10 mm×10 mm) of an abrader (5750, Taber Industries) using a zip tie. Weights totaling 720 grams were added to the Taber arm to result in a total applied load of 1 kilogram. The stroke length was set at 25 mm, the speed was set to 40 cycles per minute, and testing occurred at 23° C. The area to be abraded was marked onto the back of the sample for tracking. A sample of the coating was secured in the abrader and subjected to 2,000 cycles, 3,000 cycles, or 3,500 cycles. After the coating is abraded for the predetermined number of cycles, an abraded water contact angle is measured in accordance with the method for the contact angle described above. Unless otherwise indicated, the abraded water contact angle is calculated as the average of 12 water contact angle measurements taken at evenly spaced locations along the abraded area. A high contact angle (e.g., greater than or equal to 850 or greater than or equal to 90°) is indicative of the surface-modifying layer surviving the Steel Wool Abrasion Test. Decreases in the contact angle below 70° correlate with a loss of the surface-modifying layer. In aspects, the abraded water contact angle (e.g., of the surface-modifying layer disposed on the planarization layer in a coated article in accordance with aspects of the present disclosure) after 2,000 cycles, 3,000 cycles, and/or 3,5000 cycles in the Steel Wool Abrasion Test can be greater than or equal to 85°, greater than or equal to 88°, greater than or equal to 90°, greater than or equal to 93°, greater than or equal to 95°, greater than or equal to 98°, or greater than or equal to 100°. As demonstrated by the results of the Steel Wool Abrasion Test, the surface-modifying layer disposed on the planarization layer in a coated article in accordance with aspects of the present disclosure can withstand abrasion and maintain good contact angles (e.g., having a steel-wool abraded water contact angle of greater than or equal to 90° or greater than or equal to 95°).

Throughout the disclosure, the “Cheesecloth Abrasion Test” is also used to determine the durability of a coating. In the Cheesecloth Abrasion Test, 4 layers of cheesecloth wrap (Crockmeter Squares for American Standards, 200877; SDL Atlas USA, Rock Hill, SC) are affixed to a cylindrical tip with a radius of 2 cm of a Linear Taber Abrader (Model 5750; Taber Industries, North Tonawanda, NY) with a constant load of 750 grams. The path-length of each swipe is 15 mm, with each cycle comprising a forward and backward swipe to return the tip to its original position before proceeding with the next cycle. The speed was 30 cycles per minute, testing occurred at 23° C. After the coating is abraded for 200,000 cycles, a cheesecloth-abraded water contact angle is measured in accordance with the method for the contact angle described above. In aspects, a cheesecloth-abraded water contact angle of the surface-modifying layer 113 (e.g., disposed on the planarization layer in a coated article in accordance with aspects of the present disclosure) can be greater than or equal to 80°, greater than or equal to 85°, greater than or equal to 88°, greater than or equal to 90°, greater than or equal to 95°, or greater than or equal to 100°. In aspects a difference between the water contact angle of the surface-modifying layer (as-formed) and the cheesecloth-abraded water contact angle (after 200,000 cycles) can be less than or equal to 20°, less than or equal to 15°, less than or equal to 12°, less than or equal to 10°, or less than or equal to 8° (e.g., when the surface-modifying layer is disposed on the planarization layer in a coated article in accordance with aspects of the present disclosure).

Throughout the disclosure, the “Rubber Abrasion Test” is also used to determine the durability of a coating. In the Rubber Abrasion Test, a 6 mm diameter by 20 mm long rod of rubber is affixed to a cylindrical tip with a length of 5 mm of a Linear Taber Abrader (Model 5750; Taber Industries, North Tonawanda, NY) with a constant load of 1 kg. The path-length of each swipe is 15 mm, with each cycle comprising a forward and backward swipe to return the tip to its original position before proceeding with the next cycle. The speed was 40 cycles per minute, testing occurred at 23° C. After the coating is abraded for 3,000 cycles, a rubber-abraded water contact angle is measured in accordance with the method for the contact angle described above. In aspects, a rubber-abraded water contact angle of the surface-modifying layer 113 can be greater than or equal to 80°, greater than or equal to 85°, greater than or equal to 90°, greater than or equal to 95°, greater than or equal to 100°, greater than or equal to 105°, or greater than or equal to 110°. In aspects a difference between the water contact angle of the surface-modifying layer (as-formed) and the rubber-abraded water contact angle (after 3,000 cycles) can be less than or equal to 15°, less than or equal to 12°, less than or equal to 10°, or less than or equal to 8°.

In aspects, a visibility of a fingerprint on the surface-modifying layer 113, as defined above as an absolute value of a difference between CIELAB L* values for a portion of the surface-modifying layer with and without fingerprint oil, can be less than or equal to 15, less than or equal to 10, less than or equal to 8, less than or equal to 5, less than or equal to 2. In aspects, a visibility of a fingerprint on the surface-modifying layer can range from greater than or equal to 0 to less than or equal to 15, from greater than or equal to 0.5 to less than or equal to 10, from greater than or equal to 1 to less than or equal to 8, from greater than or equal to 2 to less than or equal to 5, or any range or subrange therebetween. In aspects, a color shift of a fingerprint on the surface-modifying layer 113, as defined above as √((a₁*−a₂*)²+(b₁*−b₂*)²), can be less than or equal to 15, less than or equal to 10, less than or equal to 8, less than or equal to 5, less than or equal to 2. In aspects, a color shift of a fingerprint on the surface-modifying layer 113 can range from greater than or equal to 0 to less than or equal to 15, from greater than or equal to 0.5 to less than or equal to 10, from greater than or equal to 1 to less than or equal to 8, from greater than or equal to 2 to less than or equal to 5, or any range or subrange therebetween.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent to the front surface of the housing. The display can comprise liquid crystal display (LCD), an electrophoretic displays (EPD), an organic light-emitting diode (OLED) display, or a plasma display panel (PDP). The consumer electronic product can comprise a cover substrate disposed over the display. In aspects, at least one of a portion of the housing or the cover substrate comprises the coated article and/or the planarization layer discussed throughout the disclosure. The consumer electronic product can comprise a portable electronic device, for example, a smartphone, a tablet, a wearable device, or a laptop.

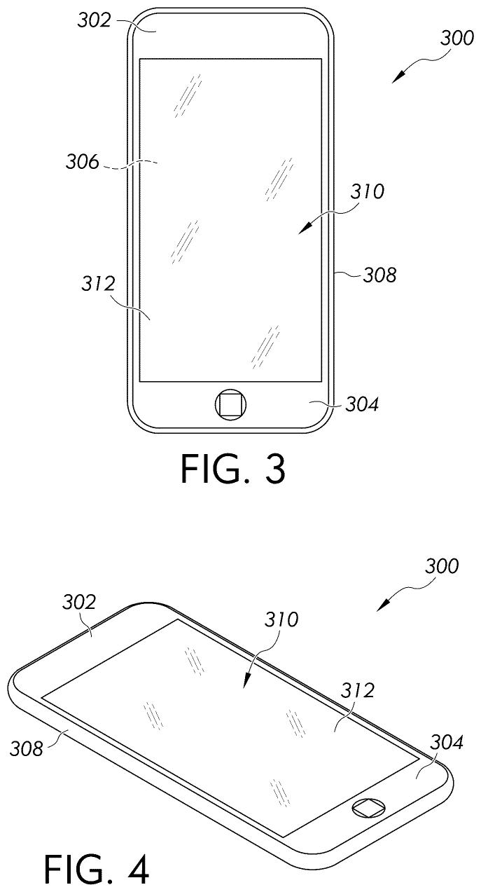

The coated article and/or planarization layer disclosed herein may be incorporated into another article, for example, an article with a display (or display articles) (e.g., consumer electronics, including mobile phones, tablets, computers, navigation systems, wearable devices (e.g., watches), and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the coated articles and/or planarization layer disclosed herein is shown in FIGS. 3-4. Specifically, FIGS. 3-4 show a consumer electronic device 300 including a housing 302 having front 304, back 306, and side surfaces 308. Although not shown, the consumer electronic device can comprise electrical components that are at least partially inside or entirely within the housing. For example, electrical components include at least a controller, a memory, and a display. As shown in FIGS. 3-4, the display 310 can be at or adjacent to the front surface of the housing 302. The consumer electronic device can comprise a cover substrate 312 at or over the front surface of the housing 302 such that it is over the display 310. In aspects, at least one of the cover substrate 312 or a portion of housing 302 may include any of the coated articles and/or planarization layers disclosed herein.

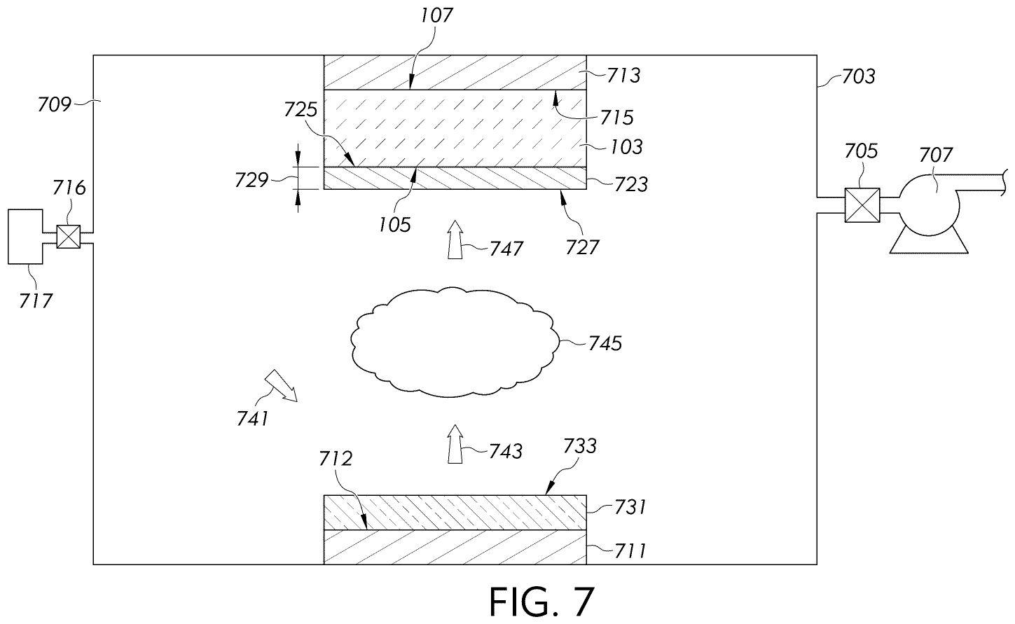

Aspects of methods of making the foldable apparatus and/or foldable substrate in accordance with aspects of the disclosure will be discussed with reference to the flow chart in FIG. 6 and example method steps illustrated in FIGS. 7-12. In a first step 601, as shown in FIGS. 7-8, methods can start with obtaining a substrate 103. In aspects, the substrate 103 may be provided by purchase or otherwise obtaining a substrate or by forming the substrate. In aspects, the substrate 103 can comprise a glass-based substrate and/or a ceramic-based substrate. In further aspects, glass-based substrates and/or ceramic-based substrates can be provided by forming them with a variety of ribbon forming processes, for example, slot draw, down-draw, fusion down-draw, up-draw, press roll, redraw, or float. In further aspects, ceramic-based substrates can be provided by heating a glass-based substrate to crystallize one or more ceramic crystals. The substrate 103 comprises a first major surface 105 that can extend along a first plane 104. In aspects, as indicated in FIG. 1, an optical stack 203 comprising an anti-reflective coating and/or a gradient coating comprising a refractive index gradient can be disposed on and/or bonded to the first major surface 105. Although not shown in FIGS. 8-11, it is to be understood that the optical stack 203, 203a, or 203b can be disposed on the first major surface 105. The optical stack 203, 203a, or 203b can be present by the end of step 601, disposed in step 603, or not be present in the coated article. In aspects, the substrate 103 can be chemically strengthened with one or more compressive stress regions (or central tension regions) comprising any of the aspects related to depth of compression, maximum compressive stress, and/or tensile stress discussed above for the corresponding property.

In aspects, after step 601, methods can proceed to step 603 comprising disposing an optical stack over and/or on the substrate 103 (e.g., first major surface 105). For example, as discussed above, the optical stack 203, 203a, or 203b can be disposed on the first major surface 105. Methods of forming one or more layers of the optical stack can comprise physical vapor deposition (e.g., sputtering, reactive sputtering, electron-beam evaporation, thermal evaporation, plasma-assisted or plasma-enhanced PVD, pulsed laser deposition). The optical stack can comprise one or more of the aspects discussed above for the optical stack 203, 203a, or 203b with reference to FIGS. 2A-2C.

After step 601 or 603, as shown in FIG. 7 methods can proceed to step 605 comprising disposing an initial layer 723 over the substrate 103 (e.g., first major surface 105). In aspects, as shown, step 603 can comprise placing the substrate 103 in a chamber 703 (e.g., vacuum chamber) with an interior 709 that can be maintained at a reduced pressure. In aspects, the reduced pressure of the interior 709 can be less than or equal to 50,000 Pascals (Pa), less than or equal to 1,000 Pa, less than or equal to 1 Pa, less than or equal to 0.1 Pa, less than or equal to 0.01 Pa, greater than or equal to 10⁻⁶ Pa, greater than or equal to 10⁻⁵ Pa, greater than or equal to 10⁻⁴ Pa, or greater than or equal to 10⁻³ Pa. In aspects, the reduced pressure in the interior 709 can range from greater than or equal to 10⁻⁶ Pa to less than or equal to 1,000 Pa, from greater than or equal to 10⁻⁵ to less than or equal to 1 Pa, from greater than or equal to 10⁻⁴ to less than or equal to 0.1 Pa, from greater than or equal to 10⁻³ Pa to less than or equal to 0.01 Pa, or any range or subrange therebetween. In aspects, the pressure (e.g., reduced pressure) of the chamber 703 can be maintained by operating one or more of the valve 705 and 716. In further aspects, the pressure of the chamber 703 can be reduced or maintained by opening the valve 705 connected to a pump 707 that can remove gas from the chamber 703. In further aspects, the pressure of the chamber 703 can be increased or maintained by opening the valve 716 connected to a gas source 717, which adds gas to the chamber, as indicated by arrow 741. In aspects, the gas source 717 can provide a non-reactive gas (e.g., argon, helium, krypton), oxygen, nitrogen, air, or a combination thereof.

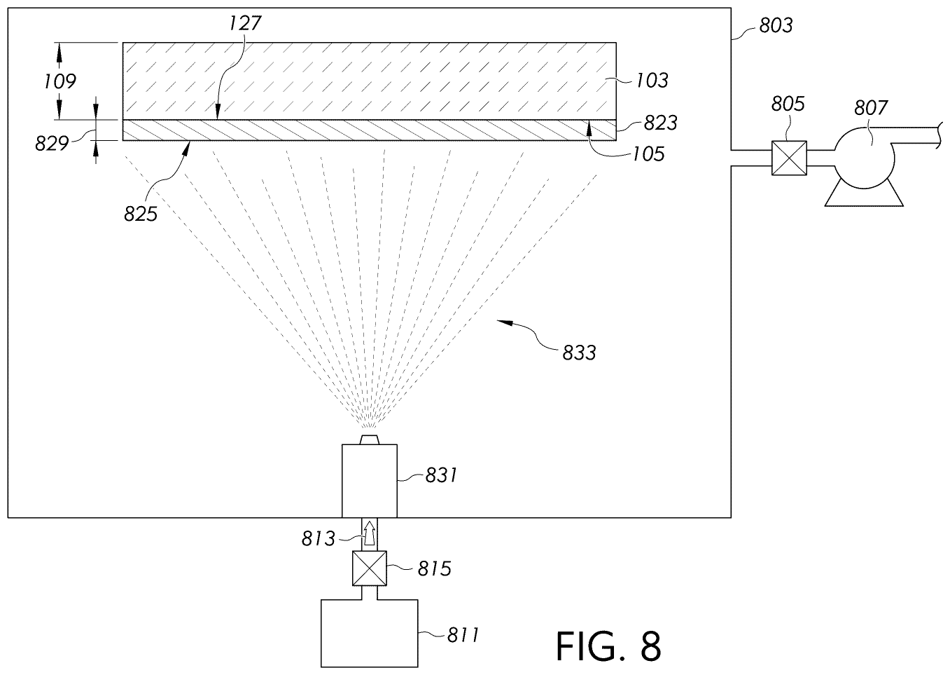

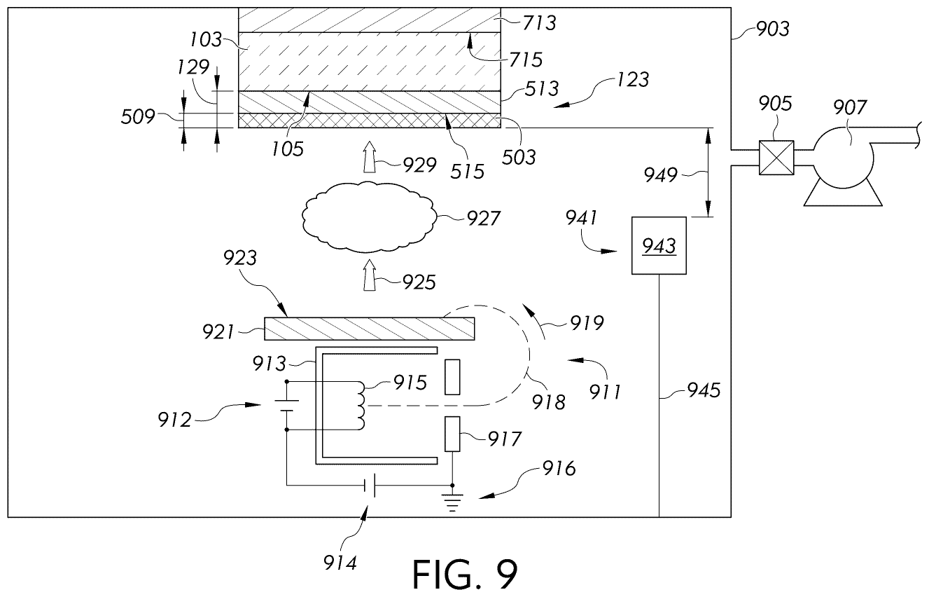

In aspects, the initial layer 723 can comprise a silica-containing material (or a silicon-containing material), for example, silica. In aspects, as shown in FIG. 7, the disposing the initial layer 723 (in step 603) can comprise PVD. For example, FIG. 7 depicts deposition of the initial layer 723 by reactive sputtering. As shown, material from the gas source 717 (e.g., sputtering gas) can impinge a sputtering target 731 (e.g., sputtering surface 733 of the sputtering target 731) as indicated by arrow 741. The sputtering target 731 can be disposed on a first surface 712 of a first holder 711 that can also function as an electrode (e.g., to accelerate sputtering gas towards the sputtering surface 733 and/or to accelerate material sputtered from the sputtering target 731 towards the substrate 103). As shown, the substrate 103 can be positioned opposite the sputtering target 731 and the substrate 103 (e.g., second major surface 107) can be disposed on a second surface 715 of a second holder 713 that can also function as another electrode (e.g., opposite polarity of an electrode corresponding to the first holder 711). The sputtering gas can sputter material from the sputtering target 731 (e.g., sputtering surface 733) as indicated by arrow 743. The sputtered material can further react with material in the interior 709 of the chamber 703, as indicated by cloud 745. Then, the sputtered material and/or the reacted material can be disposed over the first major surface 105 of the substrate 103 to form the initial layer 723, as indicated by arrow 747. For example, silicon material can be sputtered from (arrow 741 for impinging the sputtering surface 733 arrow 743 for sputtered material) the sputtered target, and the sputtered silicon can react with oxygen gas (in cloud 745) to form a silica-containing material (e.g., silica) that is disposed (arrow 747) over the first major surface of the substrate to form the initial layer. An initial thickness 729 of the initial layer 723 (e.g., silica-containing material, silica) defined between an initial surface 727 and a second surface area 725 (e.g., corresponding to second surface area 127 shown in FIGS. 1 and 2A-2C) can be within one or more of the ranges discussed above for the planarization thickness 129 of the planarization layer 123. It is to be understood that a thickness of the initial layer 723 can be greater than the resulting thickness of the inner sublayer 513 (see FIG. 9) as material from the initial layer can be removed in step 605.

After step 601 or 605, as shown in FIG. 8, methods can proceed to step 607 comprising impinging the initial layer 723 (see FIG. 7) with an ion beam 833 generated by a beam source 831. In aspects, as shown, the substrate 103 and the initial layer 723 (to form the initial layer 723) can be positioned in a chamber 803, which can be similar to or identical to the chamber 703 shown in FIG. 7. As shown, a pressure of the chamber 803 can be reduced or maintained by opening the valve 805 connected to a pump 807 that can remove gas from the chamber 803. A reduced pressure of the chamber 803 can be within one or more of the ranges discussed above with reference to step 605. Also, as shown, the impinging the initial surface 727 of the initial layer 723 (see FIG. 7) with the ion beam 833 forms the inner sublayer 823 with an interior surface 825 (e.g., corresponding to second interior surface 515 shown in FIG. 5).

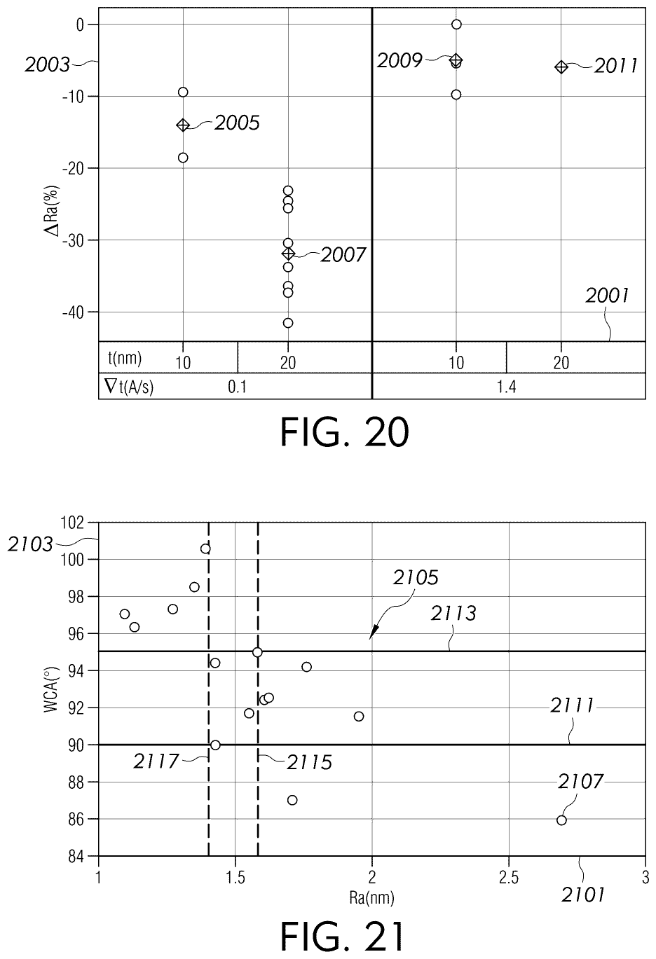

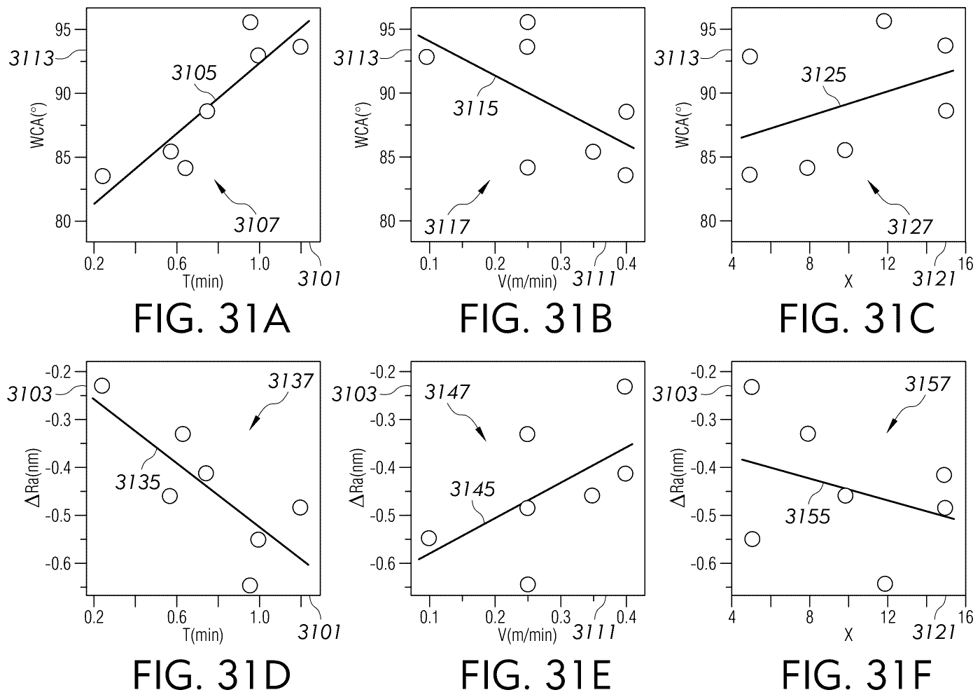

In aspects, a surface roughness Ra of the interior surface 825 of the inner sublayer 823 can be less than or equal to 2.0 nm, less than or equal to 1.9 nm, less than or equal to 1.8 nm, less than or equal to 1.7 nm, less than or equal to 1.6 nm, less than or equal to 1.5 nm, greater than or equal to 0.8 nm, greater than or equal to 1.0 nm, greater than or equal to 1.2 nm, greater than or equal to 1.3 nm, greater than or equal to 1.4 nm, or greater than or equal to 1.5 nm. In aspects, a surface roughness Ra of the interior surface 825 of the inner sublayer 823 can be in a range from greater than or equal to 0.8 nm to less than or equal to 2.0 nm, from greater than or equal to 1.0 nm to less than or equal to 1.9 nm, from greater than or equal to 1.2 nm to less than or equal to 1.8 nm, from greater than or equal to 1.3 nm to less than or equal to 1.8 nm, from less greater or equal to 1.3 nm to less than or equal to 1.7 nm, from greater than or equal to 1.4 nm to less than or equal to 1.6, from greater than or equal to 1.4 nm to less than or equal to 1.5 nm, or any range or subrange therebetween. In aspects, step 607 can reduce the surface roughness Ra from the initial surface 727 of the initial layer 723 (see FIG. 7) to the interior surface 825 of the inner sublayer 823 (as a % of the surface roughness of the initial surface) by greater than or equal to 5%, greater than or equal to 10%, greater than or equal to 15%, greater than or equal to 20%, greater than or equal to 25%, or greater than or equal to 30%, for example, in a range from greater than or equal to 5% to less than or equal to 50%, from greater than or equal to 10% to less than or equal to 45%, from greater than or equal to 15% to less than or equal to 45%, from greater than or equal to 20% to less than or equal to 40%, from greater than or equal to 25% to less than or equal to 40%, from greater than or equal to 30% to less than or equal to 35%, or any range or subrange therebetween. In aspects, step 607 can reduce the surface roughness Ra from the initial surface 727 of the initial layer 723 (see FIG. 7) to the interior surface 825 of the inner sublayer 823 by greater than or equal to 0.1 nm, greater than or equal to 0.2 nm, greater than or equal to 0.3 nm, greater than or equal to 0.4 nm, greater than or equal to 0.5 nm, or greater than or equal to 0.6 nm, for example, in a range from greater than or equal to 0.1 nm to less than or equal to 1.0 nm, from greater than or equal to 0.2 nm to less than or equal to 0.8 nm, from greater than or equal to 0.3 nm to less than or equal to 0.6 nm, from greater than or equal to 0.4 nm to less than or equal to 0.5 nm, or any range or subrange therebetween. For example, as shown in FIGS. 20 and 31-31F, the example ion beam treatments of the present disclosure demonstrate reductions in surface roughness Ra (in % and in nm) within the ranges discussed above in this paragraph.

As shown, an inner thickness 829 of the inner sublayer 823 is defined between the second surface area 127 and the interior surface 825. In aspects, the inner thickness 829 can be less than the initial thickness 729. In even further aspects, (an absolute value of) a difference between the inner thickness 829 and the initial thickness 729 can be less than or equal to 50 nm, less than or equal to 40 nm, less than or equal to 30 nm, less than or equal to 25 nm, less than or equal to 20 nm, less than or equal to 15 nm, or less than or equal to 10 nm. In still further aspects, for example when using a Kaufman-type ion beam source or an end-Hall ion beam source, (an absolute value of) a difference between the inner thickness 829 and the initial thickness 729 can be in a range from greater than or equal to 10 nm to less than or equal to 50 nm, from greater than or equal to 10 nm to less than or equal to 40 nm, from greater than or equal to 15 nm to less than or equal to 30 nm, from greater than or equal to 20 nm to less than or equal to 25 nm, or any range or subrange therebetween. In still further aspects, for example when using a linear ion beam source, (an absolute value of) a difference between the inner thickness 829 and the initial thickness 729 can be less than 10 nm, less than 8 nm, less than 5 nm, or less than 3 nm, for example, in a range from greater than or equal to 1 nm to less than or equal to 30 nm, from greater than or equal to 1 nm to less than or equal to 20 nm, from greater than or equal to 2 nm to less than or equal to 15 nm, from greater than or equal to 3 nm to less than or equal to 10 nm, from greater than or equal to 5 nm to less than or equal to 8 nm, or any range or subrange therebetween.

In aspects, the impinging with the ion beam 833 in step 607 can occur for a period of time of greater than or equal to 20 seconds, greater than or equal to 30 seconds, greater than or equal to 45 seconds, greater than or equal to 1 minute, greater than or equal to 2 minutes, greater than or equal to 3 minutes, greater than or equal to 4 minutes, greater than or equal to 5 minutes, greater than or equal to 10 minutes, greater than or equal to 15 minutes, greater than or equal to 20 minutes, greater than or equal to 30 minutes, less than or equal to 60 minutes, less than or equal to 45 minutes, less than or equal to 30 minutes, less than or equal to 25 minutes, less than or equal to 20 minutes, less than or equal to 15 minutes, less than or equal to 10 minutes, less than or equal to 5 minutes, less than or equal to 3 minutes, less than or equal to 2 minutes, less than or equal to 1 minute, or less than or equal to 45 seconds. In further aspects, the impinging with the ion beam 833 in step 607 can occur for a period of time in a range from greater than or equal to 20 seconds to less than or equal to 60 minutes, from greater than or equal to 30 seconds to less than or equal to 45 minutes, from greater than or equal to 45 seconds to less than or equal to 30 minutes, from greater than or equal to 1 minute to less than or equal to 25 minutes, from greater than or equal to 2 minutes to less than or equal to 20 minutes, from greater than or equal to 3 minutes to less than or equal to 15 minutes, from greater than or equal to 4 minutes to less than or equal to 10 minutes, from greater than or equal to 5 minutes to less than or equal to 10 minutes, or any range or subrange therebetween. In further aspects, for example when using a Kaufman-type ion beam source or an end-Hall ion beam source, the impinging with the ion beam 833 in step 607 can occur for a period of time in a range from greater than or equal to 10 minutes to less than or equal to 60 minutes, from greater than or equal to 15 minutes to less than or equal to 45 minutes, from greater than or equal to 20 minutes to less than or equal to 30 minutes, from greater than or equal to 20 minutes to less than or equal to 25 minutes, or any range or subrange therebetween. In further aspects, for example when using a linear ion beam source, the impinging with the ion beam 833 in step 607 can occur for a period of time in a range from greater than or equal to 20 seconds to less than or equal to 5 minutes, from greater than or equal to 30 seconds to less than or equal to 4 minutes, from greater than or equal to 45 seconds to less than or equal to 3 minutes, from greater than or equal to 1 minute to less than or equal to 2 minutes, or any range or subrange therebetween. In aspects, the impinging with the ion beam 833 in step 607 can occur while a temperature the chamber 803 is maintained in a range from greater than or equal to 20° C. to less than or equal to 40° C., from greater than or equal to 20° C. to less than or equal to 35° C., from greater than or equal to 22° C. to less than or equal to 30° C., from greater than or equal to 22° C. to less than or equal to 28° C., from greater than or equal to 25° C. to less than or equal to 28° C., or any range or subrange therebetween.

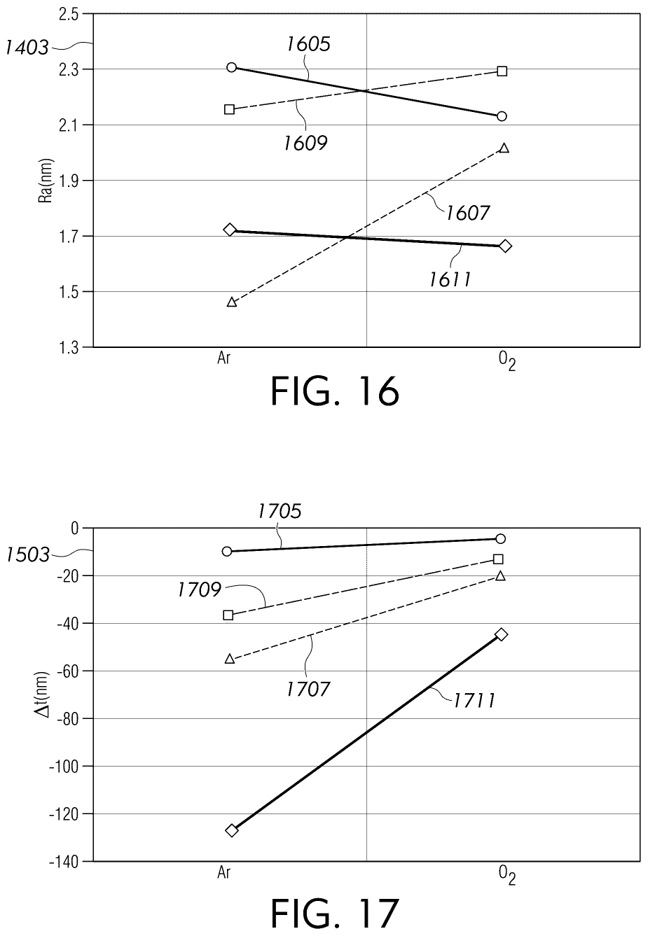

In aspects, as shown in FIG. 8, the ion beam 833 can be generated by dispensing a gas from a container 811, for example regulated by a valve 815, to the beam source 831 as indicated by arrow 813. In aspects, the ion beam 833 can comprise ions of a noble gas (e.g., neon, argon, xenon) or oxygen. An exemplary ion beam comprises, consists essentially of, or consists of oxygen ions. Without wishing to be bound by theory, providing a lower weight ion (e.g., oxygen rather than argon) can achieve the benefit of providing a smoother surface while reducing (e.g., minimizing) the amount of material removed from the initial layer since lower mass ions have less kinetic energy when travelling at the same speed as higher mass ions. Also, ions accelerated in the same electric field are expected to have the same kinetic energy, which results in the velocity of the lighter ion (e.g., oxygen ions) being greater than the velocity of the heavier ion (e.g., argon ions) while the momentum of the heavier ion (e.g., argon ions) is greater than the momentum of the lighter ion (e.g., oxygen ions). Without wishing to be bound by theory, it is believed that the lower force imparted by the lower momentum oxygen ions (relative to heavier, higher momentum argon ions) results in less material being removed from the surface and/or less large-scale rearrangement of the surface that might increase surface unevenness. For example, as demonstrated in FIGS. 16-17 and 27-28 (especially FIGS. 16-17), the oxygen ions in the ion beam can remove less material from the initial layer (FIG. 17) while providing comparable or reduced surface roughness (FIG. 16).

In aspects, the beam source 831 can comprise a Kaufman-type ion beam source, an end-Hall beam source, a linear ion beam source, a grided ion beam source, an inductively coupled plasma (ICP) ion beam source, or combinations thereof. An exemplary aspect of an end-Hall beam source is KRI 400 available from Kaufman & Robinson. An exemplary aspect of a Kaufman-type ion beam source is KDC-10 available from Kaufman & Robinson. An exemplary aspect of a linear ion beam source is the 23 cm RF ion beam source available from the Plasma Process Group.

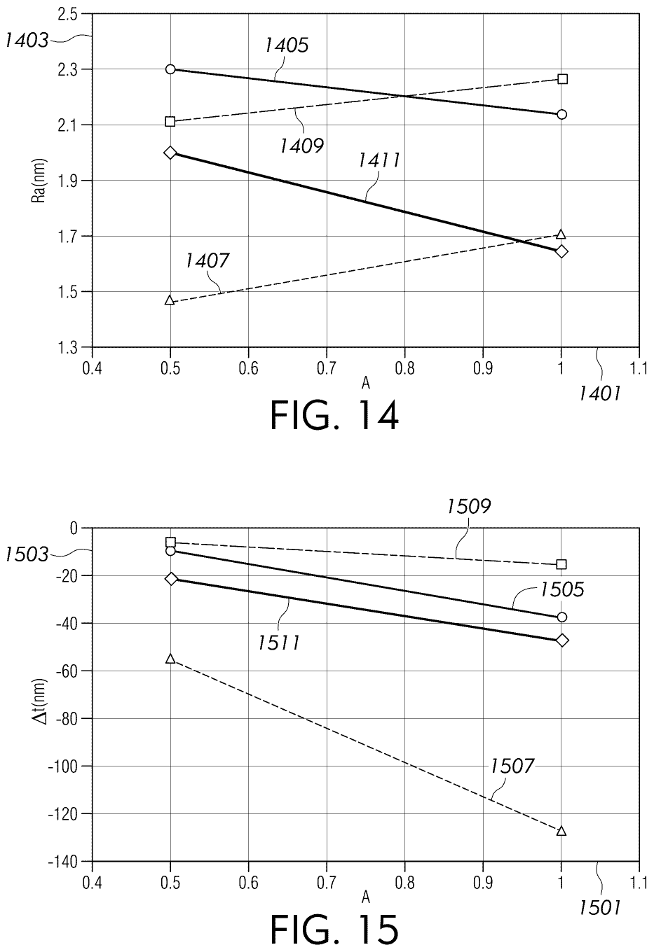

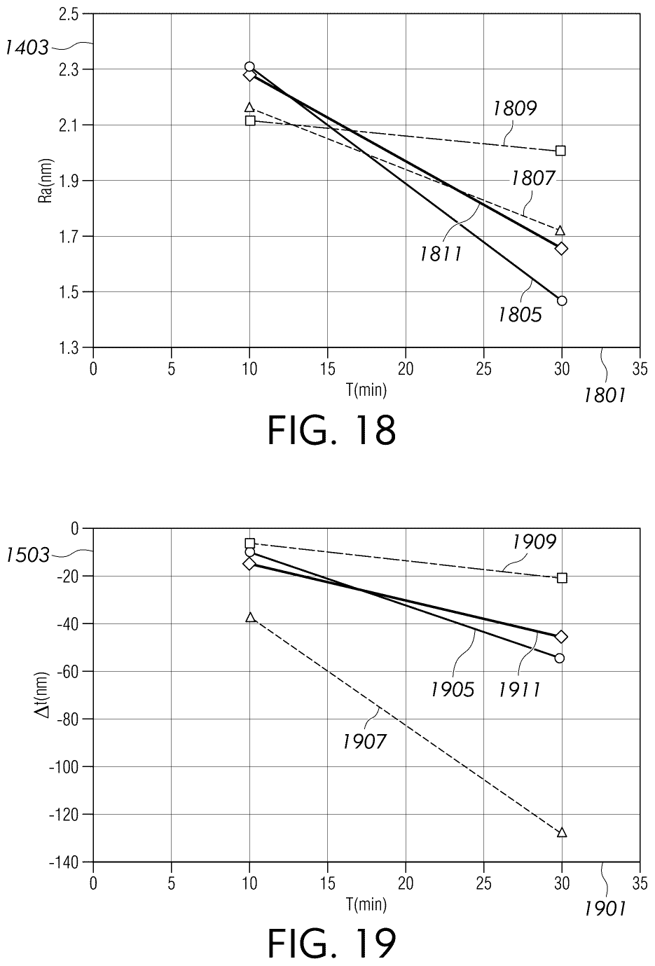

In aspects, the beam source 831 can be a Kaufman-type ion beam source. In aspects, a current associated with operating the Kaufman-type ion beam source can be less than or equal to 1.0 Amp (A), less than or equal to 0.9 A, less than or equal to 0.8 A, less than or equal to 0.7 A, greater than or equal to 0.5 A, greater than or equal to 0.6 A, or greater than or equal to 0.7 A. In aspects, a current associated with operating the Kaufman-type ion beam source can be in a range from greater than or equal to 0.5 A to less than or equal to 1.0 A, from greater than or equal to 0.5 A to less than or equal to 0.9 A, greater less than or equal to 0.6 A to less than or equal to 0.8 A, from greater than or equal to 0.6 A to less than or equal to 0.7 A, or any range or subrange therebetween. For example, as shown in FIG. 14-15, operating the Kaufman-type ion beam source with a current from greater than or equal to 0.5 A to less than or equal to 1.0 A, especially less than 0.8 A or less than 0.7 A, can provide a reduced surface roughness (e.g., less than or equal to 2.0 nm) while minimizing a thickness of the initial layer removed by the ion beam (e.g., less than or equal to 60 nm, less than or equal to 40 nm, or less than or equal to 20 nm). In aspects, as discussed above, (an absolute value of) a difference between the inner thickness 829 and the initial thickness 729 (Δt) can be in a range from greater than or equal to 10 nm to less than or equal to 50 nm, from greater than or equal to 10 nm to less than or equal to 40 nm, from greater than or equal to 15 nm to less than or equal to 30 nm, from greater than or equal to 20 nm to less than or equal to 25 nm, or any range or subrange therebetween. In aspects, as discussed above, the ion beam generated by the Kaufman-type ion beam source can comprise oxygen ions. For example, as shown in FIGS. 16-17, providing oxygen ions can minimize a thickness of the initial layer removed by the ion beam while maintaining or enhancing the surface roughness reduction of the ion beam treatment. In further aspects, the impinging with the ion beam from the Kaufman-type ion beam source can occur for a period of time (T) in a range from about 10 minutes to about 60 minutes, from about 15 minutes to about 45 minutes, from about 20 minutes to about 30 minutes, from about 20 minutes to about 25 minutes, or any range or subrange therebetween. For example, as shown in FIGS. 18-19, impinging the ion beam for more than 10 minutes can reduce a surface roughness Ra of the interior surface.

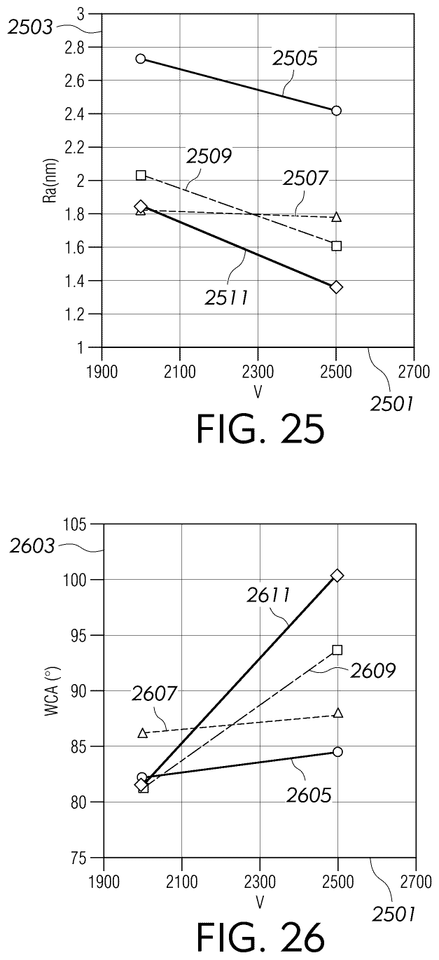

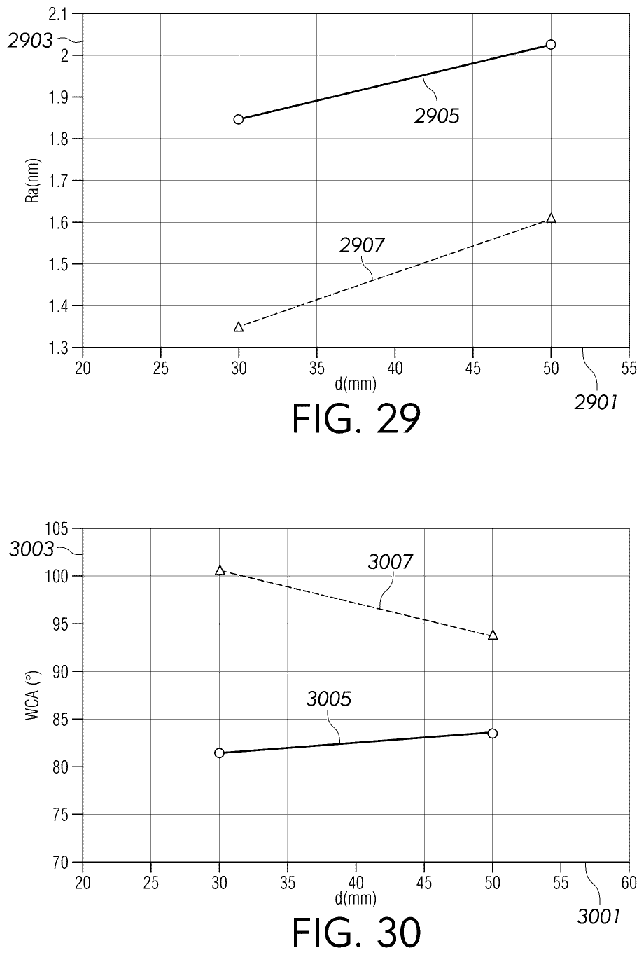

In aspects, the beam source 831 can be a linear ion beam source. In further aspects, the linear ion beam source can be operated at a voltage of greater than or equal to 2000 V, greater than or equal to 2100 V, greater than or equal to 2200 V, greater than or equal to 2300 V, greater than or equal to 2400 V, less than or equal to 2500 V, less than or equal to 2400 V, less than or equal to 2300 V, or less than or equal to 2200 V. In further aspects, the linear ion beam source can be operated at a voltage in a range from greater than or equal to 2000V to less than or equal to 2500 V, from greater than or equal to 2100 V to less than or equal to 2500 V, from greater than or equal to 2200 V to less than or equal to 2400 V, from greater than or equal to 2300 V to less than or equal to 2400 V, or any range or subrange therebetween. For example, as shown in FIGS. 25-26, providing a linear ion beam source operated at greater than or equal to 2000 V (e.g., at 2500 V) can provide a reduced surface roughness (e.g., a surface roughness Ra of less than or equal to 2 nm) of the interior surface and/or an increased water contact angle (e.g., steel-wool abraded water contact angle) of a surface-modifying layer disposed thereon (e.g., greater than or equal to 85°, greater than or equal to 90°, or less than or equal to 95°). In further aspects, a distance that the linear ion beam source is positioned from the surface of the initial layer can be greater than or equal to 10 millimeters (mm), greater than or equal to 15 mm, greater than or equal to 20 mm, greater than or equal to 25 mm, less than or equal to 50 mm, less than or equal to 40 mm, less than or equal to 35 mm, less than or equal to 30 mm, less than or equal to 25 mm, or less than or equal to 20 mm. In further aspects, a distance that the linear ion beam source is positioned from the surface of the initial layer can be in a range from greater than or equal to 10 mm to less than or equal to 50 mm, from greater than or equal to 10 mm to less than or equal to 40 mm, from greater than or equal to 15 mm to less than or equal to 35 mm, from greater than or equal to 15 mm to less than or equal to 30 mm, from greater than or equal to 20 mm to less than or equal to 25 mm, or any range or subrange therebetween. For example, as shown in FIGS. 29-30, bringing the linear ion beam source closer to the sample can improve the surface roughness of the interior surface while maintaining or increasing the water contact angle (e.g., steel-wool abraded water contact angle) of the surface-modifying layer disposed thereon. In aspects, as discussed above, the ion beam generated by the linear ion beam source can comprise oxygen ions. In further aspects, (an absolute value of) a difference between the inner thickness 829 and the initial thickness 729 (Δt) can be less than 10 nm, less than 8 nm, less than 5 nm, or less than 3 nm, for example, in a range from greater than or equal to 1 nm to less than or equal to less than 10 nm, from greater than or equal to 2 nm to less than 10 nm, from greater than or equal to 3 nm to less 10 nm, from greater than or equal to 5 nm to less than or equal to 8 nm, or any range or subrange therebetween. In further aspects, the impinging with the ion beam from the linear ion beam source can occur for a period of time (T) in a range from about 20 seconds to about 5 minutes, from about 30 seconds to about 4 minutes, from about 45 seconds to about 3 minutes, from about 1 minute to about 2 minutes, or any range or subrange therebetween. For example, as shown in FIGS. 31A and 31D, the impinging the ion beam for more than 0.2 minutes can reduce a surface roughness Ra of the interior surface and/or increase a water contact angle (e.g., steel-wool abraded water contact angle) of the surface-modifying layer disposed thereon.

After step 607, as shown in FIG. 9, methods can proceed to step 609 comprising disposing a silica-containing material (e.g., outer sublayer 503) on the inner sublayer 513 to form the planarization layer 123. As shown, the planarization layer 123 comprises the inner sublayer 513 and the outer sublayer 503 disposed thereon. In aspects, the silica containing material of the outer sublayer 503 can comprise, consist essentially of, or consist of silica. In further aspects, as discussed above, the outer sublayer 503 and the inner sublayer 513 can comprise the same material, for example, silica, although a microstructure of the outer sublayer 503 can be different (e.g., smaller) than a corresponding microstructure of the inner sublayer 513. In aspects, as discussed above, the outer thickness 509 of the outer sublayer 503 can be greater than or equal to 10 nm, greater than or equal to 15 nm, greater than or equal to 20 nm, greater than or equal to 25 nm, less than or equal to 100 nm, less than or equal to 80 nm, less than or equal to 50 nm, less than or equal to 40 nm, less than or equal to 30 nm, or less than or equal to 25 nm. In aspects, the outer thickness 509 of the outer sublayer 503 can be in a range from greater than or equal to 10 nm to less than or equal to 100 nm, from greater than or equal to 10 nm to less than or equal to 80 nm, from greater than or equal to 15 nm to less than or equal to 50 nm, from greater than or equal to 15 nm to less than or equal to 40 nm, from greater than or equal to 15 nm to less than or equal to 30 nm, from greater than or equal to 20 nm to less than or equal to 25 nm, or any range or subrange therebetween.

As shown in FIG. 9, the disposing the outer sublayer 503 can occur in a chamber 903, which can be similar to or identical to the chamber 703 or 803 shown in FIGS. 7-8. As shown, a pressure of the chamber 903 can be reduced or maintained by opening the valve 905 connected to a pump 907 that can remove gas from the chamber 903. A reduced pressure of the chamber 903 can be within one or more of the ranges discussed above with reference to step 605. In aspects, the outer sublayer 503 can be disposed using physical vapor deposition. As shown in FIG. 9, an exemplary method for disposing the outer sublayer 503 is e-beam evaporation, although other evaporation methods can be used in other aspects (e.g., resistive thermal evaporation). In aspects, as shown, a voltage difference (e.g., from a first power supply 912) is applied across a filament 915, where the filament emits electrons that can travel along path 918 in direction 919. The filament can be positioned in a body 913 of the e-beam evaporator apparatus 911. Further, electrons emitted from the filament can be accelerated by another voltage difference (e.g., second voltage difference 914 between plates 917 and the filament 915 relative to an equipment ground 916) that can apply an electric field and/or magnetic field that also causes the path 918 to curve and impinge a target surface 923 of a target 921. The target 921 can comprise the material to be disposed on the inner sublayer 513 as the outer sublayer 503. For example, the target 921 can comprise a silica-containing material, namely, silica. Unlike sputtering, the material of the target 921 is evaporated (or sublimated) to the gas phase rather than being ejected without undergoing a phase change (as in sputtering). As indicated by arrow 925, the evaporated material travels as a gas (indicated by cloud 927) that can be deposited on the inner sublayer 513 (e.g., second interior surface 515) to form the outer sublayer 503.

In aspects, a deposition rate of the silica-containing material (e.g., silica) of the outer sublayer 503 can be monitored using a sensor 941 comprising a surface 943 that is positioned a predetermined distance 949 from the surface (e.g., second interior surface 515 of the inner sublayer 513), for example, with the position being maintained by a support 945. In further aspects, the sensor 941 can be configured to detect nanogram differences in mass from material deposited on the surface 943 during step 609, where the increase in mass and predetermined surface area of the surface 943 can be used to determine an effective deposition rate. It is to be understood that the “effective deposition rate” is not necessarily the actual deposition rate on the surface (e.g., second interior surface 515 of the inner sublayer 513). An exemplary aspect of the sensor 941 is a quartz crystal microbalance (QCM). As used herein, the “deposition rate” refers to the effective deposition rate as measured by a QCM (sensor 941) positioned 500 mm below the surface (predetermined distance 949) and 150 mm above the target surface 923. In aspects, a deposition rate (e.g., effective deposition rate from QCM) of the silica-containing material for the outer sublayer 503 in step 609 can be greater than or equal to 0.01 nanometers per second (nm/s) (0.1 Å/s), greater than or equal to 0.02 nm/s (0.2 Å/s), greater than or equal to 0.03 nm/s (0.3 Å/s), greater than or equal to 0.05 nm/s (0.5 Å/s), greater than or equal to 0.07 nm/s (0.7 Å/s), less than 0.14 nm/s (1.4 Å/s), less than or equal to 0.10 nm/s (1.0 Å/s), less than or equal to 0.08 nm/s (0.8 Å/s), less than or equal to 0.06 nm/s (0.6 Å/s), less than or equal to 0.05 nm/s (0.5 Å/s), less than or equal to 0.04 nm/s (0.4 Å/s), less than or equal to 0.03 nm/s (0.3 Å/s), or less than or equal to 0.02 nm/s (0.2 Å/s). In aspects, a deposition rate (e.g., effective deposition rate from QCM) can range from greater than or equal to 0.01 nm/s to less than about 0.14 nm/s, from greater than or equal to 0.01 nm/s to less than or equal to 0.10 nm/s, from greater than or equal to 0.01 nm/s to less than or equal to 0.08 nm/s, from greater than or equal to 0.01 nm/s to less than or equal to 0.06 nm/s, from greater than or equal to 0.01 nm/s to less than or equal to 0.05 nm/s, from greater than or equal to 0.01 nm/s to less than or equal to 0.04 nm/s, from greater than or equal to 0.01 nm/s to less than or equal to 0.03 nm/s, or any range or subrange therebetween. In aspects, a deposition rate (e.g., effective deposition rate from QCM) can range from greater than or equal to 0.01 nm/s to less than 0.10 nm/s, from greater than or equal to 0.02 nm/s to less than or equal to 0.10 nm/s, from greater than or equal to 0.02 nm/s to less than or equal to 0.08 nm/s, from greater than or equal to 0.03 nm/s to less than or equal to 0.06 nm/s, from greater than or equal to 0.03 nm/s to less than or equal to 0.05 nm/s, from greater than or equal to 0.04 nm/s to less than or equal to 0.05 nm/s. As demonstrated in FIG. 20, deposition rates (e.g., effective deposition rates from QCM) of less than 0.14 nm/s (e.g., about 0.10 nm/s) produced outer surfaces of planarization layers within the scope of the present disclosure. Controlling the deposition rate within one or more of the above-mentioned ranges can efficiently (e.g., quickly) deposit a substantially uniform coating of the silica-containing material while further providing a low surface roughness of the resulting outer surface of the outer sublayer.

In aspects, the outer thickness 509 of the outer sublayer 503 can be in a range from greater than or equal to 10 nm to less than or equal to 100 nm, from greater than or equal to 10 nm to less than or equal to 80 nm, from greater than or equal to 15 nm to less than or equal to 50 nm, from greater than or equal to 15 nm to less than or equal to 40 nm, from greater than or equal to 15 nm to less than or equal to 30 nm, from greater than or equal to 20 nm to less than or equal to 25 nm, or any range or subrange therebetween. As demonstrated in FIG. 20, providing an outer thickness of greater than or equal to 10 nm (e.g., about 20 nm) can reduce a surface roughness by 10% or more (e.g., from about 20% to about 50%). In aspects, the surface roughness Ra (or other characteristics including the surface height variation, domain density, ratio of mean peak height to surface height variation) of the outer surface of the outer sublayer 503 formed in step 609 can be within one or more of the corresponding ranges discussed above for the first surface area 125 of the planarization layer 123 (e.g., outer surface 505 of the outer sublayer 503). In further aspects, the surface roughness Ra (or other characteristics including the surface height variation, domain density, ratio of mean peak height to surface height variation) of the first surface area 125 of the planarization layer 123 (e.g., outer surface 505 of the outer sublayer 503) can be less than the corresponding characteristic of the second interior surface 515 of the inner sublayer 513. In aspects, as discussed above, the material of the outer sublayer 503 can be silica. In further aspects, the material of the outer sublayer 503 can be the same as the material of the inner sublayer 513. In aspects, a microstructure of the outer surface of the outer sublayer formed in step 609 can be less than a corresponding microstructure of the second interior surface 515 of the inner sublayer 513.

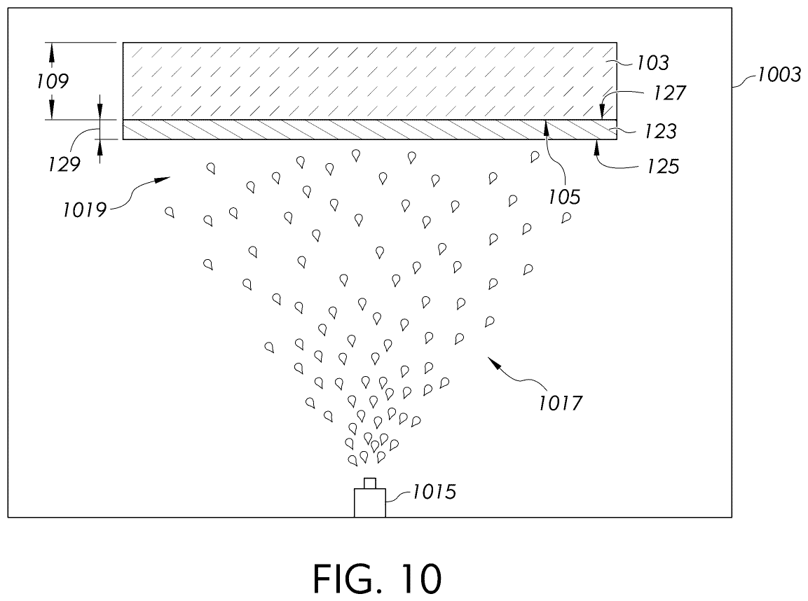

In aspects, after step 609, as shown in FIGS. 10-12, methods can proceed to step 611 comprising disposing a surface-modifying layer 113 (see FIGS. 1 and 2A-2C) on the first surface area 125 of the planarization layer 123. In further aspects, as shown in FIG. 10, step 611 can comprise spraying droplets 1017 of a solution from a nozzle 1015 towards the first surface area 125 of the planarization layer 123 (e.g., as a cone 1019), although other methods can be used in other aspects. In further aspects, the solution can be spray coated on the planarization layer 123 to form the surface-modifying layer 113. Alternatively, the surface-modifying layer 113 can be formed by physical vapor deposition, for example, evaporative methods including e-beam evaporation and/or thermal evaporation. In further aspects, step 611 can be performed at atmospheric pressure and/or a pressure within one or more of the ranges discussed above for step 605. In further aspects, as shown in FIG. 12, step 611 can further comprise heating the deposited solution (e.g., from droplets 1017), for example by placing the substrate 103 in an oven 1201. For example, the oven 1201 can be an inert ampoule heated at a temperature from greater than or equal to 60° C. to less than or equal to 200° C. (e.g., greater than or equal to 60° C., greater than or equal to 80° C., greater than or equal to 90° C., greater than or equal to 100° C., greater than or equal to 120° C., greater than or equal to 140° C., greater than or equal to 250° C., less than or equal to 220° C., less than or equal to 200° C., less than or equal to 180° C., or less than or equal to 160° C.). Samples with a surface-modifying layer can be formed by: (optionally) plasma treating (for surface activation) with an O₂ or Ar plasma, placing the sample in the ampoule with a drop of a precursor material for the surface-modifying layer before sealing the ampoule, and heating the ampoule for from about 2 hours to about 5 hours. Alternatively, a high vacuum coating chamber similar to the chamber 703, 803, and/or 903 shown in FIGS. 7-9 can be used. The precursor solution for the surface-modifying layer can be vaporized from either a liquid injection source or desorbed from a sorbate (typically enclosed in a canister) using a thermal source such as a resistively heated tungsten boat, an effusion or Knudesn cell, or an electron beam evaporator. Deposition rate and total thickness can be monitored in these systems with a quartz crystal monitor (QCM). This type of chamber is commonly used in production of fluorinated ETC coatings on handheld devices such as cellphones.

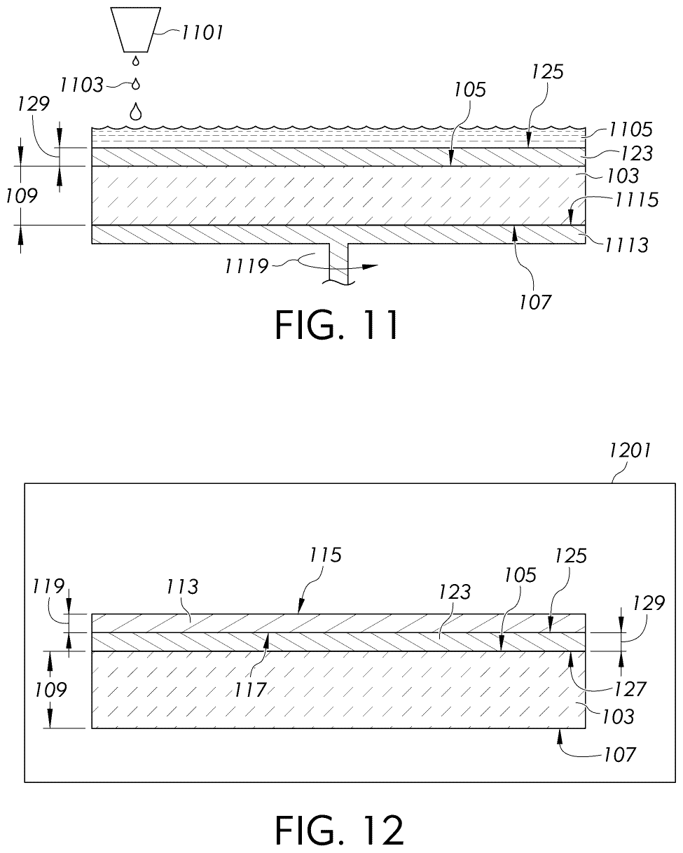

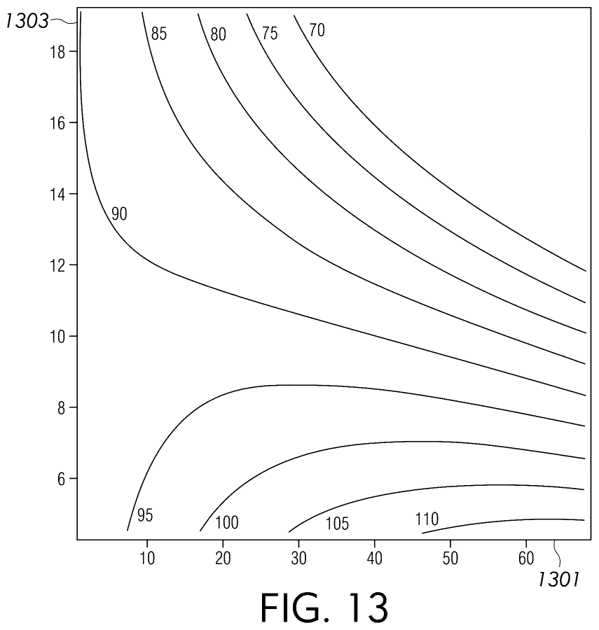

Alternatively, as shown in FIGS. 11-12, step 611 can comprise disposing a precursor solution 1103 over the first major surface 105 of the substrate 103. In aspects, as shown in FIG. 11, the precursor solution 1103 can be dispensed from a container 1101 (e.g., conduit, flexible tube, micropipette, ink-jet print head, or syringe) over (e.g., onto) the first major surface 105 of the substrate 103 to form a precursor layer 1105. In further aspects, as shown, step 611 can comprise spin coating the precursor solution 1103 over the first major surface 105, for example, by disposing the second major surface 107 of the substrate 103 over a surface 1115 of a holder 1113 and the holder can be rotated (as shown by arrow 1119) while and/or after the precursor solution 1103 is disposed over the first major surface 105. In even further aspects, the holder 1113 can be rotated at greater than or equal to 200 revolutions per minute (rpm), greater than or equal to 500 rpm, greater than or equal to 700 rpm, less than or equal to 4,000 rpm, less than or equal to 2,500 rpm, or less than or equal to 1,500 rpm. In even further aspects, the holder 1113 can be rotated from greater than or equal to 200 rpm to less than or equal to 4,000 rpm, from greater than or equal to 500 rpm to less than or equal to 2,500 rpm, from greater 700 rpm to less than or equal to 1,500 rpm, or any range or subrange therebetween. Spin coating the precursor solution can form a substantially uniform precursor layer over the first major surface of the substrate. Then, the precursor solution can be cured at room temperature (e.g., ambient conditions) or by placing the disposed precursor solution in an oven 1201, which can be maintained at the temperature for the period of time discussed above with reference to FIG. 12.

In aspects, after step 611, methods can proceed to step 613 comprising assembling the coated article comprising the planarization layer 123 and/or the surface-modifying layer 113 into a consumer electronic device. For example, the surface-modifying layer 113 can comprise an exterior surface of a display portion of a display device and/or a touch-sensor. For example, the surface-modifying layer 113 can comprise an exterior surface of at least a portion of a consumer electronic device.

After step 609, 611, or 613, methods can proceed to step 615, where methods of making the coated article can be complete. In aspects, methods of making a coated article in accordance with aspects of the disclosure can proceed along steps 601, 603,605, 607, 609, 611, and 613 of the flow chart in FIG. 6 sequentially, as discussed above. In aspects, methods can follow arrow 602 from step 601 to step 605, for example, if the optical stack 203, 203a, and/or 203b is already disposed on the substrate 103 at the end of step 601 or the coated article will not have an optical stack between the substrate and the planarization layer. In aspects, methods can follow arrow 604 from step 601 to step 607, for example, if the initial layer (corresponding to the resulting inner sublayer) is already disposed over the substrate at the end of step 601. In aspects, methods can follow arrow 606 from step 609 to step 615, for example, if methods are complete at the end of step 609. In aspects, methods can follow arrow 608 from step 611 to step 615, for example, if methods are complete at the end of step 615. Any of the above options may be combined to make a foldable apparatus in accordance with the embodiments of the disclosure.

### EXAMPLES

Various aspects will be further clarified by the following examples. Examples 1-41 and Comparative Example AA comprised a glass-based substrate (Composition 1 having a nominal composition in wt % of: 67.6 SiO₂; 12.7 Al₂O₃; 13.6 Na₂O; 3.7 B₂O₃, 2.3 MgO, and 0.1 Sn₂O) with a thickness of 0.8 mm. Unless otherwise stated, the glass-based substrate had a surface roughness Ra of about 0.2 nm. Examples 1-41 and Comparative Example AA comprised the optical stack shown in Table 1 (corresponding to the order that the layers are deposited—meaning that the first row is the closest to the glass-based substrate and the last row is the furthest from the glass-based substrate) disposed on the glass-based substrate. In Table 1, “SiNₓ” refers to silicon nitride, which can have a non-stoichiometric (i.e., other than Si₃N₄) ratio of the constituent atoms; and “SiON” refers to silicon oxynitride (i.e., SiOₓN_{y} with non-zero amounts of both silicon and oxygen—x>0, y>0—and x+y is less than or equal to 1). The reactively sputtered silica layers were formed using: a Metamode sputter tool (Optorun Co., Ltd.) with 9 kiloWatts (kW) of mid-frequency power applied to a dual rotatory magnetron cathode to sputter material from an amorphous silicon target with 180 sccm Ar provided to the dual rotary magnetron; also, inductively coupled plasma with 3 kW of radio frequency power transformed the sputtered silicon to silica with 180 sccm oxygen gas and 80 sccm Ar at 23° C. The final SiO₂ layer shown in Table 1 was formed by reactively sputtering SiO₂ at a deposition rate of about 1.4 Å/s. As used herein, the final SiO₂ layer shown in Table 1 will be referred to as the “initial layer.” Comparative Example AA was not further processed whereas Examples 1-8 were treated with an ion beam generated by a Kaufman-type ion beam source with the conditions stated in Table 2 and Examples 24-31 were treated with an ion beam generated from a linear ion beam source with the conditions stated in Table 5.

TABLE 1
Composition of Optical Stack

| | Refractive | Thickness |
|---|---|---|
| Material | Index | (nm) |
| (substrate) | 1.50 | |
| SiO₂ | 1.48 | 20.0 |
| SiON | 1.94 | 8.0 |
| SiO₂ | 1.48 | 64.0 |
| SiON | 1.94 | 20.0 |
| SiO₂ | 1.48 | 49.2 |
| SiON | 1.94 | 35.9 |
| SiO₂ | 1.48 | 26.4 |
| SiON | 1.94 | 50.6 |
| SiO₂ | 1.48 | 8.0 |
| SiON | 1.94 | 1500. |
| SiO₂ | 1.48 | 16.0 |
| SiNₓ | 2.01 | 39.4 |
| SiO₂ | 1.48 | 50.4 |
| SiNₓ | 2.01 | 25.2 |
| SiO₂ | 1.48 | 85.6 |
| SiNₓ | 2.01 | 26.0 |
| SiO₂ | 1.48 | 45.1 |
| SiNₓ | 2.01 | 154.4 |
| SiO₂ | 1.48 | 101.5 |
| (air) | 1.00 | |

Table 2 presents the conditions and properties of Examples 1-8 (and the properties of Comparative Example AA). The initial surface of the initial layer (outer SiO₂) was treated with a Kaufman-type ion beam source using the conditions stated in Table 2. As used in this section, the ion beam treatments occurred in a chamber with a chamber pressure of about 6.7×10⁻³ Pa (5×10⁻⁵ Torr). As used in Tables 2, 4-5, and 7, “At” refers to a change in thickness as a result of the corresponding treatment, “SHV” refers to the surface height variation (as defined above), and “H/SHV” refers to a ratio of the mean peak height to the surface height variation (as defined above).

TABLE 2
Conditions and Properties of Examples 1-8 and Comparative Example AA
using Kaufman-type Ion Beam Source

| Example | 1 | 2 | 3 | 4 | 5 | 6 | 7 | 8 | AA |
|---|---|---|---|---|---|---|---|---|---|
| Voltage | 1000 | 1000 | 1000 | 1000 | 1000 | 1000 | 1000 | 1000 | n/a |
| (V) | | | | | | | | | |
| Current | 0.5 | 0.5 | 1 | 1 | 0.5 | 0.5 | 1 | 1 | n/a |
| (A) | | | | | | | | | |
| O₂ (sccm) | 0 | 0 | 0 | 0 | 50 | 50 | 50 | 50 | n/a |
| Ar (sccm) | 80 | 80 | 80 | 80 | 0 | 0 | 0 | 0 | n/a |
| time (min) | 10 | 30 | 10 | 30 | 10 | 30 | 10 | 30 | n/a |
| Surface | 2.31 | 1.46 | 2.16 | 1.71 | 2.12 | 2.0 | 2.28 | 1.65 | 2.7 |
| Roughness | | | | | | | | | |
| Ra (nm) | | | | | | | | | |
| Δt (nm) | −10 | −55 | −36 | −127 | −6 | −22 | −14 | −46 | n/a |
| SHV (μm²) | 0.46 | 0.22 | 0.39 | 0.26 | 0.37 | 0.32 | 0.44 | 0.25 | 0.60 |
| H/SHV | 6.05 | 1.57 | 4.62 | 2.43 | 4.48 | 3.65 | 5.73 | 2.22 | 9.8 |
| (nm/μm²) | | | | | | | | | |

TABLE 3
Curves for FIGS. 14-19 using Examples 1-8 (see Table 2)

| Curve | Examples |
|---|---|
| 1405, 1505 | 1, 3 |
| 1407, 1507 | 2, 4 |
| 1409, 1509 | 5, 7 |
| 1411, 1511 | 6, 8 |
| 1605, 1705 | 1, 5 |
| 1607, 1707 | 2, 6 |
| 1609, 1709 | 3, 7 |
| 1611, 1711 | 4, 8 |
| 1805, 1905 | 1, 2 |
| 1807, 1907 | 3, 4 |
| 1809, 1909 | 5, 6 |
| 1811, 1911 | 7, 8 |

FIGS. 14-19 present the trends for Examples 1-8 with Table 3 indicating which examples (Examples 1-8) were used for the endpoints of the corresponding curves in FIGS. 14-19. FIGS. 14-15 present the effect of the current (in Amps) on the surface roughness of the interior surface and the removed thickness (Δt). In FIGS. 14-15, the horizontal axis 1401 and 1501 (i.e., x-axis) corresponds to the current (in Amps) associated with the Kaufman-type ion beam source, the vertical axis 1403 (i.e., y-axis) in FIG. 14 corresponds to the surface roughness Ra of the interior surface (in nm), and the vertical axis 1503 (i.e., y-axis) in FIG. 15 corresponds to the thickness removed (Δt) by the ion beam treatment. Curves 1405 and 1409 (1505 and 1509) involved a treatment time of 10 minutes while curves 1407 and 1411 (1507 and 1511) involved a treatment time of 30 minutes. Curves 1405 and 1407 (1505 and 1507) involved argon ions while curves 1409 and 1411 (1509 and 1511) involved oxygen ions.

As shown in FIG. 14, the surface roughness Ra decreased as the current increased for curves 1405 and 1411 while the opposite trend is observed for curves 1407 and 1409. Curves 1407 and 1411 have lower surface roughness than curves 1405 and 1409. As shown in FIG. 15, the thickness removed increases with increasing current for all curves shown. Curves 1505, 1509, and 1511 are associated with less material removed than in curve 1507. Removing less material while achieving the same (or better surface roughness Ra) has the benefit of less processing to achieve a target thickness (since less material can be disposed after the ion beam treatment to achieve the target thickness). Combining the trends observed in FIGS. 14-15, low surface roughness Ra and low remove thickness are achieved for curve 1411 or 1511 (at 1 A current) and curve 1407 or 1507 (at 0.5 A current) (Examples 8 and 2, respectively).

FIGS. 16-17 present the effect of the ion material (argon ions versus oxygen ions) on the surface roughness of the interior surface and the removed thickness (Δt). In FIGS. 16-17, the horizontal axis (i.e., x-axis) corresponds to the ion material (argon ions versus oxygen ions) generated by the Kaufman-type ion beam source that is controlled by the process gases used as shown in Table 2, the vertical axis 1603 (i.e., y-axis) in FIG. 16 corresponds to the surface roughness Ra of the interior surface (in nm), and the vertical axis 1703 (i.e., y-axis) in FIG. 17 corresponds to the thickness removed (Δt) by the ion beam treatment. Curves 1605 and 1609 (1705 and 1709) involved a treatment time of 10 minutes while curves 1607 and 1611 (1707 and 1711) involved a treatment time of 30 minutes. Curves 1605 and 1607 (1705 and 1707) involved a current of 0.5 A while curves 1609 and 1611 (1709 and 1711) involved a current of 1 A.

As shown in FIG. 16, longer treatment times (curves 1607 and 1611) are generally associated with lower surface roughness. As shown in FIG. 17, the thickness removed decreased by switching from argon ions to oxygen ions. Notably, the longest treatment with Ar (left point of curve 1711) removed the entire initial SiO₂ layer. Without wishing to be bound by theory, the increased mass of argon ions relative to oxygen ions have increased kinetic energy (for the same velocity) that can have more intense impacts on the surface that removes additional material from the surface. Also, ions accelerated in the same electric field are expected to have the same kinetic energy, which results in the velocity of the lighter ion (e.g., oxygen ions) being greater than the velocity of the heavier ion (e.g., argon ions) while the momentum of the heavier ion (e.g., argon ions) is greater than the momentum of the lighter ion (e.g., oxygen ions). Without wishing to be bound by theory, it is believed that the lower force imparted by the lower momentum oxygen ions (relative to heavier, higher momentum argon ions) results in less material being removed from the surface and/or less large-scale rearrangement of the surface that might increase surface unevenness. To achieve reduced surface roughness while minimizing the thickness removed, using oxygen ions better achieves this objective since less thickness is removed using oxygen ions (as shown in FIG. 17).

FIGS. 18-19 present the effect of the treatment time (in minutes (min)) on the surface roughness of the interior surface and the removed thickness (Δt). In FIGS. 18-19, the horizontal axis (i.e., x-axis) corresponds to the treatment time (in min) with ion beam from the Kaufman-type ion beam source, the vertical axis 1803 (i.e., y-axis) in FIG. 18 corresponds to the surface roughness Ra of the interior surface (in nm), and the vertical axis 1903 (i.e., y-axis) in FIG. 19 corresponds to the thickness removed (Δt) by the ion beam treatment. As shown in FIG. 18, the surface roughness Ra decreases as the treatment time increases with the greatest decrease seen for curve 1805. As shown in FIG. 19, the thickness removed also increases as the treatment time increases. Consequently, there is generally a tradeoff between lower surface roughness from increased treatment time and decreased thickness removed from decreased treatment time. As shown between FIGS. 18-19, the lowest surface roughness Ra with less than 60 nm removed is achieved for curve 1805 and 1905 followed by curve 1811 and 1911 (both for 30 minute treatment times).

Overall, combining the observations from FIGS. 14-19, decreased current (e.g., less than 0.8 A or from 0.5 A to 0.8 A), oxygen ions, and decreased treatment times (e.g., less than 20 min or from 10 min to 15 min) can achieve reduced surface roughness with minimal thickness removed (e.g., less than or equal to 60 nm, or from greater than or equal to 10 nm to less than or equal to 60 nm).

Table 4 presents the treatment conditions and properties of Examples 9-23. As shown, Examples 9-23 build on the ion-beam treatment of Examples 1-8 (or no treatment for Comparative Example AA) with the deposition of an outer sublayer of silica (by e-beam evaporation) with the condition stated in Table 4. The properties (e.g., surface roughness Ra, SHV, and H/SHV) of the outer surface of the planarization layer (outer surface of the outer sublayer comprising silica from e-beam evaporation) are presented in Table 4. The deposition rate (as measured by QCM) is stated in Table 4. Then, a surface-modifying layer (namely an easy-to-clean coating) was formed on the outer surface by e-beam evaporation of an easy-to-clean material (i.e., Daiken UD-509 ETC) thereon.

TABLE 4
Conditions and Properties of Examples 9-23

| Example | 9 | 10 | 11 | 12 | 13 | 14 | 15 | |
|---|---|---|---|---|---|---|---|---|
| Ion Beam Example | AA | AA | 1 | 2 | 3 | 3 | 3 | |
| Outer Thickness (nm) | 10 | 20 | 20 | 20 | 10 | 10 | 20 | |
| Deposition Rate (Å/s) | 1.4 | 0.1 | 0.1 | 0.1 | 1.4 | 0.1 | 0.1 | |
| Interior Surface Ra (nm) | 2.69 | 2.69 | 2.31 | 1.46 | 2.16 | 2.16 | 2.16 | |
| Outer Surface Ra (nm) | 2.69 | 1.71 | 1.35 | 1.1 | 1.95 | 1.76 | 1.43 | |
| Interior Surface SHV (μm²) | 0.60 | 0.60 | 0.46 | 0.22 | 0.39 | 0.39 | 0.39 | |
| Outer Surface SHV (μm²) | 0.60 | 0.26 | 0.21 | 0.23 | 0.31 | 0.27 | 0.22 | |
| Interior Surface | 9.8 | 9.8 | 6.05 | 1.57 | 4.62 | 4.62 | 4.62 | |
| H/SHV (nm/μm²) | | | | | | | | |
| Outer Surface | 9.79 | 2.35 | 1.32 | 1.36 | 3.33 | 2.57 | 1.49 | |
| H/SHV (nm/μm²) | | | | | | | | |
| Exterior Surface | 85.9 | 87 | 98.5 | 97 | 91.5 | 94.2 | 94.4 | |
| Steel-Wool Abraded | | | | | | | | |
| WCA (°) | | | | | | | | |
| Example | 16 | 17 | 18 | 19 | 20 | 21 | 22 | 23 |
| Ion Beam Example | 4 | 4 | 4 | 4 | 5 | 6 | 7 | 8 |
| Outer Thickness (nm) | 10 | 20 | 10 | 20 | 20 | 20 | 20 | 20 |
| Deposition Rate (Å/s) | 1.4 | 1.4 | 0.1 | 0.1 | 0.1 | 0.1 | 0.1 | 0.1 |
| Interior Surface Ra (nm) | 1.71 | 1.71 | 1.71 | 1.71 | 2.12 | 2.0 | 2.28 | 1.65 |
| Outer Surface Ra (nm) | 1.62 | 1.61 | 1.55 | 1.13 | 1.58 | 1.39 | 1.43 | 1.27 |
| Interior Surface SHV | 0.26 | 0.26 | 0.26 | 0.26 | 0.37 | 0.32 | 0.44 | 0.25 |
| (μm²) | | | | | | | | |
| Outer Surface SHV | 0.24 | 0.24 | 0.23 | 0.22 | 0.24 | 0.21 | 0.22 | 0.21 |
| (μm²) | | | | | | | | |
| Interior Surface | 2.43 | 2.43 | 2.43 | 2.43 | 4.48 | 3.65 | 5.73 | 2.22 |
| H/SHV (nm/μm²) | | | | | | | | |
| Outer Surface | 2.12 | 2.06 | 1.86 | 1.34 | 1.98 | 1.42 | 1.51 | 1.27 |
| H/SHV (nm/μm²) | | | | | | | | |
| Exterior Surface | 92.5 | 92.4 | 91.7 | 96.3 | 95 | 100.6 | 90 | 97.3 |
| Steel-Wool Abraded | | | | | | | | |
| WCA (°) | | | | | | | | |

FIG. 20 schematically illustrates a change in surface roughness Ra (in %) as a function of deposition conditions for the outer sublayer to form the planarization layer. The vertical axis 2003 (i.e., y-axis) corresponds to a change in surface roughness Ra (in %), and the horizontal axis 2001 (i.e., x-axis) corresponds to the deposition conditions (thickness and deposition rate). The circles correspond to individual measurements with the diamonds corresponding to the median of the samples for each deposition condition. For the data presented in FIG. 20, the silica was deposited on Example 4 with point 2005 corresponding to Example 18, point 2007 corresponding to Example 19, 2009 corresponding to Example 16, and point 2011 corresponding to Example 17. As shown, the lower deposition rate (0.1 Å/s versus 1.4 Å/s) has a greater reduction in surface roughness Ra. Further, for the lower deposition rate, the additional thickness of the silica (going from 10 nm to 20 nm) further reduces the surface roughness Ra. Point 2005 corresponds to a surface roughness Ra decrease of 14% while point 2007 corresponds to a surface roughness decrease of 32%. Based on these observations, low deposition rates (e.g., less than or equal to 1.0 Å/s, or from less greater or equal to 0.1 Å/s to less than or equal to 1.0 Å/s) are associated with decreased surface roughness (e.g., for a thickness of greater than or equal to 10 nm).

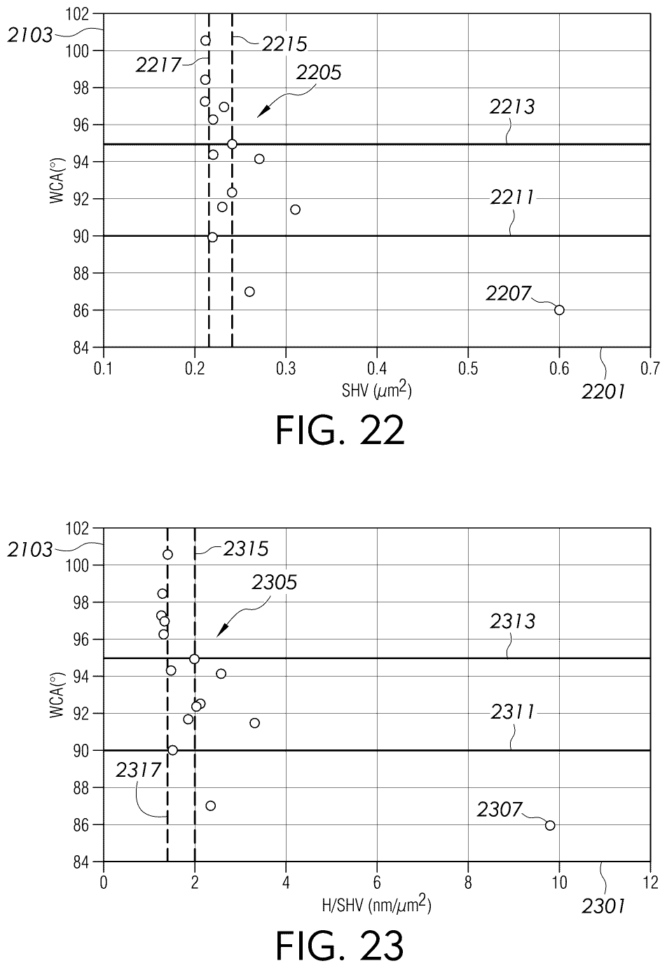

FIGS. 21-23 schematically illustrate relationships between properties of the outer surface of the planarization layer (e.g., surface roughness Ra, SHV, and H/SHV) and the steel-wool abraded water contact angle (WCA) for the surface-modifying layer (easy-to-clean coating) disposed on the outer surface. As discussed above, the steel-wool abraded water contact angle is measured after 3,000 cycles in the Steel Wool Abrasion test. In FIGS. 20-23, the vertical axis 2103 (i.e., y-axis) corresponds the steel-wool abraded water contact angle (WCA) for the surface-modifying layer (easy-to-clean coating) disposed on the outer surface, where the steel-wool abraded water contact angle is measured after 3,000 cycles in the Steel Wool Abrasion test. In FIG. 21, the horizontal axis 2101 (i.e. x-axis) corresponds to the surface roughness Ra (in nm) of the outer surface of the planarization layer (outer surface of the outer sublayer) that the surface-modifying layer is disposed on. In FIG. 22, the horizontal axis 2201 (i.e. x-axis) corresponds to the surface height variation (SHV in μm²) of the outer surface of the planarization layer (outer surface of the outer sublayer) that the surface-modifying layer is disposed on. In FIG. 23, the horizontal axis 2301 (i.e. x-axis) corresponds to the ratio of the mean peak height to the surface height variation (H/SHV in nm/μm²) of the outer surface of the planarization layer (outer surface of the outer sublayer) that the surface-modifying layer is disposed on. In FIGS. 21-23, horizontal lines 2111, 2211, and 2311 correspond to a steel-wool abraded water contact angle of 90° and horizontal lines 2113, 2213, and 2313 correspond to a steel-wool abraded water contact angle of 95°. Points 2107, 2207, and 2307 corresponds to Example 9, which is taken as a baseline for comparison. Sets of points 2105, 2205, and 2305 correspond to Examples 11-23.

In FIG. 21, vertical line 2115 corresponds to a surface roughness Ra of 1.6 nm, and vertical line 2117 corresponds to a surface roughness Ra of about 1.4 nm. As shown for the set of points 2105, samples with a steel-wool abraded water contact angle of greater than or equal to 90° (horizontal line 2111) have a surface roughness Ra of less than or equal to 1.6 nm (vertical line 2115). Also, samples with a steel-wool abraded water contact angle of greater than or equal to 950 (horizontal line 2113) have a surface roughness Ra of less than or equal to 1.4 nm (vertical line 2117).

In FIG. 22, vertical line 2215 corresponds to a surface height variation (SHV) of 0.24 μm², and vertical line 2217 corresponds to a surface height variation (SHV) of about 0.21 μm². As shown for the set of points 2205, samples with a steel-wool abraded water contact angle of greater than or equal to 900 (horizontal line 2211) have a surface height variation (SHV) of less than or equal to 0.24 μm² (vertical line 2215). Also, samples with a steel-wool abraded water contact angle of greater than or equal to 95° (horizontal line 2213) have a surface height variation (SHV) of less than or equal to 0.21 μm² (vertical line 2217).

In FIG. 23, vertical line 2315 corresponds to a ratio of the mean peak height to the surface height variation (H/SHV) of 2.0 nm/μm², and vertical line 2317 corresponds to a ratio H/SHV of about 1.4 nm/μm². As shown for the set of points 2305, samples with a steel-wool abraded water contact angle of greater than or equal to 900 (horizontal line 2311) have a ratio H/SHV of less than or equal to 2.0 nm/μm² (vertical line 2315). Also, samples with a steel-wool abraded water contact angle of greater than or equal to 950 (horizontal line 2313) have a ratio H/SHV of less than or equal to 1.4 nm/μm² (vertical line 2217).

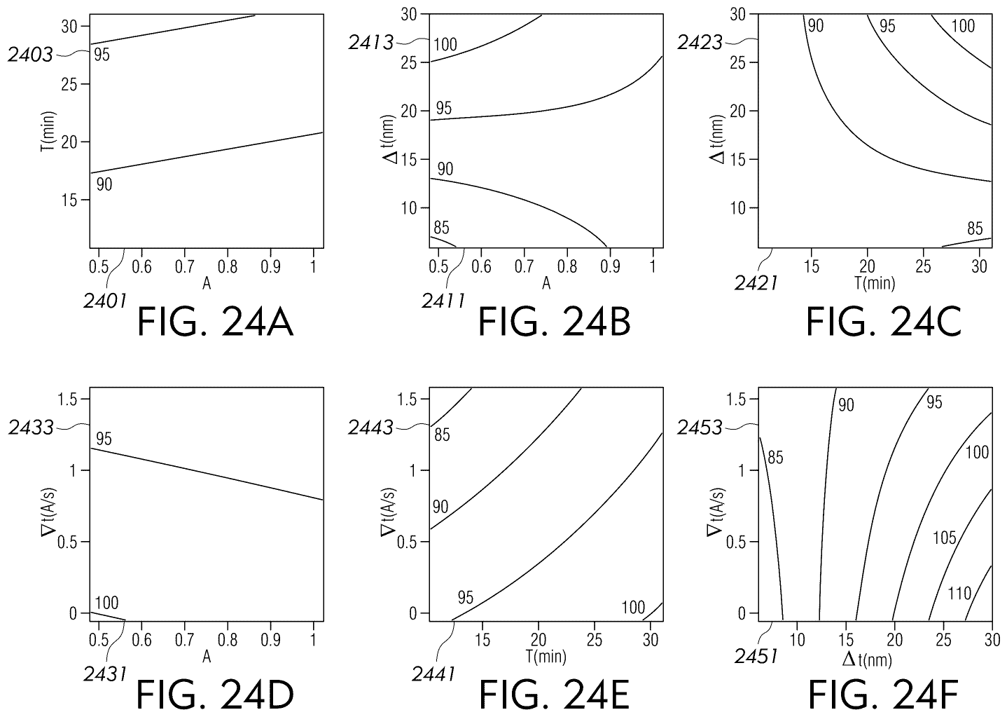

FIGS. 24A-24F illustrate contours corresponding to a steel-wool abraded water contact angle (°) of the surface modifying layer for combinations of various processing conditions using a Kaufman-type ion beam source. In FIGS. 24A, 24B, and 24D, the horizontal axis 2401, 2411, and 2431 (i.e., x-axis) is the current in amps for the Kaufman-type ion beam source. In FIG. 24A, the vertical axis 2403 (i.e. y-axis) is the exposure time in minutes. As shown in FIG. 24A, the steel-wool abraded water contact angle increases as the exposure time increases and the current decreases (towards the top left). In FIGS. 24B-24C, the vertical axis 2413 and 2423 (i.e., y-axis) is the added (deposited) thickness disposed over the interior surface (as the outer sublayer) in nm. In FIG. 24C, the horizontal axis 2421 (i.e., x-axis) corresponds to the exposure time in minutes. As shown in FIG. 24B, the steel-wool abraded water contact angle increases as the added (deposited) thickness increases and as the current decreases when the added thickness is greater than or equal to 15 nm (highest steel-wool abraded water contact angles in the top left). As shown in FIG. 24C, the steel-wool abraded water contact angle increases as the exposure time increases and the added (deposited) thickness increases (towards the top right). In FIGS. 24D-24F, the vertical axis 2433, 2443, and 2453 (i.e., y-axis) is the deposition rate in Å/s. As shown in FIG. 24D, the steel-wool abraded water contact angle increases as the current decreases and the deposition rate decreases (towards the bottom left). As shown in FIG. 24E, the steel-wool abraded water contact angle increases as the exposure time increases and the deposition rate decreases (towards the bottom right). As shown in FIG. 24F, the steel-wool abraded water contact angle increases as the added (deposited) thickness increases and as the deposition rate decreases (towards the bottom right).

Table 5 presents the conditions and properties of Examples 24-31. The initial surface of the initial layer (outer SiO₂) was treated with a linear ion beam source using the conditions stated in Table 5. As used in this section, the ion beam treatments occurred in a chamber with a chamber pressure was about 6.7×10⁻³ Pa (5×10⁻⁵ Torr). Based on the trends observed for Examples 9-23 with the Kaufman-type ion beam source, the conditions for Examples 24-31 were selected for the linear ion beam. Without wishing to be bound by theory, the linear ion beam source treatments in Table 5 remove less material than the Kaufman-type ion beam source of Examples 9-23. The steel-wool abraded water contact angle (see FIGS. 26, 28, and 30) was measured for Examples 34-41 corresponding to Examples 24-31 with the addition of a silica outer sublayer comprising a thickness of 10 nm deposited by e-beam deposition at a rate of 1.4 Å/s followed by e-beam evaporation of an easy-to-clean material (i.e., Daiken UD-509 ETC) thereon with the resulting coated article subjected to 3,000 cycles in the Steel Wool Abrasion Test.

TABLE 5
Conditions and Properties of Examples 24-31 using Linear Ion Beam Source

| Example | 24 | 25 | 26 | 27 | 28 | 29 | 30 | 31 |
|---|---|---|---|---|---|---|---|---|
| Voltage (V) | 2000 | 2500 | 2000 | 2500 | 2000 | 2000 | 2500 | 2500 |
| Current (A) | 0.05 | 0.06 | 0.05 | 0.06 | 0.05 | 0.05 | 0.06 | 0.06 |
| Power (kW) | 0.069 | 0.111 | 0.066 | 0.111 | 0.075 | 0.075 | 0.114 | 0.114 |
| O₂ (sccm) | 0 | 0 | 0 | 0 | 20 | 20 | 20 | 20 |
| Ar (sccm) | 100 | 100 | 100 | 100 | 80 | 80 | 80 | 80 |
| Distance (mm) | 50 | 50 | 50 | 50 | 50 | 30 | 50 | 30 |
| Number of Passes | 10 | 10 | 20 | 20 | 20 | 20 | 20 | 20 |
| Inner Surface | 2.73 | 2.42 | 1.82 | 1.77 | 2.03 | 1.85 | 1.61 | 1.35 |
| Roughness | | | | | | | | |
| Ra (nm) | | | | | | | | |

TABLE 6
Curves for FIGS. 25-30 using Examples 24-31-see Table 4
(and Examples 34-41-see Table 7 (below))

| Curve | Examples |
|---|---|
| 2505, (2605) | 24, 25 (34, 35) |
| 2507, (2607) | 26, 27 (36, 37) |
| 2509, (2609) | 28, 30 (38, 40) |
| 2511, (2611) | 29, 31 (39, 41) |
| 2705, (2805) | 26, 28 (36, 38) |
| 2707, (2807) | 27, 30 (37, 40) |
| 2905, (3005) | 28, 29 (38, 39) |
| 2907, (3007) | 30, 31 (40, 41) |

FIGS. 25, 27, and 29 present the trends for Examples 24-31 with Table 6 indicating which examples (Examples 24-31) were used for the endpoints of the corresponding curves in FIGS. 25, 27, and 29. Due to the relatively short treatment times (relative to those discussed above for the Kaufman-type ion beam source, thickness removal is less of a concern for the ion beam treatments with the linear ion beam source. FIGS. 26, 28, and 30 present the trends for Examples 34-41 with Table 6 indicating which examples (Examples 34-41) were used for the endpoints of the corresponding curves in FIGS. 26, 28, and 30. Since a consistent deposition procedure was used to transform Examples 24-31 to Examples 34-41, the properties of the coated article (including the outer sublayer and the ETC coating) such as steel-wool abraded water contact angle will be discussed relative to the interior surface roughness Ra in FIGS. 26, 28, and 30 (although it is to be understood that the outer surface roughness Ra presented in Table 7 is a different property than the interior surface roughness Ra) to evaluate the effect of the ion beam treatment.

FIGS. 25-26 present the effect of the voltage (in Volts) of the linear ion beam source on the surface roughness of the interior surface and the steel-wool abraded water contact angle (WCA). In FIGS. 25-26, the horizontal axis 2501 and 2601 (i.e., x-axis) corresponds to the voltage (in Volts) associated with the linear ion beam source, the vertical axis 2503 (i.e., y-axis) in FIG. 25 corresponds to the surface roughness Ra of the interior surface (in nm), and the vertical axis 2603 (i.e., y-axis) in FIG. 26 corresponds to the steel-wool abraded water contact angle (WCA) of the resulting surface-modifying layer. Curves 2505, 2507, and 2509 (2605, 2607, and 2609) involved a distance of 50 mm between the linear ion beam source and the initial surface while curve 2511 (2611) distance of 30 mm. Curves 2505 and 2507 (2605 and 2607) involved argon ions while curves 2509 and 2511 (2609 and 2611) involved oxygen ions (20% oxygen by volume shown in Table 5).

As shown in FIG. 25, the surface roughness Ra decreased as the voltage increased for curves 2505, 2507, and 2509 (50 mm distance). Curves 2509 and 2511 have lower surface roughness than curve 2505. As shown in FIG. 26, the steel-wool abraded water contact angle increases with increasing voltage for all curves shown. Curves 2611 and 2609 have steel-wool abraded water contact angles greater than 90° (e.g., greater than or equal to 2300 V, or greater than or equal to 2500 V).

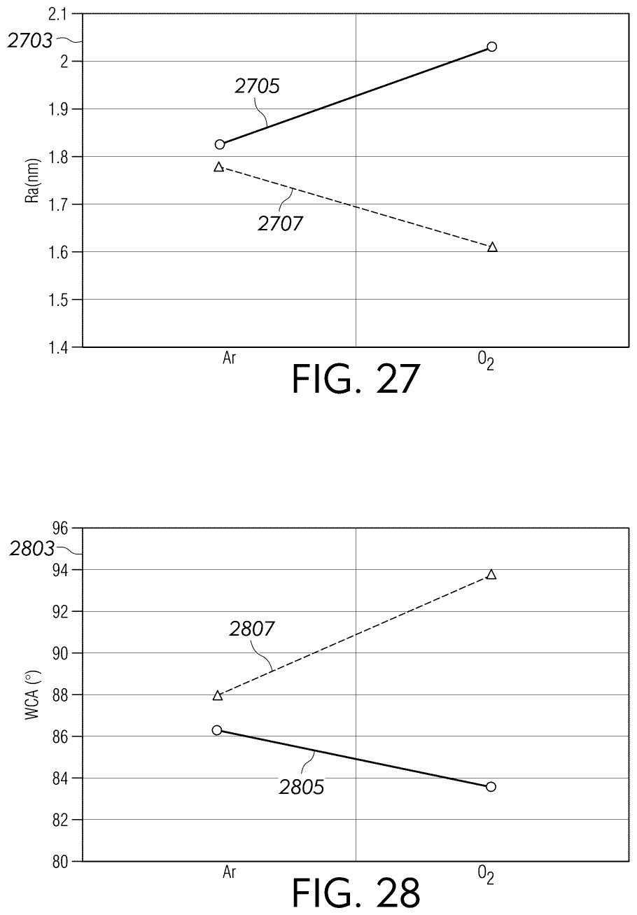

FIGS. 27-28 present the effect of the ion material (argon ions alone versus adding oxygen ions) on the surface roughness of the interior surface and the steel-wool abraded water contact angle. In FIGS. 27-28, the horizontal axis (i.e., x-axis) corresponds to the ion material (argon ions alone versus adding oxygen ions) generated by the linear ion beam source that is controlled by the process gases used as shown in Table 5, the vertical axis 2703 (i.e., y-axis) in FIG. 27 corresponds to the surface roughness Ra of the interior surface (in nm), and the vertical axis 2803 (i.e., y-axis) in FIG. 28 corresponds to the steel-wool abraded water contact angle (WCA) of the resulting surface-modifying layer. Curve 2705 (2805) involved a voltage of 2000 V while curve 2707 (2807) involved a voltage of 2500 V. The trend between surface roughness Ra and steel-wool abraded water contact angle (WCA) is mixed.

FIGS. 29-30 present the effect of the distances between the linear ion beam source and the initial surface on the surface roughness Ra of the interior surface and the steel-wool abraded water contact angle (WCA). In FIGS. 29-30, the horizontal axis (i.e., x-axis) corresponds to the distance (in mm) between the linear ion beam source and the initial surface, the vertical axis 2903 (i.e., y-axis) in FIG. 29 corresponds to the surface roughness Ra of the interior surface (in nm), and the vertical axis 3003 (i.e., y-axis) in FIG. 30 corresponds to the steel-wool abraded water contact angle of the resulting surface-modifying layer. As shown in FIG. 29, the surface roughness Ra decreases as the distance decreases. As shown in FIG. 30, the steel-wool abraded water contact angle increases for curve 3007 as the distance decreases.

Overall, combining the observations from FIGS. 25-30, increased voltage (e.g., greater than 2000 V or from 2000 V to 2500 V) and decreased distance (e.g., less than 50 mm, or from 30 mm to 40 mm) can achieve reduced surface roughness and increase steel-wool abraded water contact angles (for a consistent deposition method for the outer sublayer and the ETC coating thereafter).

FIGS. 31A-31F illustrate relationships between linear ion beam treatment conditions on the change in surface roughness Ra and steel-wool abraded water contact angle (WCA). In FIGS. 31A-31C, the vertical axis 3113 (i.e., y-axis) corresponds to the steel-wool abraded water contact angle (WCA) in degrees of the resulting surface-modifying layer. In FIGS. 31D-31F, the vertical axis 3103 (i.e., y-axis) correspond to the change in surface roughness Ra (in nm). In FIGS. 31A and 31D, the horizontal axis 3101 (i.e., x-axis) corresponds to the total treatment time (in minutes) that the surface is exposed to the linear ion beam source. In FIGS. 31B and 31E, the horizontal axis 3111 (i.e., x-axis) corresponds to the speed (velocity) that the sample was translated relative to the linear ion beam source (in meters per minute). In FIGS. 31C and 31F, the horizontal axis 3121 (i.e., x-axis) corresponds to the number to times that the sample was passed under (e.g., impinged by) the linear ion beam. It is to be understood that the speed and number of passes can be adjusted to achieve a predetermined total treatment time (T) (see FIGS. 31A and 31D). In FIGS. 31A-31F, trendlines 3105, 3115, 3125, 3135, 3145, and 3155 are linear fits to points 3107, 3117, 3127, 3137, 3147, and 3157, respectively. As shown in FIG. 31A, the steel-wool abraded water contact angle increases as the total treatment (exposure) time increases. As shown in FIG. 31B, the steel-wool abraded water contact angle increases as the speed (velocity) decreases (when the number of passes is held constant). As shown in FIG. 31C, the steel-wool abraded water contact angle increases as the number of passes increases (as the speed (velocity) is held constant). As shown in FIG. 31D, the surface roughness Ra decreases as the total treatment (exposure) time increases. As shown in FIG. 31E, the steel-wool abraded surface roughness Ra decreases as the speed (velocity) decreases (when the number of passes is held constant). As shown in FIG. 31F, the surface roughness Ra decreases as the number of passes increases (when the speed (velocity) is held constant). Overall, FIGS. 31A-31F indicates that increasing the total treatment (exposure) time increases the steel-wool abraded water contact angle (and decreases the surface roughness) regardless of the speed (velocity) or number of passes to achieve the total treatment (exposure) time.

Table 7 presents the treatment conditions and properties of Examples 33-41. As shown, Examples 33-41 build on the ion-beam treatment of Examples 24-31 (or no treatment for Comparative Example AA) with the deposition of an outer sublayer of silica (by e-beam evaporation) with a thickness of 10 nm deposited at 1.4 Å/s. The properties (e.g., surface roughness Ra, SHV, and H/SHV) of the outer surface of the planarization layer (outer surface of the outer sublayer comprising silica from e-beam evaporation) are presented in Table 4. Then, a surface-modifying layer (namely an easy-to-clean coating) was formed on the outer surface by e-beam evaporation of an easy-to-clean material (i.e., Daiken UD-509 ETC) thereon.

TABLE 7
Conditions and Properties of Examples 32-41

| Example | 33 | 34 | 35 | 36 | 37 | 38 | 39 | 40 | 41 |
|---|---|---|---|---|---|---|---|---|---|
| Ion Beam Example | AA | 24 | 25 | 26 | 27 | 28 | 29 | 30 | 31 |
| Outer Thickness (nm) | 10 | 10 | 10 | 10 | 10 | 10 | 10 | 10 | 10 |
| Deposition Rate (Å/s) | 1.4 | 1.4 | 1.4 | 1.4 | 1.4 | 1.4 | 1.4 | 1.4 | 1.4 |
| Inner Surface Ra (nm) | 2.7 | 2.73 | 2.42 | 1.82 | 1.77 | 2.03 | 1.85 | 1.61 | 1.35 |
| Outer Surface | 2.69 | 2.27 | 1.83 | 2.19 | 1.68 | 2.06 | 1.92 | 1.62 | 1.53 |
| Ra (nm) | | | | | | | | | |
| Outer Surface | 0.60 | 0.44 | 0.28 | 0.40 | 0.25 | 0.35 | 0.30 | 0.24 | 0.23 |
| SHV (μm²) | | | | | | | | | |
| Outer Surface | 9.79 | 5.63 | 2.82 | 4.85 | 2.32 | 3.91 | 3.18 | 2.11 | 1.78 |
| H/SHV (nm/μm²) | | | | | | | | | |
| Exterior Surface | 85.9 | 82.2 | 84.5 | 86.3 | 88 | 83.5 | 81.4 | 93.8 | 100.6 |
| Steel-Wool Abraded | | | | | | | | | |
| WCA (°) | | | | | | | | | |

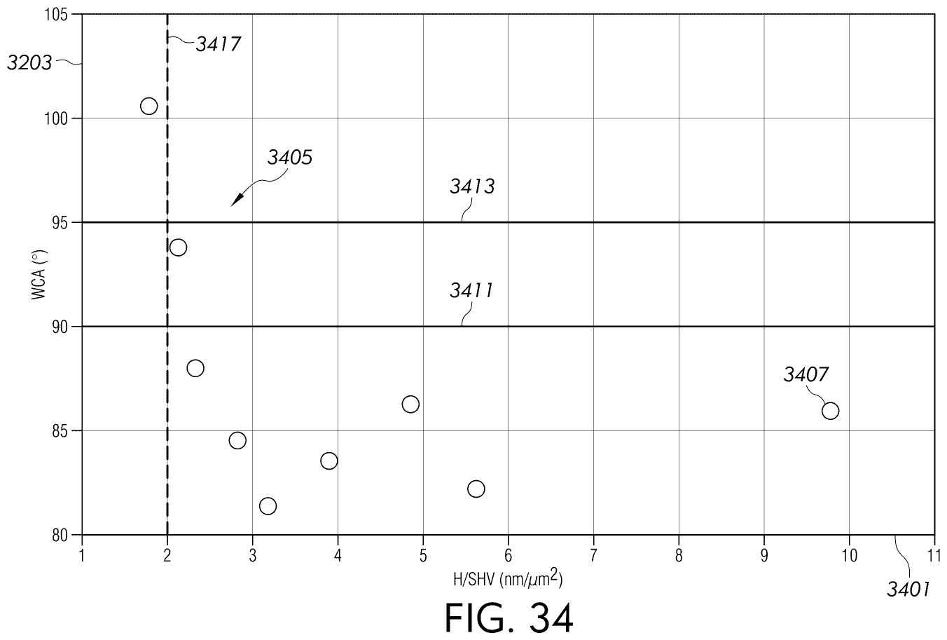

FIGS. 32-34 schematically illustrate relationships between properties of the outer surface of the planarization layer (e.g., surface roughness Ra, SHV, and H/SHV) and the steel-wool abraded water contact angle (WCA) for the surface-modifying layer (easy-to-clean coating) disposed on the outer surface. As discussed above, the steel-wool abraded water contact angle is measured after 3,000 cycles in the Steel Wool Abrasion test. In FIGS. 32-34, the vertical axis 3203 (i.e., y-axis) corresponds the steel-wool abraded water contact angle (WCA) for the surface-modifying layer (easy-to-clean coating) disposed on the outer surface, where the steel-wool abraded water contact angle is measured after 3,000 cycles in the Steel Wool Abrasion test. In FIG. 32, the horizontal axis 3201 (i.e. x-axis) corresponds to the surface roughness Ra (in nm) of the outer surface of the planarization layer (outer surface of the outer sublayer) that the surface-modifying layer is disposed on. In FIG. 33, the horizontal axis 3301 (i.e. x-axis) corresponds to the surface height variation (SHV in μm²) of the outer surface of the planarization layer (outer surface of the outer sublayer) that the surface-modifying layer is disposed on. In FIG. 34, the horizontal axis 3401 (i.e. x-axis) corresponds to the ratio of the mean peak height to the surface height variation (H/SHV in nm/μm²) of the outer surface of the planarization layer (outer surface of the outer sublayer) that the surface-modifying layer is disposed on. In FIGS. 32-34, horizontal lines 3211, 3311, and 3411 correspond to a steel-wool abraded water contact angle of 90° and horizontal lines 3213, 3313, and 3413 correspond to a steel-wool abraded water contact angle of 95°. Points 3207, 3307, and 3407 corresponds to Example 33, which is taken as a baseline for comparison. Sets of points 3205, 3305, and 3405 correspond to Examples 34-41.

In FIG. 32, vertical line 3217 corresponds to a surface roughness Ra of about 1.6 nm. As shown for the set of points 3205, samples with a steel-wool abraded water contact angle of greater than or equal to 90° (horizontal line 3211) and greater than or equal to 950 (horizontal line 2213) have a surface roughness Ra of less than or equal to 1.6 nm (vertical line 2117). In FIG. 33, vertical line 3317 corresponds to a surface height variation (SHV) of 0.24 μm². As shown for the set of points 3305, samples with a steel-wool abraded water contact angle of greater than or equal to 90° (horizontal line 3311) and greater than or equal to 95° (horizontal line 3313) have a surface height variation (SHV) of less than or equal to 0.24 μm² (vertical line 3317). In FIG. 34, vertical line 3417 corresponds to a ratio of the mean peak height to the surface height variation (H/SHV) of 2.0 nm/μm². As shown for the set of points 3405, samples with a steel-wool abraded water contact angle of greater than or equal to 900 (horizontal line 3411) and greater than or equal to 95° (horizontal line 3413) have a ratio H/SHV of less than or equal to 2.0 nm/μm² (vertical line 2317).

Instead of the optical stack in Table 2, similar trends (with likely lower surface roughness) are expected if the optical stack comprises the composition stated in Table 8 or Table 9. In Table 8 and Table 9, the order of the materials corresponds to the order that the layers are deposited—meaning that the first row is the closest to the glass-based substrate and the last row is the furthest from the glass-based substrate. In Tables 8-9, the substrate (i.e., glass-based substrate) and air are shown to help orient the optical stack, but the substrate and air are not actually elements of the optical stack.

TABLE 8
Composition of Alternative Optical Stack

| | Refractive | Thickness |
|---|---|---|
| Material | Index | (nm) |
| (substrate) | 1.50 | |
| SiO₂ | 1.48 | 24.70 |
| SiNₓ | 2.06 | 20.88 |
| SiO₂ | 1.48 | 22.00 |
| SiNₓ | 2.06 | 103.44 |
| SiO₂ | 1.48 | 84.80 |
| (air) | 1.00 | |

TABLE 9
Composition of Another Optical Stack

| | Refractive | Thickness |
|---|---|---|
| Material | Index | (nm) |
| (substrate) | 1.50 | |
| SiO₂ | 1.48 | 25.0 |
| Nb₂O₅ | 2.36 | 12.4 |
| SiO₂ | 1.48 | 40.4 |
| Nb₂O₅ | 2.36 | 116.0 |
| SiO₂ | 1.48 | 83.8 |
| (air) | 1.00 | |

The above observations can be combined to provide coated articles, planarization layers, and methods of making the same. The planarization layer can provide a decreased surface roughness Ra relative to what would be obtained in an article (e.g., coated article) without the planarization layer, which enables the coated article of the present disclosure including the planarization layer to have increased abrasion resistance of the surface-modifying layer. For example, a steel-wool abraded water contact angle (after 3,000 cycles in a Steel Wool Abrasion Test) of the surface-modifying layer can be greater than or equal to 90° or greater than or equal to or 95°.

The planarization layer can comprise an inner sublayer and an outer sublayer, where a microstructure of the inner sublayer is different than a corresponding microstructure of the outer sublayer (e.g., a grain size, roughness, or other characteristic of the outer sublayer can be smaller than a corresponding characteristic of the inner sublayer), where the inner sublayer and the outer sublayer can comprise the same material (e.g., silica). A surface roughness Ra of the outer surface of the planarization layer can be from greater than or equal to 0.5 nm to less than or equal to 1.6 nm (e.g., from greater than or equal to 0.8 nm to less than or equal to 1.5 nm or from greater than or equal to 1.0 nm to less than or equal to 1.4 nm).

Without wishing to be bound by theory, it is believed that higher spatial frequencies of a surface (e.g., gradients of the surface as measured by surface height variation) impact the abrasion resistance of a surface-modifying layer disposed thereon. For example, it is believed that decreasing the amplitude of these higher spatial frequencies can enable increased abrasion resistance. Overall surface roughness values such as surface roughness Ra may not fully capture the role of the decreased amplitude at higher spatial frequencies in the planarization layer. In contrast, aspects of the surface height variation and ratios thereof as well as domain sizes and/or domain heights discussed herein may more directly describe these aspects of the planarization layer. A surface height variation of the outer surface of the planarization layer can be from greater than or equal to 0.18 μm² to less than or equal to 0.24 μm² (e.g., from greater than or equal to 0.20 μm² to less than or equal to 0.23 μm²). A ratio of a mean peak height divided by the surface height variation of the planarization layer can be from greater than or equal to 0.8 nm/μm² to less than or equal to 2.0 nm/μm² (e.g., from greater than or equal to 1.0 nm/μm² to less than or equal to 1.5 nm/μm²).

Methods of making the coated article (e.g., planarization layer) comprise impinging an initial layer with an ion beam to form an inner sublayer and disposing an outer sublayer thereon. The inner sublayer and the outer sublayer can comprise silica. The ion beam can be generated by a Kaufman-type ion beam source, an end-Hall ion beam source, or a linear ion beam source. The ion beam treatment can remove less than or equal to 60 nm (e.g., from greater than or equal to 10 nm to less than or equal to 60 nm) from the initial layer. In aspects, a Kaufman-type ion beam source can be operated with a current of less than or equal to 0.8 Amps (e.g., from greater than or equal to 0.5 Amps to less than or equal to 0.8 Amps), with oxygen ions, and/or impinge the initial layer for less than or equal to 20 minutes (e.g., from greater than or equal to 10 minutes to less than or equal to 15 minutes). In aspects, a linear ion beam source can be operated at a voltage of greater than or equal to 2000 Volts (e.g., from 2000 V to 2500 V), a distance between the linear ion beam source and the initial surface of the initial layer less than 50 mm (e.g., from 30 mm to 40 mm), and/or impinge the initial layer for less than or equal to 5 minutes (e.g., from greater than or equal to 20 seconds to less than or equal to 1 minute).

The surface-modifying coating can reduce a visibility and/or color shift associated with disposing a fingerprint thereon. Providing a high water contact angle (e.g., greater than or equal to 100°) can enhance the removal of aqueous material (e.g., water droplets, sweat droplets) from the anti-fingerprint coating. Consequently, the anti-fingerprint coating can be hydrophobic and oleophilic. The coated article in accordance with the aspects of the disclosure can exhibit good abrasion resistance (e.g., an abraded water contact angle of greater than or equal to 90° after 2,000 cycles, 3,000 cycles, and/or 3,500 cycles in a Steel Wool Abrasion Test, a cheesecloth-abraded water contact angle of about 90° after 200,000 cycles in a Cheesecloth Abrasion Test), for example, maintaining a hydrophobic character. The planarization layer can exhibit good adhesion to the surface-modifying layer disposed thereon, for example, by providing a lower roughness surface for the surface-modifying layer.

The substrate can comprise a glass-based and/or ceramic-based material, which can provide good dimensional stability, good impact resistance, and/or good puncture resistance. The glass-based and/or ceramic-based substrate can comprise one or more compressive stress regions, which can further provide increased impact resistance and/or increased puncture resistance.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein, the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof, as used herein, are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

What is claimed:

1. A coated article comprising:
a substrate comprising a first major surface, the substrate comprising glass-based material or a ceramic-based material;
a planarization layer disposed over the first major surface, an outer surface of the planarization layer exhibits:
a surface roughness Ra of less than or equal to 1.6 nm; and
a spatial height variation of less than or equal to 0.24 μm²;
a surface-modifying layer disposed on the outer surface of the planarization layer.

2. The coated article of claim 1, wherein the outer surface of the planarization layer further exhibits a ratio of a maximum height to the spatial height variation of less than or equal to 2.0 nm/μm².

3. The coated article of claim 2, wherein the ratio of the maximum height to the spatial height variation is from greater than or equal to 1.0 nm/μm² to less than or equal to 1.50 nm/μm².

4. The coated article of claim 1, wherein the surface roughness Ra is from greater than or equal to 0.8 nm to less than or equal to 1.5 nm.

5. The coated article of claim 1, wherein the spatial height variation is from greater than or equal to 0.20 μm² to less than or equal to 0.23 μm².

6. The coated article of claim 1, wherein the outer surface exhibits:
a mean height of domains above an average location is greater less than or equal to 1 nm to less than or equal to 8 nm; and
an areal density of the domains is from greater than or equal to 10 per μm² to less than or equal to 70 per μm².

7. The coated article of claim 1, wherein an exterior surface of the surface-modifying layer exhibits a water contact angle of from greater than or equal to 950 to less than or equal to 120°.

8. The coated article of claim 7, wherein the surface-modifying layer exhibits an abraded water contact angle of greater than or equal to 90° after being abraded for 3,000 cycles in a Steel Wool Abrasion test.

9. The coated article of claim 7, wherein the surface-modifying layer exhibits a coefficient of friction of the exterior surface of less than or equal to 0.25.

10. The coated article of claim 1, wherein the surface-modifying layer is an easy-to-clean coating.

11. The coated article of claim 1, wherein the planarization layer comprises an inner sublayer and an outer sublayer disposed on the inner sublayer, the outer sublayer comprising the outer surface, a thickness of the outer sublayer is from greater than or equal to 10 nm to less than or equal to 100 nm, and a microstructure of the inner sublayer is different than a corresponding microstructure of the outer sublayer.

12. The coated article of claim 1, wherein the planarization layer comprises silica.

13. The coated article of claim 1, further comprising an optical stack positioned between the surface-modifying layer and the substrate, wherein the optical stack comprises an anti-reflective coating, a band-pass filter coating, an edge neutral mirror, a beam splitter coating, a multi-layer high-reflectance coating, or an edge filter coating.

14. A consumer electronic device comprising:
a housing comprising a front surface, a back surface, and a side surface;
electrical components at least partially within the housing, the electrical components comprise a controller, a memory, and a display, the display at or facing the front surface of the housing; and
a cover substrate disposed over the display,
wherein at least one of the housing or the cover substrate comprises the coated article of claim 1.

15. A method of forming a coated article comprising:
impinging an initial surface of an initial layer disposed over a substrate with an ion beam to form an inner surface of an inner layer corresponding to the initial layer; and
disposing a silica-containing material on the inner layer to form a planarization layer, the planarization comprising the inner layer and an outer layer corresponding to the silica-containing material and having an outer surface.

16. The method of claim 15, wherein the impinging occurs for from greater than or equal to 20 seconds to less than or equal to 60 minutes while the substrate is maintained at a temperature from greater than or equal to 20° C. to less than or equal to 40° C.

17. The method of claim 15, wherein the ion beam is formed by:
a Kaufman-type ion beam source and the impinging occurs for a first period of time from greater than 10 minutes to less than or equal to 60 minutes, or
a linear ion beam source and the impinging occurs for a first period of time from greater than or equal to 20 seconds to less than or equal to 20 minutes, and a distance between the inner surface and the linear ion beam source is from greater than or equal to 10 mm to less than or equal to 50 mm, and the linear ion beam source is operated with a voltage of greater than or equal to 2000 V.

18. The method of claim 15, wherein the impinging removes from greater than or equal to 20 nanometers to less than or equal to 60 nanometers from the initial layer, and a surface roughness Ra of the inner surface is from greater than or equal to 1.0 nm to less than or equal to 1.9 nm.

19. The method of claim 15, wherein the outer surface exhibits at least one of:
a surface roughness Ra of less than or equal to 1.6 nm;
a spatial height variation of less than or equal to 0.24 μm²; or
a ratio of a maximum height to the spatial height variation of less than or equal to 2.0 nm/μm².

20. The method of claim 15, further comprising disposing a surface-modifying layer on the outer surface, the surface modifying layer comprising an exterior surface, and the exterior surface of the surface-modifying layer exhibits a water contact angle of from greater than or equal to 950 to less than or equal to 120°.
